(19) United States
(12) Patent Application Publication
(10) Pub. No.: US 2025/0377663 A1
(43) Pub. Date: Dec. 11, 2025

(54) MOBILE BODY CONTROL DEVICE, MOBILE BODY CONTROL METHOD, AND PROGRAM

(71) Applicant: SONY GROUP CORPORATION, Tokyo (JP)

(72) Inventor: Masashi ESHIMA, Tokyo (JP)

(21) Appl. No.: 18/878,010

(22) PCT Filed: Apr. 7, 2023
(86) PCT No.: PCT/JP2023/014449

§ 371 Date: Dec. 21, 2024

(30) Foreign Application Priority Data
Jun. 28, 2022 (JP) 2022-103302

(51) Int. Cl. G05D 1/246; G05D 1/689; G05D 109/20; G05D 111/10

(52) U.S. Cl. CPC G05D 1/246; G05D 1/689; G05D 2109/20; G05D 2111/10

(57) ABSTRACT

A device and a method realizing movement according to a pre-defined path even in a case that a mobile body cannot input absolute position information from the outside such as a GPS signal or the like are provided. There is provided a configuration executing control of a mobile body such as a drone or the like, and the configuration executes an imaging direction control step of controlling an imaging direction of a camera using a control unit and a localization processing step of executing a localization process estimating a self-position using a captured image of the camera using a self-position estimating unit. In the imaging direction control step, a camera imaging direction control process of directing the imaging direction of the camera to a divisional area that can be localized by referring to localization feasibility information enabling to identify whether or not localization can be performed in units of divisional areas is executed.

### TECHNICAL FIELD

The present disclosure relates to a mobile body control device, a mobile body control method, and a program. In more detail, the present disclosure relates to a mobile body control device, a mobile body control method, and a program enabling a mobile body, for example, a drone or the like to move while executing self-position estimation with high accuracy.

### BACKGROUND ART

In recent years, drones that are small flying objects have rapidly increased in use. For example, cameras are mounted in drones, and such drones are used for a process of capturing an image of landscape scenery from the sky and the like. In addition, such drones are also used for delivery of packages.

As flight control states of a drone, there are a control state in which flight is performed in a range visible to the human eye by a person operating a controller and a control state of an autonomous flight type in which monitoring using visual observation of a person or an external controller is not necessary.

Drones of the autonomous flight type, for example, can perform flight toward a destination that is far from a departure place, and the use of such drones of the autonomous flight type is expected to increase in the future.

A drone of the autonomous flight type flies while performing control such that a deviation from a pre-defined flight path does not occur by sequentially checking a self-position during flight.

As one method for a self-position estimating process, for example, there is a Simultaneous Localization and Mapping (SLAM) process.

The SLAM process, for example, is a process of estimating a current self-position by analyzing a captured image acquired by a camera mounted in a drone and analyzing a movement direction and a movement distance of the drone by analyzing movement of the drone from movement of a subject included in the captured image.

In the SLAM process, feature points are extracted from a captured image acquired by a camera, movement of the feature points in a plurality of consecutive captured images is analyzed, and a movement amount and a movement direction of a relative self-position are analyzed in accordance with a result of the analysis. Thus, in a case in which no feature points can be detected in an image captured with a camera, for example, in a case in which a captured image acquired by a camera mounted in a drone is an image of a white wall or the like, there is a problem that no feature points are extracted from the captured image, and a SLAM process, that is, self-position estimation cannot be performed.

In addition, as a conventional technology disclosing an autonomous mobile body calculating a reliability of an estimated self-position and performing movement to a place at which self-position estimation having high reliability can be performed, there is PTL 1 (JP 2017-188067A).

However, according to a configuration disclosed in this literature, in a stage in which the reliability of a self-position estimation result is determined to be low, movement to a place at which self-position estimation having high reliability can be performed is performed. Thus, for example, in a case in which there are many places at which the reliability of a self-position estimation result is low in a route to a destination, the process of moving to a place at which self-position estimation having high reliability can be executed needs to be repeatedly performed. As a result, there is a problem that the time required to reach a destination becomes significantly long.

### CITATION LIST

### Patent Literature

### [PTL 1]

JP 2017-188067A

### SUMMARY

### Technical Problem

The present disclosure, for example, is in consideration of the problems described above and relates to a mobile body control device, a mobile body control method, and a program enabling a mobile body, for example, a drone or the like to move while executing self-position estimation with high accuracy.

### Solution to Problem

According to one aspect of the present disclosure, there is provided a mobile body control method executed in a mobile body control device, the mobile body control method including: an imaging direction control step of controlling an imaging direction of a camera using a control unit; and a localization processing step of executing a localization process estimating a self-position using a captured image of the camera using a self-position estimating unit, in which, in the imaging direction control step, a camera imaging direction control process of directing the imaging direction of the camera to a divisional area that can be localized by referring to localization feasibility information enabling to identify whether or not localization can be performed in units of divisional areas is executed.

In addition, according to a second aspect of the present invention, there is provided a mobile body control device including: a control unit controlling an imaging direction of a camera; and a self-position estimating unit executing a localization processing step of executing a localization process estimating a self-position using a captured image of the camera, in which the self-control unit executes a camera imaging direction control process of directing the imaging direction of the camera to a divisional area that can be localized by referring to localization feasibility information enabling to identify whether or not localization can be performed in units of divisional areas.

Furthermore, according to a third aspect of the present disclosure, there is provided a program causing a mobile body control device to execute a mobile body control process including: an imaging direction control step of causing a control unit to control an imaging direction of a camera; and a localization processing step of causing a self-position estimating unit to execute a localization processing step of executing a localization process estimating a self-position using a captured image of the camera, in which, in the imaging direction control step, a camera imaging direction control process of directing the imaging direction of the camera to a divisional area that can be localized by referring to localization feasibility information enabling to identify whether or not localization can be performed in units of divisional areas is caused to be executed.

The program of the present disclosure is, for example, a storage medium provided in a computer-readable form or a program that can be provided by a communication medium, the storage medium or the program being provided to an information processing device or a computer system that can execute various program codes, for example. By providing such a program in a computer-readable form, processing according to the program can be realized on an information processing device or a computer system.

Still other objects, features and advantages of the present disclosure will become apparent by more detailed description on the basis of the embodiments of the present disclosure and the accompanying drawings described below. In the present specification, the system is a logical set of configurations of a plurality of devices, and the devices having each configuration are not limited to those in the same housing.

According to a configuration of one embodiment of the present disclosure, a device and a method realizing movement according to a pre-defined path even in a case in which a mobile body cannot receive absolute position information from the outside such as a GPS signal or the like as an input are realized.

More specifically, for example, there is provided a configuration executing control of a mobile body such as a drone or the like, and the configuration executes an imaging direction control step of controlling an imaging direction of a camera using a control unit and a localization processing step of executing a localization process estimating a self-position using a captured image of the camera using a self-position estimating unit. In the imaging direction control step, a camera imaging direction control process of directing the imaging direction of the camera to a divisional area that can be localized by referring to localization feasibility information enabling to identify whether or not localization can be performed in units of divisional areas is executed.

According to this configuration, a device and a method realizing movement according to a pre-defined path even in a case in which a mobile body cannot receive absolute position information from the outside such as a GPS signal or the like as an input are realized.

Note that the effects described in the present specification are merely exemplary and not limited, and may have additional effects.

### BRIEF DESCRIPTION OF DRAWINGS

FIG. 1 is a diagram illustrating an overview of a process according to the present disclosure.

FIG. 2 is a diagram describing an overview of a process according to the present disclosure.

FIG. 3 is a diagram describing an overview of a process according to the present disclosure.

FIG. 4 is a diagram describing an overview of a process according to the present disclosure.

FIG. 5 is a diagram describing an overview of a process according to the present disclosure.

FIG. 6 is a diagram describing an overview of a process according to the present disclosure.

FIG. 7 is a diagram describing an overview of a process according to the present disclosure.

FIG. 8 is a diagram describing an overview of a process according to the present disclosure.

FIG. 9 is a diagram describing an overview of an example of a landing process to which the process according to the present disclosure is applied.

FIG. 10 is a diagram describing an overview of an example of a landing process to which the process according to the present disclosure is applied.

FIG. 11 is a diagram describing an overview of an example of a landing process to which the process according to the present disclosure is applied.

FIG. 12 is a diagram describing an overview of an example of a landing process to which the process according to the present disclosure is applied.

FIG. 13 is a diagram describing a configuration example (Embodiment 1) of a mobile body control device according to the present disclosure.

FIG. 14 is a diagram describing a specific processing example of a localization feasibility determining process.

FIG. 15 is a diagram describing a configuration example of a self-position estimating unit of the mobile body control device according to the present disclosure.

FIG. 16 is a diagram illustrating a flowchart describing a sequence of a process executed by the mobile body control device (Embodiment 1) according to the present disclosure.

FIG. 17 is a diagram describing a specific example of a process of calculating a movement cost and a localization cost of each of a plurality of paths to a destination that is executed by a flight planning unit.

FIG. 18 is a diagram illustrating a flowchart describing a sequence of a process executed by the mobile body control device (Embodiment 1) according to the present disclosure.

FIG. 19 is a diagram illustrating a flowchart describing a sequence of a process executed by the mobile body control device (Embodiment 1) according to the present disclosure.

FIG. 20 is a diagram describing a configuration example (Embodiment 2) of a mobile body control device according to the present disclosure.

FIG. 21 is a diagram illustrating a flowchart describing a sequence of a process executed by the mobile body control device (Embodiment 2) according to the present disclosure.

FIG. 22 is a diagram illustrating a flowchart describing a sequence of a process executed by the mobile body control device (Embodiment 2) according to the present disclosure.

FIG. 23 is a diagram describing a configuration example (Embodiment 3) of a mobile body control device according to the present disclosure.

FIG. 24 is a diagram illustrating a flowchart describing a sequence of a process executed by the mobile body control device (Embodiment 3) according to the present disclosure.

FIG. 25 is a diagram illustrating a flowchart describing a sequence of a process executed by the mobile body control device (Embodiment 3) according to the present disclosure.

FIG. 26 is a diagram illustrating a flowchart describing a sequence of a process executed by the mobile body control device (Embodiment 3) according to the present disclosure.

FIG. 27 is a diagram describing a configuration example (Embodiment 4) of a mobile body control device according to the present disclosure.

FIG. 28 is a diagram illustrating a flowchart describing a sequence of a process executed by the mobile body control device (Embodiment 4) according to the present disclosure.

FIG. 29 is a diagram illustrating a flowchart describing a sequence of a process executed by the mobile body control device (Embodiment 4) according to the present disclosure.

FIG. 30 is a diagram illustrating a flowchart describing a sequence of a process executed by the mobile body control device (Embodiment 4) according to the present disclosure.

FIG. 31 is a diagram describing a configuration example (Embodiment 5) of a mobile body control device according to the present disclosure.

FIG. 32 is a diagram illustrating a flowchart describing a sequence of a process executed by the mobile body control device (Embodiment 5) according to the present disclosure.

FIG. 33 is a diagram illustrating a flowchart describing a sequence of a process executed by the mobile body control device (Embodiment 5) according to the present disclosure.

FIG. 34 is a diagram illustrating a flowchart describing a sequence of a process executed by the mobile body control device (Embodiment 5) according to the present disclosure.

FIG. 35 is a diagram describing a hardware configuration example of a mobile body control device according to the present disclosure.

### DESCRIPTION OF EMBODIMENTS

Hereinafter, a mobile body control device, a mobile body control method, and a program according to the present disclosure will be described in detail with reference to the drawings. The description will be given in the following order.
1. Overview of Process According to Present Disclosure
2. (Embodiment 1) Configuration Example of Mobile Body Control Device According to Embodiment 1 of Present Disclosure
3. Details of Process Executed by Mobile Body Control Device According to Embodiment 1 of Present Disclosure
4. (Embodiment 2) Configuration and Processing Example of Mobile Body Control Device According to Embodiment 2 of Present Disclosure
5. (Embodiment 3) Configuration and Processing Example of Mobile Body Control Device According to Embodiment 3 of Present Disclosure
6. (Embodiment 4) Configuration and Processing example of Mobile Body Control Device according to Embodiment 4 of Present Disclosure
7. (Embodiment 5) Configuration and Processing Example of Mobile Body Control Device According to Embodiment 5 of Present Disclosure
8. Hardware Configuration Example of Mobile Body Control Device According to Present Disclosure
9. Summary of Configuration of Present Disclosure

### 1. Overview of Process According to Present Disclosure

First, an overview of a process according to the present disclosure will be described.

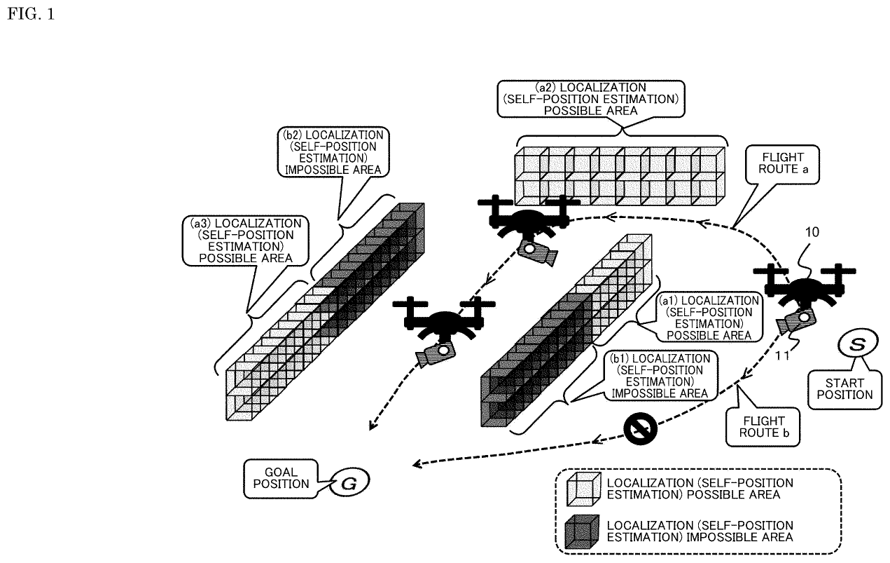

The overview of the process according to the present disclosure will be described with reference to FIG. 1.

As described above, a drone of an autonomous flight type flies while performing control such that a deviation from a pre-defined flight path does not occur by sequentially checking a self-position during flight.

A self-position estimating process is called a localization process. The localization process may include not only the self-position estimating process but also a self-posture estimating process.

In the process according to the present disclosure described below, the localization process is a process including at least a self-position estimating process. The localization process may be a process of estimating a self-position and a self-posture together.

As one method for the localization (self-position estimating) process, for example, there is a Simultaneous Localization and Mapping (SLAM) process.

In a SLAM process, for example, a current self-position is estimated by analyzing a captured image acquired by a camera mounted in a drone and analyzing a movement direction and a movement distance of the drone by analyzing movement of the drone from movement of feature points included in the captured image.

However, in the SLAM process, movement of feature points inside of a plurality of image frames captured by a camera is analyzed, and a movement amount and a movement direction of a relative self-position are analyzed in accordance with a result of this analysis, and, in a case in which a subject included in a captured image is an image, for example, such as a white wall or the like from which it is difficult to detect feature points, there are cases in which self-position estimation using the SLAM process cannot be performed and there are cases in which the accuracy is lowered.

The mobile body control device according to the present disclosure solves such problems and performs area division as below in advance for a movement area (flight area) of a mobile body (drone) such that movement to a destination can be performed by executing self-position estimation with high accuracy and stores a result of the area division in the storage unit as localization feasibility information.
(a) Localization (self-position estimation) possible area
(b) Localization (self-position estimation) impossible area
(c) Localization (self-position estimation) possibility/impossibility unknown area

A specific example will be described with reference to FIG. 1.

A drone 10 is illustrated in FIG. 1. The drone 10 flies from a start position (S) to a goal position (G).

As flight routes from the start position (S) to the goal position (G), there are two types including flight route a and flight route b as illustrated in FIG. 1.

A box (cube) aggregation illustrated in FIG. 1, for example, represents which area out of the following two types an object such as a wall present at the position of the box (cube) aggregation is.
(a) Localization (self-position estimation) possible area
(b) Localization (self-position estimation) impossible area

In other words, in units of divisional areas defined by respective boxes configuring the box (cube) aggregation, it is represented whether a divisional area is a “(a) localization (self-position estimation) possible area” or “(b) localization (self-position estimation) impossible area”.

The divisional areas defined by the boxes are divisional areas generated by dividing surfaces of objects such as walls in a three-dimensional space, in which the drone 10 is flying, using grids at regular intervals.

A divisional area denoted using a white box represents a “(a) localization (self-position estimation) possible area”.

On the other hand, a divisional area denoted using a grey box represents a “(b) localization (self-position estimation) impossible area”.

The “(a) localization (self-position estimation) possible area” denoted using a white box represents an area for which feature points can be easily detected and self-position estimation with high accuracy according to a SLAM process based on detected feature points can be performed in a case in which an image is captured using the camera 11 of the drone 10.

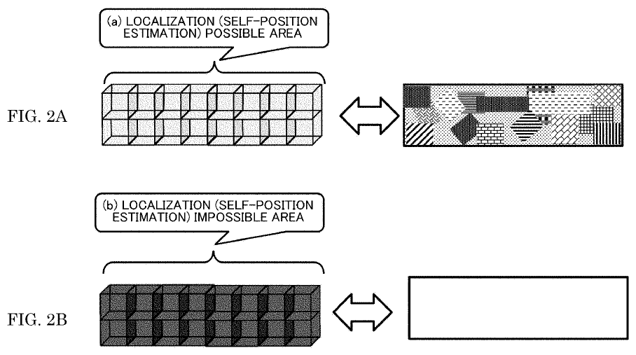

For example, as illustrated in FIG. 2(a), in the case of an object such as a wall having many textures, it is set as the “(a) localization (self-position estimation) possible area”.

On the other hand, the “(b) localization (self-position estimation) impossible area” denoted using a grey box represents that it is an area for which it is difficult to detect feature points, and it is difficult to perform self-position estimation with high accuracy according to a SLAM process based on feature points in a case in which an image is captured by the camera 11 of the drone 10.

For example, as illustrated in FIG. 2(b), in the case of an object such as a white wall having no texture, it is set as the “(b) localization (self-position estimation) impossible area”.

Boxes illustrated in FIG. 1, for example, are set at surface positions or the like of objects imaged by the camera 11 of the drone 10 during flight of the drone 10. More specifically, for example, in the case of an indoor place, boxes are set being associated with surface positions of various objects such as a wall, a desk, a table, other furniture, a floor, and a ceiling.

In the case of an outdoor place, boxes are set being associated with surface positions of various buildings, trees, roads, road surfaces, and the like.

Here, it is not essential to set divisional areas represented using boxes in FIG. 1 at surface positions of objects such as walls and the like. For example, boxes may be set to areas in which no object is present. A divisional area represented using a box in FIG. 1 is used as information representing whether localization (self-position estimation) is possible or impossible or representing that it is unknown whether localization is possible or impossible in a case in which an image is captured in a direction of the box side by the camera 11 of the drone 10.

Thus, for example, there is also a possibility that boxes representing two types of areas are set at positions at which no object is present.
(b) localization (self-position estimation) impossible area
(c) localization (self-position estimation) possibility/impossibility unknown area

In FIG. 1, although boxes are not illustrated in a floor part to avoid complication of the drawing, boxes can be present also in the floor part.

Information representing an object such as a wall present inside of an area in which the drone 10 is flying is an area out of the following two types, that is, information about which of these areas
(a) localization (self-position estimation) possible area
(b) localization (self-position estimation) impossible area
(c) localization (self-position estimation) possibility/impossibility unknown area is recorded as “localization feasibility information” in the storage unit inside the drone 10.

The drone 10 determines a flight route by referring to “localization feasibility information” stored in the storage unit.

More specifically, the drone performs flight by selecting a route along which flight can be performed along the “(a) localization (self-position estimation) possible area” as a flight route.

In the example illustrated in FIG. 1, a flight route a is a route for sequentially flying over the following three “(a) localization (self-position estimation) possible areas”.
(a1) Localization (self-position estimation) possible area
(a2) Localization (self-position estimation) possible area
(a3) Localization (self-position estimation) possible area

Along the flight route a, by imaging such three localization (self-position estimation) possible areas using a camera and performing a SLAM process using feature points detected from a camera captured image, autonomous flight can be performed while self-position estimation with high accuracy is performed.

In addition, when performing flight along the flight route a, the drone 10 performs flight while controlling capturing an image with the camera 11 in a direction in which the localization (self-position estimation) possible areas (a1) to (a3) can be imaged.

The other flight route b is a route for sequentially flying over the following areas.
(a1) Localization (self-position estimation) possible area
(b1) Localization (self-position estimation) impossible area

Although the flight route b has a flight distance shorter than the flight route a, the drone has to fly over an area in which “(a) localization (self-position estimation) possible area is interrupted, that is, the “(b1) localization (self-position estimation) impossible area”.

The “(b1) localization (self-position estimation) impossible area” is an area for which it is difficult to detect feature points from a captured image acquired by a camera and is an area for which it is difficult to perform self-position estimation with high accuracy using a SLAM process.

Thus, in such a case, the drone 10 selects the flight route a as a flight route to be used.

In this way, the mobile body control device according to the present disclosure performs area division as below in advance and stores a result of the area division in a storage unit inside of the drone 10 as localization feasibility information.
(a) Localization (self-position estimation) possible area
(b) Localization (self-position estimation) impossible area
(c) Localization (self-position estimation) possibility/impossibility unknown area

When determining a flight route, the drone 10 selects a route along which it can sequentially flight over the “(a) localization (self-position estimation) possible areas” by referring to this “localization feasibility information” and performs flight. In accordance with such a process, autonomous flight can be performed while self-position estimation with high accuracy is performed using a SLAM process that uses feature points detected from a camera captured image.

The example illustrated in FIG. 1 is an example in which following two divisional areas illustrated as the localization feasibility information.
(a) localization (self-position estimation) possible area
(b) localization (self-position estimation) impossible area The localization feasibility information also includes
(c) localization (self-position estimation) possibility/impossibility unknown area.

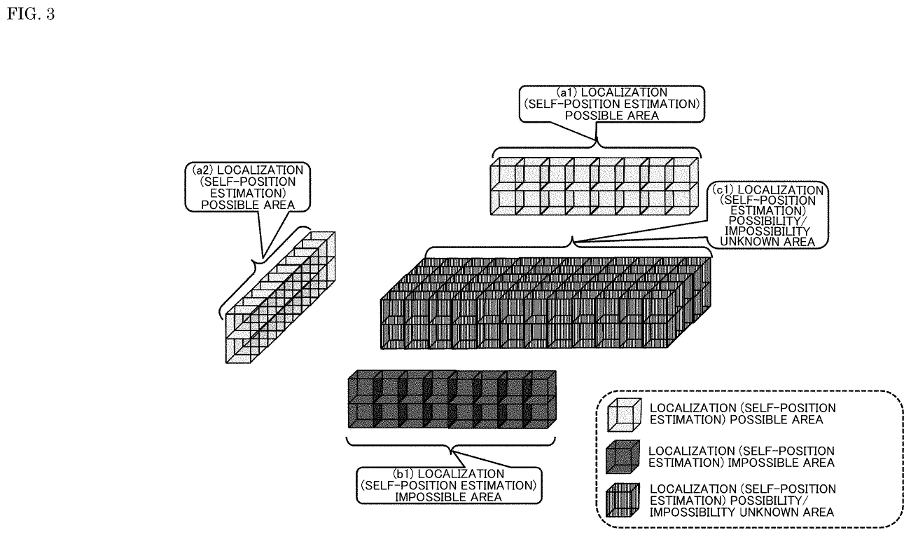

In FIG. 3, an example having information of following three types of areas is illustrated.
(a) Localization (self-position estimation) possible area
(b) Localization (self-position estimation) impossible area
(c) Localization (self-position estimation) possibility/impossibility unknown area

An area setting illustrated in FIG. 3 is an area setting in which
“(a) localization (self-position estimation) possible areas” are set in an upper part and on the left side in FIG. 3,
“(b) localization (self-position estimation) impossible area” is set in a lower part of FIG. 3, and
“(c) localization (self-position estimation) possibility/impossibility unknown area” is set in a center part of FIG. 3.

For example, two types of areas including
(a) localization (self-position estimation) possible area and
(b) localization (self-position estimation) impossible area
are areas for which the drone 10 has verified whether a localization process, that is, the self-position estimation process can be performed through in-advance flight.

In other words, in accordance with in-advance flight, the areas are an area for which feature points that are necessary for a localization process, that is, a self-position estimating process could be sufficiently detected is set as
(a) localization (self-position estimation) possible area.

On the other hand, area for which feature points that are necessary for a self-position estimating process could not be sufficiently detected is set as a (b) localization (self-position estimation) impossible area.

These areas registered in “localization feasibility information” inside a storage unit of the drone 10.

In contrast to this,
“(c) localization (self-position estimation) possibility/impossibility unknown area” illustrated in a center part of FIG. 3
is an area for which area determination according to in-advance flight has not been executed.

Also such an area is registered in “localization feasibility information” inside of the storage unit of the drone 10 as the “(c) localization (self-position estimation) possibility/impossibility unknown area”.

In a case in which the drone 10 flies over an area including the “(c) localization (self-position estimation) possibility/impossibility unknown area”, there are the following two types of flight modes.
(1) Success-focused flight
(2) Map enlargement-focused flight
“(1) Success-focused flight” is safe flight, that is, a flight mode in which flight is performed by performing reliable localization (self-position estimation).
“(2) Map enlargement-focused flight” is a flight mode in which, by intentionally flying over the “(c) localization (self-position estimation) possibility/impossibility unknown area”, the “(c) localization (self-position estimation) possibility/impossibility unknown area” is used to perform the process of analyzing any one of
(a) localization (self-position estimation) possible area and
(b) localization (self-position estimation) impossible area.

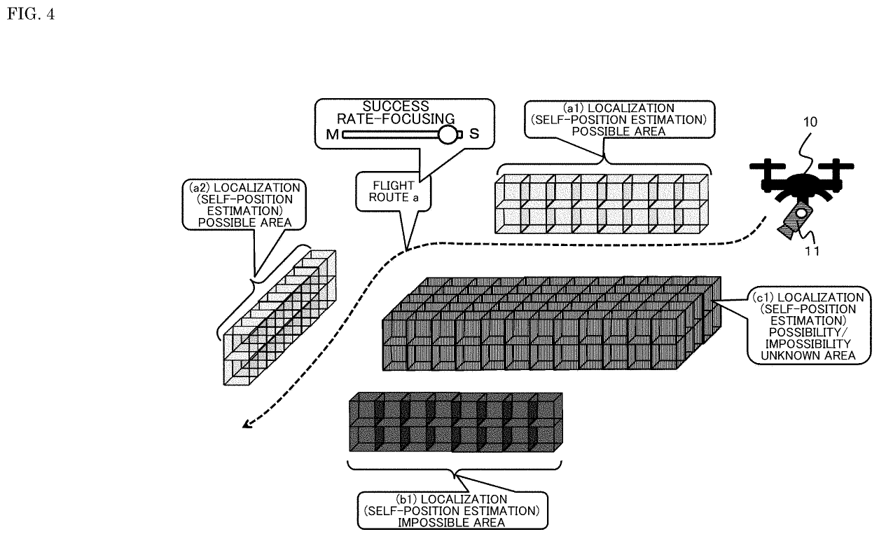

A specific example of these two types of flight modes will be described with reference to FIG. 4 and subsequent drawings.

FIG. 4 is an example of “(1) Success-focused flight”.
“(1) Success-focused flight” is a flight mode in which safe flight, that is, flight is performed using reliable localization (self-position estimation) and, as illustrated in FIG. 4, is a flight mode according to a route along a “(a1) localization (self-position estimation) possible area” illustrated in an upper part of FIG. 4 and a “(a2) localization (self-position estimation) possible area” on the left side of FIG. 4.

The drone 10 captures images of the “localization (self-position estimation) possible areas (a1) and (a2)” using the camera 11 by flying along such a flight route and can perform autonomous flight while performing self-position estimation with high accuracy using a SLAM process that uses feature points detected from a camera captured image.

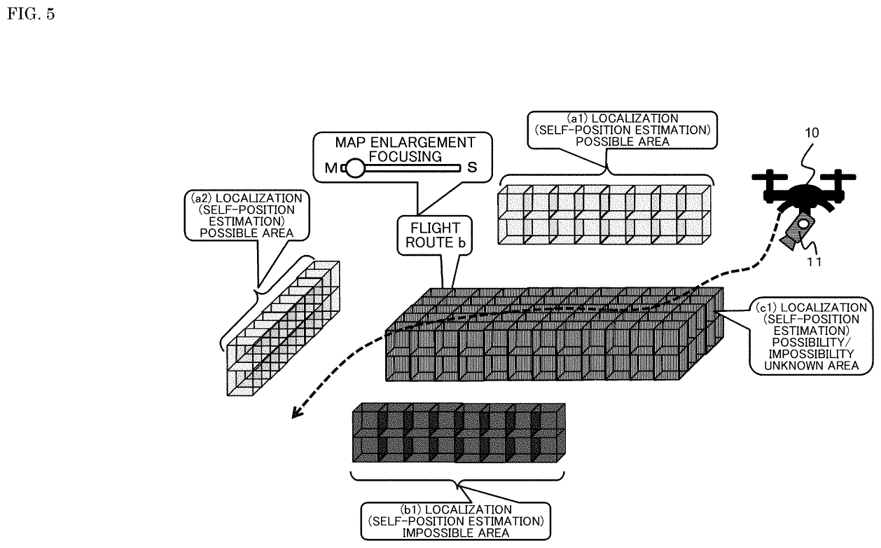

FIG. 5 is an example of “(2) Map enlargement-focused flight”.
“(2) Map enlargement-focused flight” is a flight mode in which, by intentionally flying over the “(c) localization (self-position estimation) possibility/impossibility unknown area”, the “(c) localization (self-position estimation) possibility/impossibility unknown area” is used to perform the process of analyzing any one of
(a) localization (self-position estimation) possible area and
(b) localization (self-position estimation) impossible area.

As illustrated in FIG. 5, the drone flies to pass through a “(c1) localization (self-position estimation) possibility/impossibility unknown area” of a center part of FIG. 5.

During flight of the “(c1) localization (self-position estimation) possibility/impossibility unknown area”, the drone 10 captures an image of the “(c1) localization (self-position estimation) possibility/impossibility unknown area” using the camera 11 and executes extraction of feature points from a captured image and self-position estimation using a SLAM process based on the extracted feature points.

In addition, a data processing unit of the drone 10 analyzes success/non-success of a feature point detecting process and a localization process (self-position estimating process) for a flight area (an imaged area according to the camera 11) inside of the “(c1) localization (self-position estimation) possibility/impossibility unknown area”.

An area for which the feature point detecting process and the localization (self-position estimation) process have been successful among “(c1) localization (self-position estimation) possibility/impossibility unknown areas is changed to the “localization (self-position estimation) possible area”, and the area is registered in the “localization feasibility information” inside of the storage unit of the drone 10.

On the other hand, an area for which the feature point detecting process and the localization (self-position estimation) process have not been successful among “(c1) localization (self-position estimation) possibility/impossibility unknown areas” is changed to the “localization (self-position estimation) impossible area”, and the area is registered in the “localization feasibility information” inside of the storage unit of the drone 10.

In this way, by performing “Map enlargement-focused flight”, an update process of “localization feasibility information” of sequentially changing the “(c) localization (self-position estimation) possibility/impossibility unknown area” to one of
(a) localization (self-position estimation) possible area and
(b) localization (self-position estimation) impossible area and registering the changed area can be performed.

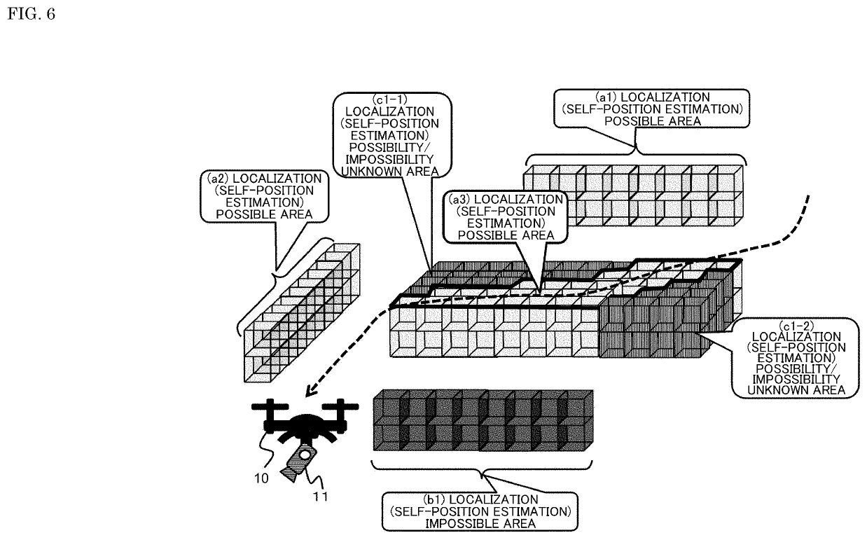

FIG. 6 illustrates an example of update of “localization feasibility information”. FIG. 6 is an example in which an update process of the “localization feasibility information” is performed by performing “Map enlargement-focused flight” for the center part of the “(c1) localization (self-position estimation) possibility/impossibility unknown area” described with reference to FIG. 5.

As illustrated in FIG. 6, after update, the center part of the “(c1) localization (self-position estimation) possibility/impossibility unknown area” before update illustrated in FIG. 5 is set as
(a3) localization (self-position estimation) possible area.

This represents that this area is an area for which the feature point detecting process and the localization process (the self-position estimating process) have been successful.

In addition, in the examples described with reference to FIGS. 1 to 6, although an example in which a divisional unit of each of
(a) localization (self-position estimation) possible area
(b) localization (self-position estimation) impossible area, and
(c) localization (self-position estimation) possibility/impossibility unknown area is set as a box-shaped (cubic) area having a three-dimensional shape has been illustrated.

These divisional areas are not limited to a box shape (cubic shape), and, for example, a rectangular area having a two-dimensional shape may be used.

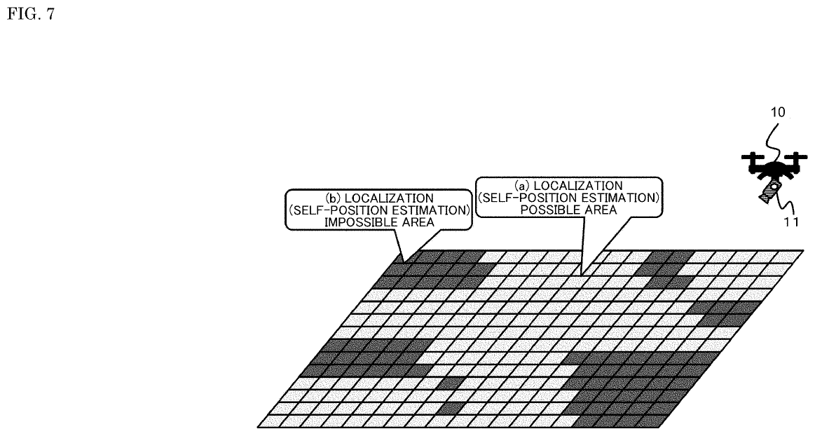

For example, as illustrated in FIG. 7, rectangular areas acquired by dividing a plane in a downward direction that is observed from an air space in which the drone 10 is flying into three areas including
(a) localization (self-position estimation) possible area,
(b) localization (self-position estimation) impossible area, and
(c) localization (self-position estimation) possibility/impossibility unknown area are set, and divisional area information in units of such rectangular areas may be recorded in the storage unit of the drone 10 as “localization feasibility information”.

In the example illustrated in FIG. 7, white rectangular areas are (a) localization (self-position estimation) possible areas, and grey rectangular areas are (b) localization (self-position estimation) impossible areas.

For example, “localization feasibility information” in which area division is set in such a rectangular plane area may be configured to be stored in the storage unit of the drone 10.

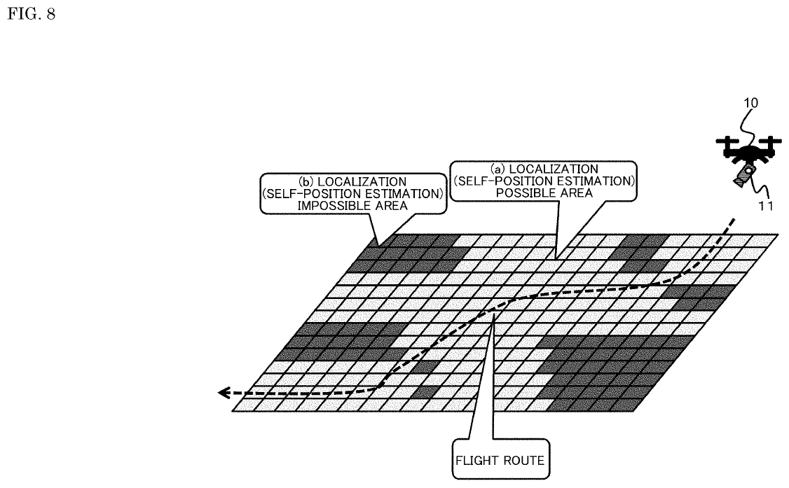

At the time of flying, by determining a flight route by referring to this “localization feasibility information” and flying along the flight route, for example, as illustrated in FIG. 8, the drone 10 can fly along a route for flying over “(a) localization (self-position estimation) possible areas”.

By flying along such a route, feature point detection using a captured image of “(a) localization (self-position estimation) possible areas”, a SLAM process using an analysis of detected feature points, and a localization (self-position estimation) process can be performed with high accuracy, and autonomous flight that is safe and reliable can be performed.

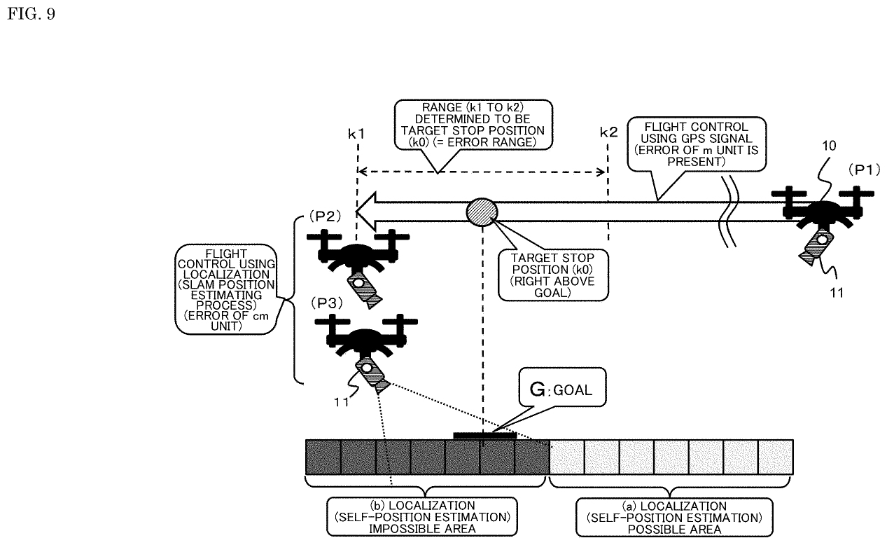

In addition, an example of a process of a case in which the drone 10 lands at a destination will be described with reference to FIG. 9.

The example illustrated in FIG. 9 is an example of a process in which the drone 10 flies at an outdoor place, flies while acquiring position information according to GPS signals, and lands at a goal place (G) set in advance.

As a problem in the self-position calculating process using the SLAM process, there is a problem that error is accumulated in a self-position calculated in the SLAM process according to long-time flight.

For this reason, for example, in the case of flying at an outdoor place at which GPS signals can be received, the drone 10 performs the process of flying while acquiring position information using GPS signals.

The example illustrated in FIG. 9 is an example in which the drone 10 flies while estimating a self-position using GPS signals received from GPS satellites.

The drone 10 flies toward a target stop position (k0) in an air space of the goal (G) while checking a self-position by receiving GPS signals from a position (P1). However, in a case in which there is error in units of meters in the position information acquired from GPS signals, and the drone 10 flies toward the target stop position (k0) in the air space of the goal (G), arrival at any place within a circle of a diameter k1 to k2 having the target stop position (k0) as illustrated in the drawing as its center becomes a limit. For example, as illustrated in FIG. 9, the drone 10 is assumed to have arrived at a position (P2).

The drone 10 starts lowering from a position (P2) illustrated in this FIG. 9 and is going to land at a goal place (G).

Here, in order to execute self-position estimation with high accuracy, the drone 10 is going to land at the goal place (G) while calculating a self-position using the SLAM process.

However, in the example illustrated in FIG. 9, since the goal place (G) is set as a localization impossible area, it becomes difficult to perform feature point detection from an image captured by the camera 11 of the drone 10 and a self-position estimating process, and thus it becomes difficult to accurately land at the goal place (G).

In such a case, by setting a flight route using the “localization feasibility information” according to the present disclosure described above, it becomes possible to accuracy land at the goal place (G).

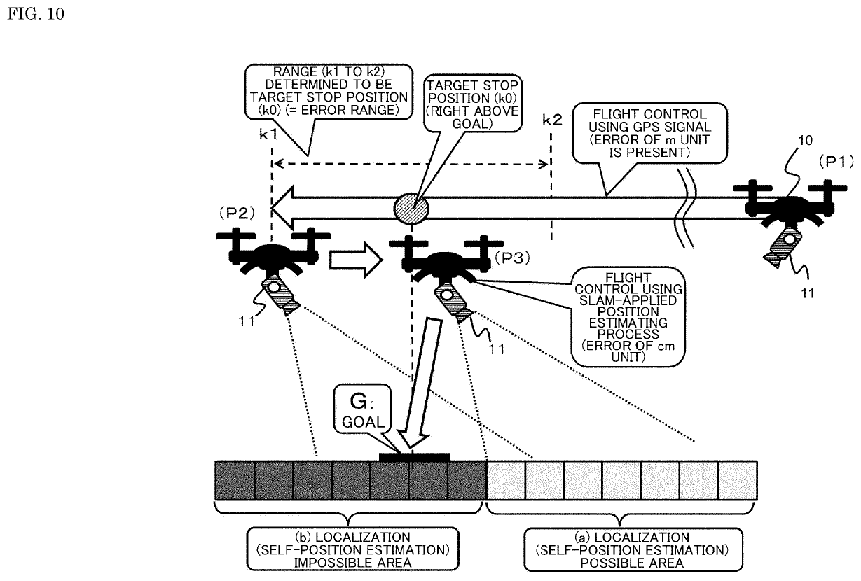

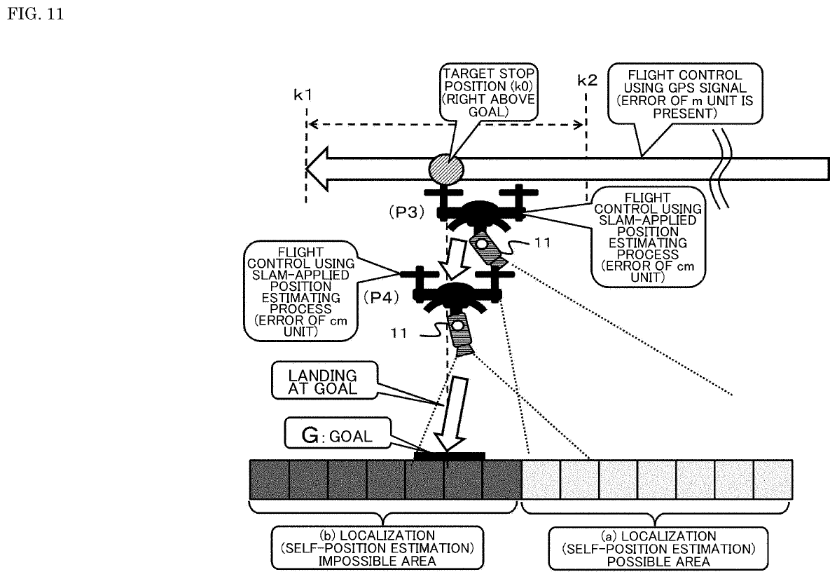

An example of a landing process for the goal place (G) using the “localization feasibility information” will be described with reference to FIGS. 10 and 11.

Similar to that described above with reference to FIG. 9, also the drone 10 illustrated in FIG. 10 flies toward a target stop position (k0) in the air space of a goal (G) while checking a self-position by receiving GPS signals from a position (P1). However, there is error in units of meters in position information acquired using GPS signals, and the drone 10 arrives at a place within a circle of a diameter k1 to k2 having a target stop position (k0) as its center without stopping at the target stop position (k0) in the air space of the goal (G). For example, as illustrated in FIG. 10, the drone 10 arrives at a position (P2).

Since self-position estimation using a SLAM process is executed at the position (P2) illustrated in FIG. 10, the drone 10 acquires “localization feasibility information” stored in the storage unit inside of the drone 10.

In the “localization feasibility information” stored in the storage unit inside of the drone 10, area information of two types of areas illustrated in FIG. 10, that is,
(a) localization (self-position estimation) possible area and
(b) localization (self-position estimation) impossible area is recorded.

In accordance with this “localization feasibility information”, the drone 10 present at the position (P2) advances to a position (P3) at which the “(a) localization (self-position estimation) possible area” can be imaged by the camera 11, images the “(a) localization (self-position estimation) possible area” from this position (P3), and executes a feature point acquiring process from a captured image and a localization (self-position estimation) process based on acquired feature points.

It is assured that the feature point acquiring process from a captured image and a localization (self-position estimation) process based on acquired feature points of this “(a) localization (self-position estimation) possible area” can be executed as a high-accuracy process.

Next, the drone 10 starts lowering from the position (P3) and, as illustrated in FIG. 11, can arrive at the “(a) localization (self-position estimation) possible area” and a position (P4) at which a goal (G) position can be imaged. Thereafter, while the goal (G) position is continuously imaged by the camera 11, the drone performs lowering to the goal (G) position and lands thereat.

By performing such a process, a landing process for a goal (G) position with high accuracy can be performed.

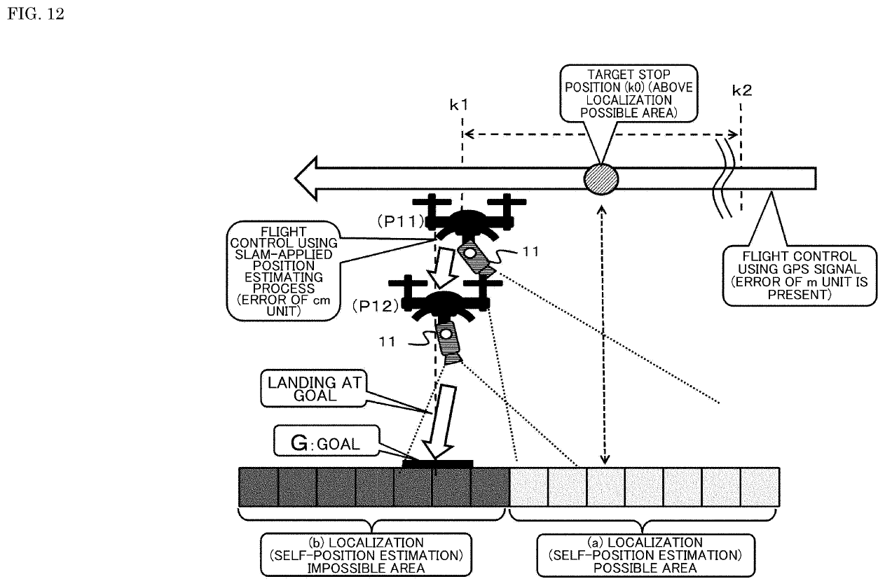

Alternatively, for example, as illustrated in FIG. 12, “a target stop place (k0) according to GPS” may be configured to be set to a position in the air space of the “(a) localization (self-position estimation) possible area side” in advance. In such a configuration, even in a case in which the drone 10 has deviated from “the target stop place (k0) according to GPS” and arrived at a position (P11) illustrated in FIG. 12, the “(a) localization (self-position estimation) possible area” can be imaged from this position by the camera 11.

Thereafter, the drone 10 starts lowering from the position (P11) and, as illustrated in FIG. 12, can arrive at a position (P12) at which the “(a) localization (self-position estimation) possible area” and the goal (G) position can be imaged. Thereafter, the drone performs lowering to the goal (G) position and lands thereat while continuously imaging the goal (G) position using the camera 11.

By performing such a process, a landing process for the goal (G) position with high accuracy can be performed.

In addition, for example, in a case in which the drone 10 includes an Inertial Measurement Unit (IMU) and the like and has a configuration in which SLAM, to which information such as an acceleration, an angular velocity, and the like of the drone 10, which is measured by the IMU is applied, can be executed, in addition to visual SLAM based on a camera captured image, by executing a SLAM process using measurement information acquired by the IMU together, a landing process for the goal (G) position with higher accuracy can be performed.

### 2. (Embodiment 1) Configuration Example of Mobile Body Control Device According to Embodiment 1 of Present Disclosure

Next, a configuration example of the mobile body control device According to Embodiment 1 of the present disclosure will be described.

Embodiment 1 is an embodiment in which a camera is configured to be fixed to the drone 10. Thus, control of an imaging direction of the camera is executed using posture control of the drone itself.

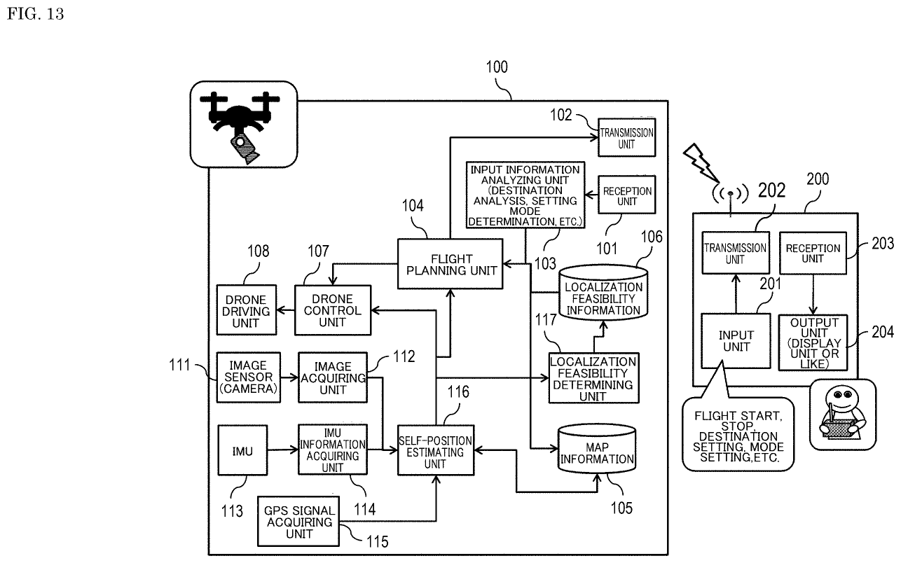

FIG. 13 illustrates a configuration example of a mobile body control device 100 according to Embodiment 1 of the present disclosure.

The mobile body control device 100 according to Embodiment 1 of the present disclosure is configured inside of the drone 10. FIG. 13 illustrates a configuration example of a controller 200 performing communication with the mobile body control device 100 of the drone 10 together.

As illustrated in FIG. 13, the mobile body control device 100 includes a reception unit 101, a transmission unit 102, an input information analyzing unit 103, a flight planning unit (a movement planning unit) 104, map information 105, localization feasibility information 106, a drone control unit 107, a drone driving unit 108, an image sensor (camera) 111, an image acquiring unit 112, an Inertial Measurement Unit (IMU) 113, and an IMU information acquiring unit 114, a GPS signal acquiring unit 115, a self-position estimating unit 116, and a localization feasibility determining unit 117.

The controller 200 includes an input unit 201, a transmission unit 202, a reception unit 203, and an output unit (a display unit and the like) 204.

First, constituent elements of the mobile body control device 100 illustrated in FIG. 13 will be described.

The reception unit 101 and the transmission unit 102 execute data communication with the controller 200.

The controller 200 is a controller that can be operated by a user and can transmit various instructions to the drone 10 and receive transmission data from the drone 10, for example, a camera captured image and the like.

The input information analyzing unit 103 analyzes information input from the controller 200 through the reception unit 101. More specifically, the controller 200 transmits a flight start instruction, a stop instruction, and an autonomous flight start instruction of the drone 10 or destination setting information, mode setting information, and the like.

The mode setting information, for example, is setting information of the flight mode that has been described above with reference to FIGS. 4 to 6 and is a flight mode such as the “success rate-focused flight mode” that is the flight mode described with reference to FIG. 4, the “map enlargement-focused mode” that is the flight mode described with reference to FIG. 5, and the like.

Information analyzed by the input information analyzing unit 103 is input to the flight planning unit 104.

The flight planning unit (the movement planning unit) 104 generates a flight plan (a drone flight path, a drone posture (a body orientation), and the like) toward a destination from a self-position (a current place) estimated by the self-position estimating unit 120. In addition, when a flight plan generating process is performed by the flight planning unit 104, the map information 105, and the localization feasibility information 106 are used.

By using the map information 105 and the localization feasibility information 106, for each of a plurality of path candidates from a current position or a start position of the drone 10 to a destination, the flight planning unit 104 executes cost calculation of a movement cost, a localization cost, and the like and determines an optimal flight path on the basis of calculated costs.

A specific processing example of a flight path determining process based on this cost calculation will be described in a later stage.

The map information 105 is a three-dimensional map of a three-dimensional space that is an area in which the drone 10 is flying, and, for example, three-dimensional point group information in which objects that are obstacles for flight are represented as a point group is used.

The localization feasibility information 106 is, for a movement area (a flight area) of the drone 10 as described above, localization feasibility information in units of predetermined divisional areas, for example, such as boxes (cubes) described with reference to FIG. 1 and the like, rectangular area units described with reference to FIG. 7, and the like, in other words, information representing which area among the following areas each divisional area is, that is, which area among (a) to (c) each divisional area is.
(a) Localization (self-position estimation) possible area
(b) Localization (self-position estimation) impossible area
(c) Localization (self-position estimation) possibility/impossibility unknown area

The flight planning unit 104 plans a flight path to a destination using the map information 105 and the localization feasibility information 106 described above. The flight plan information planned by the flight planning unit 104 is input to the drone control unit 1107.

The drone control unit 107 generates drone control information for causing the drone 10 to execute flight according to the flight plan information planned by the flight planning unit 104 and outputs the generated control information to the drone driving unit 108 to drive the drone, in other words, to cause the drone to fly. The drone driving unit 108 is configured using a motor, a propeller, and the like used for causing the drone 10 to fly.

An image sensor (camera) 111 corresponds to the camera 11 mounted in the drone 10 described above with reference FIG. 1 and the like.

In addition, the mobile body control device 100 may be configured to use not only a camera but also another sensor, for example, a distance sensor such as a LiDAR, a ToF sensor, or the like Furthermore, the mobile body control device 100 may be configured to use an infrared camera, a stereo camera, or the like.

In addition, as described above, in this Embodiment 1, the image sensor (the camera) 111 is fixed to a main body of the drone 10. Thus, the process of adjusting and changing the camera imaging direction of the image sensor (the camera) 111 is executed using posture control of the main body of the drone 10.

The image acquiring unit 112 receives a captured image acquired by the image sensor (the camera) 111 as input and outputs the input captured image to the self-position estimating unit 117.

The inertial measurement unit (IMU) 113 is configured using an acceleration sensor, an angular velocity sensor, and the like and measures an acceleration and an angular velocity of the drone 10.

The IMU information acquiring unit 114 receives an acceleration and an angular velocity of the drone 10 measured by the inertial measurement unit (IMU) 113 as input and outputs input information to the self-position estimating unit 117.

The GPS signal acquiring unit 115 receives GPS signals from GPS satellites and outputs received signals to the self-position estimating unit 117.

The self-position estimating unit 116 receives each piece of information such as a captured image from the image acquiring unit 112, information of an acceleration and an angular velocity of the drone 10 from the IMU information acquiring unit 114, and GPS signals from the GPS signal acquiring unit 115 as input and estimates position/posture of the drone 10.

The self-position/posture information of the drone 10 that has been estimated by the self-position estimating unit 116 is input to the flight planning unit 104, the drone control unit 107, and the localization feasibility determining unit 117. The flight planning unit 104 generates a flight plan of the drone 10 using the self-position/posture information of the drone 10 that has been estimated by the self-position estimating unit 116, and the drone control unit 107 controls the drone 10 in accordance with the generated flight plan.

The localization feasibility determining unit 117 receives the self-position/posture information of the drone 10 that has been estimated by the self-position estimating unit 116 as input, analyzes whether the self-position estimating process has been successful, unsuccessful, or the like, and performs a generation process or an update process of the localization feasibility information 106 on the basis of a result of the analysis.

The localization feasibility information 106 is information representing which area among these (a) to (c) a three-dimensional space in which the drone 10 is flying, a two-dimensional plane on the ground, or the like is in units of divisional areas.
(a) Localization (self-position estimation) possible area
(b) Localization (self-position estimation) impossible area
(c) Localization (self-position estimation) possibility/impossibility unknown area

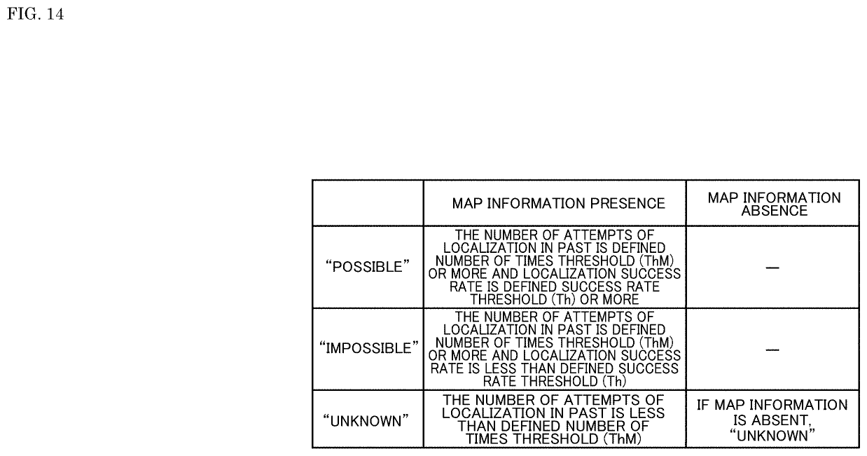

A specific processing example of a process of determining an area type (one of (a) to (c) described above) based on the self-position/posture information of the drone 10 that has been estimated by the self-position estimating unit 116 using the localization feasibility determining unit 117 will be described with reference to FIG. 14.

The localization feasibility determining unit 117, for example, in accordance with a determination criterion illustrated in FIG. 14, determines an area type (one of (a) to (c) described above) of a divisional area unit.

In addition, for example, for an area for which map information 105 configured from three-dimensional point group information has not been generated, as illustrated in the field of “Map Information Absence” in FIG. 14, all divisional areas included in the area are determined as
(c) localization (self-position estimation) possibility/impossibility unknown areas.

On the other hand, for example, for an area for which the map information 105 configured from three-dimensional point group information has been generated, an area type of a divisional area included in the area determined in accordance with a determination criterion represented in the field of “Map Information Presence” in FIG. 14.

In addition, as illustrated in FIG. 14, in a case in which the number of attempts of localization of a divisional area that is an area type determination target in the past is a defined number of times threshold (ThM) or more, and a localization success rate is a defined success rate threshold (Th) or more, the divisional area is determined to be
(a) localization (self-position estimation) possible area.

In addition, in a case in which the number of attempts of localization of a divisional area that is an area type determination target in the past is a defined number of times threshold (ThM) or more, and a localization success rate is less than the defined success rate threshold (Th), the divisional area is determined to be
(b) localization (self-position estimation) impossible area.

Furthermore, in a case in which the number of attempts of localization of a divisional area that is an area type determination target in the past is less than the defined number of times threshold (ThM), the divisional area is determined to be the (c) localization (self-position estimation) possibility/impossibility unknown area.

The localization feasibility determining unit 117, for example, by using the determination criterion represented in FIG. 14, receives self-position/posture information of the drone 10 that has been estimated by the self-position estimating unit 116 as input, determines an area type (one of (a) to (c) described above) of each divisional area unit, and performs a generation process or an update process of the localization feasibility information 106 in which a determination result is reflected.

Next, each constituent unit of the controller 200 illustrated in FIG. 13 will be described.

The controller 200 includes an input unit 201, a transmission unit 202, a reception unit 203, and an output unit (a display unit or the like) 204.

The input unit 201 is an input unit that can be operated by a user and, for example, inputs a flight start instruction, a stop instruction, or an autonomous flight start instruction for the drone 10 or destination setting information, a mode setting information, or the like.

The input information is transmitted to the mobile body control device 100 of the drone 10 through the transmission unit 202.

The mode setting information, as described above, for example, is flight mode setting information of the flight modes described above with reference to FIGS. 4 and 5 such as “success rate-focused flight mode” that is the flight mode described with reference to FIG. 4, “map enlargement-focused mode” that is the flight mode described with reference to FIG. 5, and the like.

The reception unit 203 receives transmission data from the mobile body control device 100 of the drone 10. For example, the reception unit receives information representing a flight state of the drone 10, a captured image of the image sensor (the camera) 11, and the like. Received information is output to the output unit 204, for example, configured using a display unit and the like.

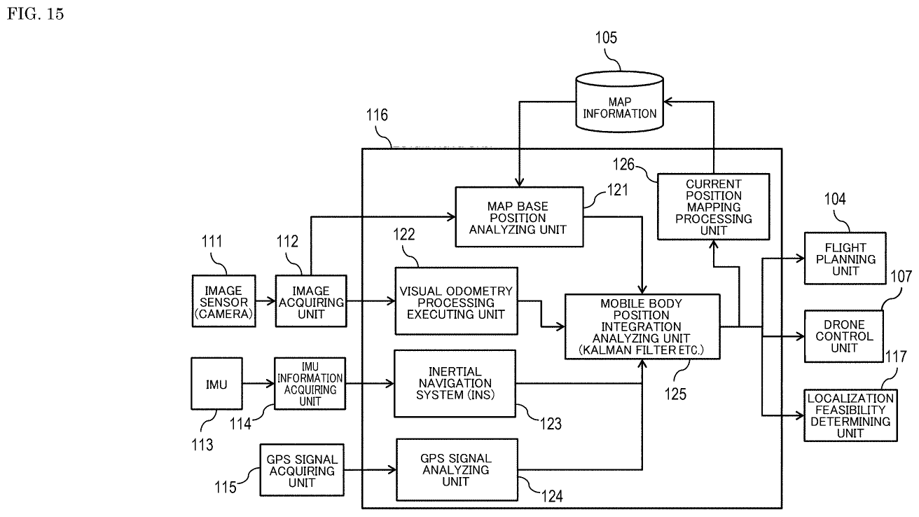

Next, a detailed configuration example of the self-position estimating unit 116 of the mobile body control device 100 illustrated in FIG. 13 will be described with reference to FIG. 15.

As illustrated in FIG. 15, the self-position estimating unit 116 of the mobile body control device 100 includes a map base position analyzing unit 121, a visual odometry processing executing unit 122, an inertial navigation system (INS) 123, a GPS signal analyzing unit 124, a mobile body position integration analyzing unit 125, and a current position mapping processing unit 126.

The map base position analyzing unit 121 receives a captured image acquired by the image sensor (the camera) 111 from the image acquiring unit 112 as input, executes a collation process between the captured image and the map information 105, and analyzes the position of the drone 10.

The visual odometry processing executing unit 122 receives a captured image acquired by the image sensor (the camera) 111 from the image acquiring unit 112 as input and executes a self-position/posture estimating process using a SLAM process to which the captured image is applied. More specifically, the self-position/posture estimating process using feature point detection from a captured image acquired by the image sensor (the camera) 111 and a process of tracking the detected feature points is executed.

The inertial navigation system (INS) 123 receives an acceleration and an angular velocity of the drone 10 from the inertial measurement unit (IMU) 113, that is, the inertial measurement unit (IMU) 113 configured using an acceleration sensor, an angular velocity sensor, and the like as input and calculates a position and a posture of the drone 10 on the basis of such input information.

The GPS signal analyzing unit 124 receives GPS signals acquired by the GPS signal acquiring unit 115 as input and calculates the position of the drone 10 on the basis of the input signals.

Four processing units including the map base position analyzing unit 121, the visual odometry processing executing unit 122, the inertial navigation system (INS) 123, and the GPS signal analyzing unit 124 calculate the position and the posture of the drone 10 using different techniques. All such information is input to the mobile body position integration analyzing unit 125.

The mobile body position integration analyzing unit 125 integrates position information and posture information of the drone 10 input from these four processing units including the map base position analyzing unit 121, the visual odometry processing executing unit 122, the inertial navigation system (INS) 123, and the GPS signal analyzing unit 124 and calculates a position and a posture of the drone 10 that are final.

The mobile body position integration analyzing unit 125 executes the process of calculating final position/posture information of the drone 10 by integrating positions and postures calculated using a plurality of different algorithms and time-series position/posture information, and the like, for example, using a fusion algorithm such as a Kalman filter.

The position/posture information of the drone 10 calculated by the mobile body position integration analyzing unit 125 is input to the current position mapping processing unit 126, the flight planning unit 104, the drone control unit 107, and the localization feasibility determining unit 117.

The current position mapping processing unit 126 records the position/posture information of the drone 10 that has been calculated by the mobile body position integration analyzing unit 125 in the map information 105.

The flight planning unit 104 generates a flight plan of the drone 10 using the self-position/posture information of the drone 10 that has been estimated by the self-position estimating unit 116, and the drone control unit 107 controls the drone 10 in accordance with the generated flight plan.

### 3. Details of Process Executed by Mobile Body Control Device According to Embodiment 1 of Present Disclosure

Next, details of the process executed by the mobile body control device according to Embodiment 1 of the present disclosure will be described.

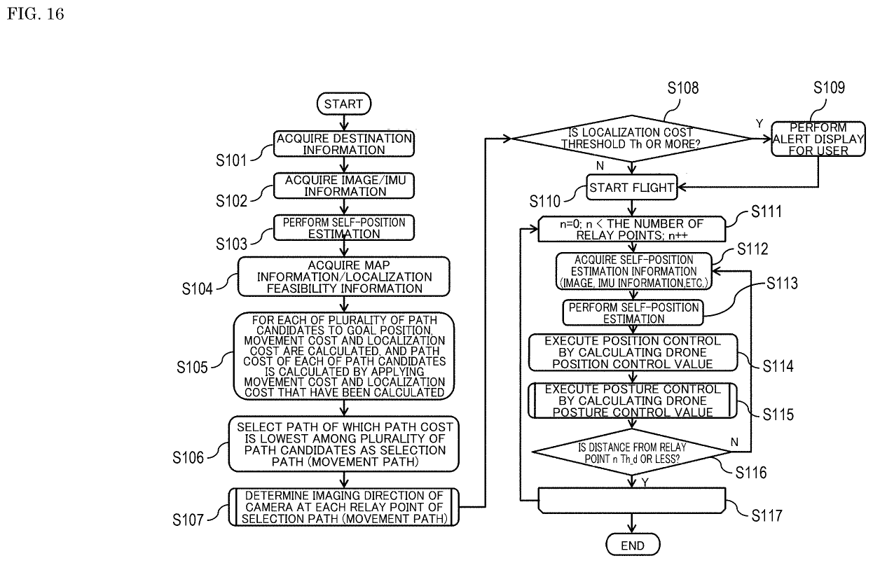

A flowchart illustrated in FIG. 16 is a flowchart describing details of the process executed by the mobile body control device according to Embodiment 1 of the present disclosure.

In addition, the process according to the flow illustrated in FIG. 16 and subsequent drawings can be executed under control of a control unit (a data processing unit) configured using a CPU having a program execution function and the like in accordance with a program stored in an internal memory of the mobile body control device and the like.

Hereinafter, processing of each step of the flow shown in FIG. 16 will be described in order.

### (Step S101)

First, the mobile body control device 100 acquires destination information in Step S101.

This process, for example, is executed as a process of receiving destination information from the controller 200 through the reception unit 101 using the input information analyzing unit 103 illustrated in FIG. 13.

### (Step S102)

Next, the mobile body control device 100 acquires an image and IMU information in Step S102.

This process, for example, is executed as a process of the image acquiring unit 112 illustrated in FIG. 13 acquiring a captured image acquired by the image sensor (the camera) 111 and a process of the IMI information acquiring unit 114 acquiring an acceleration, each piece of acceleration information, and the like of the drone 10 from the IMU 113.

Such acquired information is input to the self-position estimating unit 116.

### (Step S103)

Next, the mobile body control device 100 executes a self-position estimating process in Step S103.

This process, for example, is a process executed by the self-position estimating unit 116 illustrated in FIG. 13.

The self-position estimating unit 116, as described above with reference to FIG. 15, for example, calculates a position and a posture of the drone 10 that are final by integrating position information and posture information of the drone 10 that are input from the map base position analyzing unit 121, the visual odometry processing executing unit 122, the inertial navigation system (INS) 123, the GPS signal analyzing unit 124, and the like.

### (Step S104)

Next, the mobile body control device 100 acquires the map information 105 and the localization feasibility information 106 in Step S104.

This process is a process executed by the flight planning unit 104 illustrated in FIG. 13.

The map information 105 is a three-dimensional map of a three-dimensional space that is an area in which the drone 10 is flying and, for example, is map information configured using three-dimensional point group information in which objects that are obstacles for flight are represented as a point group.

The localization feasibility information 106 is information representing which area type in units of predetermined divisional areas such as units of boxes (cubes), rectangular areas, or the like divided by grids (localization feasibility information), that is, which area of (a) to (c) each divisional area is.
(a) Localization (self-position estimation) possible area
(b) Localization (self-position estimation) impossible area
(c) Localization (self-position estimation) possibility/impossibility unknown area

### (Step S105)

Next, in Step S105, the mobile body control device 100 calculates a movement cost and a localization cost of each of a plurality of paths that can be set as a path to a destination using the map information 105 and the localization feasibility information 106 acquired in Step S104 and calculates a path cost of each of path candidates by applying the movement cost and the localization cost of each of the plurality of paths that have been calculated.

This process is also a process executed by the flight planning unit 104 illustrated in FIG. 13.

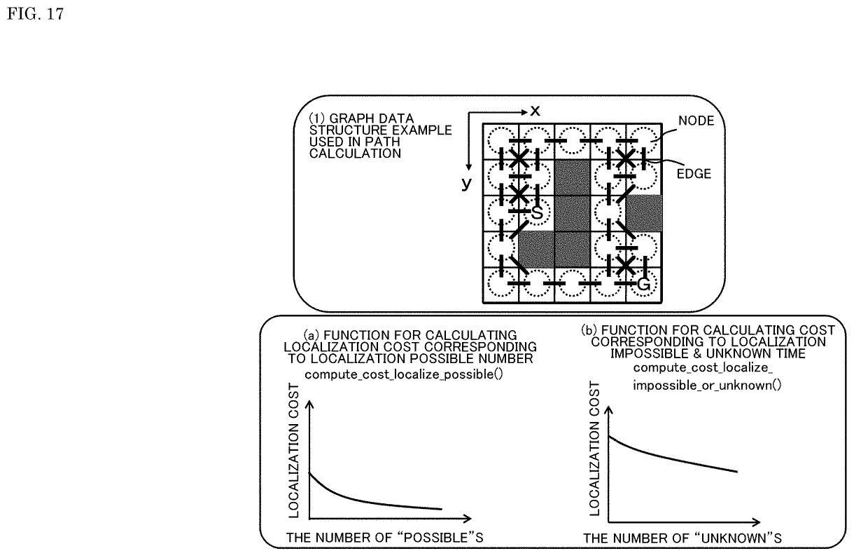

A specific example of the process of calculating a movement cost and a localization cost of each of a plurality of paths to a destination that is executed by the flight planning unit 104 will be described with reference to FIG. 17.

As one example, as a movement path planning technique for a mobile body such as a drone, a cost calculating process using a graph data structure that is frequently used will be described.

In the movement path planning technique using a graph data structure, as illustrated in FIG. 17(1), a movement space of a mobile body such as a drone is equally divided, a node is disposed in each divisional area, an edge connecting nodes that are adjacent to each other is set, and a cost is calculated using a graph algorithm.

Originally, although three-dimensional xyz (z=altitude) data is analyzed, data on a two-dimensional xy plane is represented through simplification in FIG. 17(1).

A divisional area (square), in which one node is set, illustrated in FIG. 17(1) corresponds to a divisional area for which an area type (localization feasibility information) used in the process according to the present disclosure is set, that is, a box (a cube) or a rectangular area divided by grids.

The flight planning unit 104 calculates a movement cost and a localization cost of each of a plurality of paths that can be set as a path to a destination.

The movement cost, for example, rises in proportion to a movement distance.

For the localization cost, for example, a cost calculation function as represented in each graph illustrated in a lower stage of FIG. 17 is used.

FIG. 17(a) illustrates one example of a cost corresponding to a localization possible number calculation function (compute_cost_localize_possible( )).

For example, the more the number of localization possible areas among divisional areas adjacent to a divisional area in which one certain node is set, the lower the localization cost.

FIG. 17(b) illustrates one example of a cost corresponding to a localization impossible & unknown time calculation function (compute_cost_localize_impossible_or_unknown( )).

For example, the more the number of localization possibility/impossibility unknown area among divisional areas adjacent to a divisional area in which one certain node is set, the lower the localization cost.

For example, in a graph structure illustrated in FIG. 17(1), as paths from a start node position (S: src_node) to a goal node position (G: dest_node) of a mobile body (drone), a plurality of paths can be generated by connecting nodes and edges illustrated in FIG. 17(1).

For such a plurality of paths, a cost corresponding to each path (a path cost: cost (src_node, dest_node)) is calculated in accordance with the following cost calculation equation (Equation 1).

$$cost ( src\_node , dest\_node ) = w 1 \times ( movement cost ) + w 2 \times ( localization cost ) \qquad ( Equation 1 )$$

In (Equation 1) represented above, w1 and w2 are weight coefficients defined in advance.

In the above-described cost calculation equation (Equation 1), (movement cost) becomes a cost value that rises in proportion to a movement distance.

The localization cost is a cost value calculated using the following “localization cost calculation algorithm AL1” using functions including the cost corresponding to the localization possible number calculation function (compute_cost_localize_possible( )) and the cost corresponding to the localization impossible & unknown time calculation function (compute_cost_localize_impossible_or_unknown( )) represented in FIGS. 17(a) and 17(b).

“Localization cost calculation algorithm AL1”
if 4 direction localization feasibility information.all( ) == “impossible”:
cost = HIGHEST_COST_VALUE;# maximum cost fixed value
else if: 4 direction localization feasibility information.any( ) == “possible”:# minimum
one “possible” is present
cost=compute_cost_localize_possible(num_of_“possible”);
else:# “impossible” or “unknown”
cost=compute_cost_localize_impossible_or_unknown(num_of_“unknown”);

In the algorithm described above, the “4 direction localization feasibility information” is localization feasibility information of four divisional areas adjacent to a divisional area, to which one node belonging to a path that is a cost calculation target belongs, in forward, backward, leftward, and rightward directions. These 4 directions are directions that can be set as imaging directions of the image sensor (the camera) 111.

The “localization cost calculation algorithm AL1” described above is a cost calculation algorithm in which the more localization possible areas in divisional areas on the periphery of four forward, backward, leftward, and rightward directions of a divisional area configuring a path from a start node position (S: src_node) to a goal node position (G: dest_node), the smaller the cost value, and the more localization impossible areas or localization possibility/impossibility unknown areas in divisional area on the periphery of a divisional area configuring the path, the more the cost value.

The flight planning unit 104 of the mobile body control device 100 illustrated in FIG. 13, in Step S105 of the flow illustrated in FIG. 16, for a plurality of paths from a start node position (S: src_node) to a goal node position (G: dest_node), calculates a cost corresponding to each path (path cost: cost(src_node, dest_node)) in accordance with the following cost calculation equation (Equation 1).

$$cost ( src\_node , dest\_node ) = w 1 \times ( movement cost ) + w 2 \times ( localization cost ) \qquad ( Equation 1 )$$

In the cost calculation equation (Equation 1), the longer the distance of a path, the higher the cost becomes, and the higher the localization cost of a path, the higher the cost becomes.

In addition, regarding the localization cost of a path, as described above, the more localization possible areas in divisional areas on the periphery of divisional areas configuring the path, the lower the cost becomes, and the more localization impossible areas or localization possibility/impossibility unknown areas in divisional areas on the periphery of the divisional areas configuring the path, the higher the cost becomes.

### (Step S106)

Next, the mobile body control device 100, in Step S106, compares a path cost of each of a plurality of path candidates to a destination that has been calculated in Step S105 with a path cost of each path candidate calculated by applying a movement cost and a localization cost and selects a path candidate for which a lowest cost value has been calculated as a selection path (movement path).

This process is also a process that is executed by the flight planning unit 104 illustrated in FIG. 13.

In addition, the flight planning unit 104 records and maintains selection path (movement path) information of the lowest cost determined in Step S106 in the map information 105.

### (Step S107)

Next, the mobile body control device 100, in Step S107, determines a camera imaging direction at each relay point of the selection path (movement path) selected in Step S106.

This process is also a process that is executed by the flight planning unit 104 illustrated in FIG. 13.

A relay point is a point on the selection path (the movement path) selected in Step S106 and, for example, is set for every pre-defined distance. Alternatively, in addition to points for every predetermined distance, a point for changing the traveling direction of the drone may be additionally set.

This process is a process for setting a camera imaging direction at each relay point of the selection path (the movement path) to be directed toward a localization possible area as possibly as can.

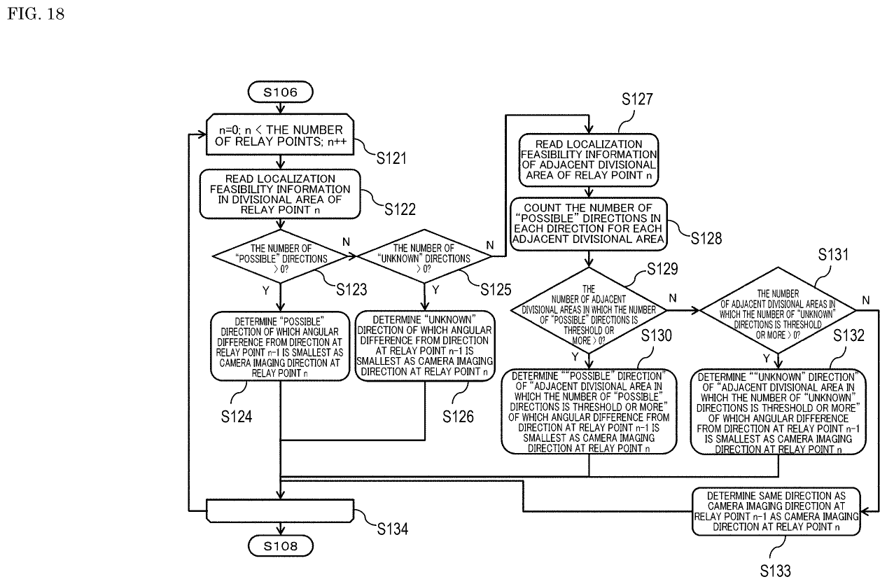

A detailed sequence of this Step S107 will be described in a later stage with reference to a flowchart illustrated in FIG. 18.

In addition, the flight planning unit 104 records and maintains relay point information in the selection path (the movement path) determined in Step S107 and the camera imaging direction information at each relay point in the map information 105.

### (Step S108)

Next, the mobile body control device 100 determines whether or not the localization cost of the selection path (the movement path) selected in Step S106 is a pre-defined threshold or more in Step S108.

This process is also a process that is executed by the flight planning unit 104 illustrated in FIG. 13.

The localization cost of the selection path (the movement path) that is a verification target here is a cost value of the selection path (the movement path) calculated in accordance with the “localization cost calculation algorithm AL1” described above.

In a case in which it is determined that the localization cost of the selection path (the movement path) a pre-defined threshold or more, the process is caused to proceed to Step S109, and in a case in which the localization cost is less than the threshold, the process is caused to proceed to Step S110.

### (Step S109)

Step S109 is a process executed in a case in which the localization cost of the selection path (the movement path) selected in Step S106 is determined to be the pre-defined threshold or more in Step S108.

In this case, the mobile body control device 100 executes an alert display (a warning display) for a user in Step S109.

For example, a warning message is transmitted to the controller 200 used by a user, and an alert display (a warning display) is executed for the output unit 204 of the controller 200.

In accordance with this process, the user can understand that the flight accompanies a risk in advance, and the user can perform a countermeasure such as stop of the flight or the like.

### (Step S110)

Next, in Step S110, the mobile body control device 100 starts flight of the drone 10 along the selection path (the movement path) selected in Step S106.

This process is a process that is executed by the drone control unit 107 of the mobile body control device 100 illustrated in FIG. 13.

### (Steps S111 to S117)

Processes of Steps S111 to S117 are processes that are repeatedly executed during flight along the selection path (the movement path) selected in Step S106 by the drone 10.

At each relay point of the selection path (the movement path), the following processes are executed.

### (Step S112)

Self-position estimation information, for example, a captured image acquired by the image sensor (the camera) 111, detection information (an acceleration, an angular velocity, and the like) of the IMU 113, and the like are acquired.

### (Step S113)

A self-position estimation process using the self-position estimation information acquired in Step S112 is executed. This process is executed by the self-position estimating unit 116.

### (Step S114)

On the basis of a self-position estimation result estimated in Step S113, as a drone control value for moving along the selection path (the movement path), a drone position control value used for controlling the drone position is calculated, and the drone position is controlled in accordance with the calculated control value.

### (Step S115)

A drone posture control value used for controlling the posture of the drone at the drone position calculated in Step S114 is calculated, and the drone posture is controlled in accordance with the calculated control value.

This drone posture control is executed for controlling the camera imaging direction of the image sensor (the camera) 111.

In other words, posture control for directing the camera imaging direction according to the image sensor (the camera) 111 toward a direction, in which the (a) localization (self-position estimation) possible area” can be imaged as possibly as can, is executed.

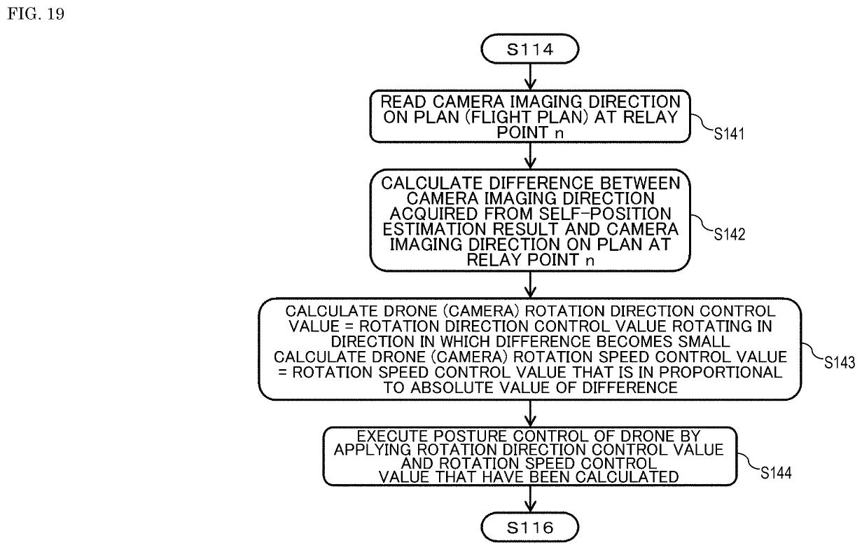

A detailed sequence of this Step S115 will be described with reference to a flowchart illustrated in FIG. 19 in a later stage.

### (Step S116)

The processes of Steps S112 to S115 are repeated until a distance to a next relay point becomes a defined threshold or less, and, when the distance to the next relay point becomes the defined threshold or less, the processes of Steps S111 to S117 are repeated as a process corresponding to the next relay point.

When the drone passes through all the relay points set in the selection path (the movement path), the process ends.

At this time point, the drone comes into a state in which it can arrive at the goal (G), in other words, a state in which a goal (G) place can be checked using a captured image acquired by the image sensor (the camera) 111.

Next, a detailed sequence of the process of Step S107 in the flow illustrated in FIG. 16, that is, the process of determining a camera imaging direction at each relay point of the selection path (the movement path) selected in Step S106 will be described with reference to the flowchart illustrated in FIG. 18.

This process is a process executed by the flight planning unit 104 of the mobile body control device 100 illustrated in FIG. 13.

The relay points are points on the selection path (a movement path) selected in Step S106 as described above and, for example, are set for every pre-defined distances. Alternatively, points for changing the traveling direction of the drone may be added to the points for every pre-defined distances.

The process of Step S107 is a process for determining the camera imaging direction at each relay point of the selection path (the movement path) in advance to be directed toward a localization possible area as possibly.

In addition, as described above, in this Embodiment 1, the image sensor (the camera) 111 is fixed to the main body of the drone 10. Thus, the change of the camera imaging direction of the image sensor (the camera) 111 is executed using posture control of the main body of the drone 10.

The posture control during flight of the drone 10 is executed in Step S115 of the flow illustrated in FIG. 16. Details of this process will be described in a later stage with reference to FIG. 19.

First, hereinafter, a detailed sequence of the process of Step S107 of the flow illustrated in FIG. 16, that is, the process of determining in advance the camera imaging direction at each relay point of the selection path (the movement path) to be directed toward a localization possible area as possibly will be described with reference to the flowchart illustrated in FIG. 18.

The flow illustrated in FIG. 18 is a process that is repeatedly executed for each relay point set in the selection path (the movement path) selected in Step S106 of the flow illustrated in FIG. 16.

For each relay point set in the selection path (the movement path), processes of the following (Step S122) to (Step S134) are executed, and the camera imaging direction at each relay point is determined in advance to be directed toward a localization possible area as possibly.

Hereinafter, the processes of each step will be described in sequence.

### (Step S122)

First, in Step S122, localization feasibility information of each of divisional areas of four forward/backward/leftward/rightward directions of one relay point n selected as a verification target is acquired.

In other words, the flight planning unit 104 of the mobile body control device 100 illustrated in FIG. 13 acquires localization feasibility information of each of divisional areas of four forward/backward/leftward/rightward directions of the relay point n from the localization feasibility information 106.

### (Step S123)

Next, in Step S123, it is determined whether or not one or more “localization (self-position estimation) possible areas” are present in the divisional areas of the four forward/backward/leftward/rightward directions of the relay point n by referring to the localization feasibility information acquired in Step S122.

In a case in which one or more localization possible areas are present, the process is caused to proceed to Step S124.

In a case in which there is no localization possible area at all, the process is caused to proceed to Step S125.

### (Step S124)

In Step S123, in a case in which it is determined that one or more “localization (self-position estimation) possible areas” are present in divisional areas of four forward/backward/leftward/rightward directions of the relay point n, the following process is executed in Step S124.

The flight planning unit 104 of the mobile body control device 100 illustrated in FIG. 13 determines a direction of a “localization (self-position estimation) possible area” of which an angular difference from the camera imaging direction at a relay point n−1 that is a previous relay point of the relay point n, which is currently a processing target, is the smallest as the camera imaging direction at the relay point n in Step S124.

In addition, the relay point n−1 is a relay point through which the drone 10 passes immediately before the drone 10 arrives at the relay point n in the selection path (the movement path) selected in Step S106.

### (Step S125)

On the other hand, in a case in which it is determined that no “localization (self-position estimation) possible area” is present at all in divisional areas of four forward/backward/leftward/rightward directions of the relay point n in Step S123, the following process is executed in Step S125.

In Step S125, it is determined whether or not one or more “localization (self-position estimation) possibility/impossibility unknown areas” are present in the divisional areas of the four forward/backward/leftward/rightward directions of the relay point n by referring to the localization feasibility information acquired in Step S122.

In a case in which one or more localization possibility/impossibility unknown areas are present, the process is caused to proceed to Step S126.

In a case in which no localization possibility/impossibility unknown area is present at all, the process is caused to proceed to Step S127.

### (Step S126)

In a case in which it is determined that one or more “localization (self-position estimation) possibility/impossibility unknown areas” are present in divisional areas of the four forward/backward/leftward/rightward directions of the relay point n in Step S125, the following process is executed in Step S126.

The flight planning unit 104 of the mobile body control device 100 illustrated in FIG. 13 determines a direction of a “localization (self-position estimation) possibility/impossibility unknown area” of which an angular difference from the camera imaging direction at a relay point (n−1) that is a previous relay point of the relay point n, which is currently a processing target, is the smallest as the camera imaging direction at the relay point n in Step S126.

### (Step S127)

On the other hand, in a case in which it is determined that no “localization (self-position estimation) possibility/impossibility unknown area” is present at all in divisional areas of four forward/backward/leftward/rightward directions of the relay point n in Step S125, the following process is executed in Step S127.

In Step S127, localization feasibility information of each of divisional areas of four forward/backward/leftward/rightward directions in divisional areas adjacent to the relay point n is acquired.

### (Step S128)

Next, in Step S128, for each of divisional areas adjacent to the relay point n acquired in Step S127, the number of “localization (self-position estimation) possible areas” included in the localization feasibility information of each of divisional areas of four forward/backward/leftward/rightward directions (area number) is counted.

### (Step S129)

Next, in Step S129, for each of the divisional areas adjacent to the relay point n counted in Step S128, it is determined whether or not there is an adjacent divisional area in which the number of “localization (self-position estimation) possible areas” included in the localization feasibility information of each of the divisional areas of the four forward/backward/leftward/rightward directions (the area number) is a pre-defined threshold or more.

In a case in which there is an adjacent divisional area in which the number of localization possible areas (the area number) is the pre-defined threshold or more, the process is caused to proceed to Step S130.

In a case in which there is no localization possible area at all, the process is caused to proceed to Step S131.

### (Step S130)

In Step S129, for each of divisional areas adjacent to the relay point n, in a case in which it is determined that there is an adjacent divisional area of which the number of “localization (self-position estimation) possible areas” (area number) included in the localization feasibility information of each of divisional areas of four forward/backward/leftward/rightward directions is a pre-defined threshold or more, the following process is executed in Step S130.

The flight planning unit 104 of the mobile body control device 100 illustrated in FIG. 13 determines a ““possible” direction” in “an adjacent divisional area of which the number of “possible” directions is a threshold or more” of which an angular difference from the direction at the previous relay point n−1 of the relay point n that is currently a processing target is the smallest as the camera imaging direction at the relay point n in Step S130.

In other words, a direction of which an angular difference from the direction at the previous relay point n−1 of the relay point n that is currently a processing target is the smallest among “directions of “localization (self-position estimation) possible areas” in adjacent divisional areas of which the number of localization possible areas (area number) is a pre-defined threshold or more”, selected in Steps S128 to S129 is determined as the camera imaging direction at the relay point n.

### (Step S131)

On the other hand, in a case in which it is determined that there is no adjacent divisional area of which the number of “localization (self-position estimation) possible areas” (the area number) included in the localization feasibility information of each of divisional areas of four forward/backward/leftward/rightward directions is a pre-defined threshold or more at all for each of adjacent divisional areas of the relay point n in Step S129, the following process is executed in Step S131.

In Step S131, it is determined whether or not there is an adjacent divisional area of which the number of “localization (self-position estimation) possibility/impossibility unknown areas” (the area number) included in the localization feasibility information of each of divisional areas of four forward/backward/leftward/rightward directions is a pre-defined threshold or more for each of adjacent divisional areas of the relay point n counted in Step S128.

In a case in which there is an adjacent divisional area of which the number of localization possibility/impossibility unknown areas (area number) is pre-defined threshold or more, the process is caused to proceed to Step S132.

In a case in which there is no such adjacent divisional area at all, the process is caused to proceed to Step S133.

### (Step S132)

In a case in which it is determined that there is an adjacent divisional area in which the number of “localization (self-position estimation) possibility/impossibility unknown areas” (the area number) included in the localization feasibility information of each of divisional areas of four forward/backward/leftward/rightward directions is a pre-defined threshold or more for each of adjacent divisional areas of the relay point n in Step S131, the following process is executed in Step S132.

The flight planning unit 104 of the mobile body control device 100 illustrated in FIG. 13 determines an ““unknown” direction” of “an adjacent divisional area, of which the number of “unknown” directions is a threshold or more”, of which an angular difference from the direction at the previous relay point n−1 of the relay point n that is currently a processing target is the smallest as the camera imaging direction at the relay point n in Step S132.

In other words, a direction of which an angular difference from the direction at the previous relay point n−1 of the relay point n that is currently a processing target is the smallest among “directions of “localization (self-position estimation) possibility/impossibility unknown areas” in adjacent divisional areas in which the number of localization possibility/impossibility unknown areas (the area number) is a pre-defined threshold or more” is determined as the camera imaging direction at the relay point n.

### (Step S133)

On the other hand, in a case in which it is determined that there is no adjacent divisional area in which the number of “localization (self-position estimation) possibility/impossibility unknown areas” (the area number) included in the localization feasibility information of each of divisional areas of four forward/backward/leftward/rightward directions is the pre-defined threshold or more for each of adjacent divisional areas of the relay point n in Step S131, the following process is executed in Step S133.

The flight planning unit 104 of the mobile body control device 100 illustrated in FIG. 13 determines the camera imaging direction of the previous relay point n−1 of the relay point n that is currently a processing target as the camera imaging direction at the relay point n as it is in Step S133.

As described above, the process of Step S107 in the flow illustrated in FIG. 16, that is, the process of determining the camera imaging direction at each relay point of the selection path (the movement path) selected in Step S106 is executed in accordance with the flow illustrated in FIG. 18.

The process of this Step S107 is a process for determining the camera imaging direction at each relay point of the selection path (the movement path) to be directed toward a localization possible area as possibly as can in advance.

The camera imaging direction information of each relay point determined in accordance with the flow illustrated in FIG. 18 is recorded inside of the map information 106 together with selection path information and relay point information.

In addition, as described above, in this Embodiment 1, the image sensor (the camera) 111 is fixed to the main body of the drone 10. Thus, during the flight of the drone 10, control of the camera imaging direction of the image sensor (the camera) 111 is executed using posture control of the main body of the drone 10.

At each relay point, posture control of the drone is executed such that the camera imaging direction of the image sensor (the camera) 111 is the direction determined in Step S107. In other words, the camera imaging direction of the image sensor (the camera) 111 is controlled to be directed toward a localization possible area as possibly as can.

The posture control during flight of the drone 10 is executed in Step S115 of the flow illustrated in FIG. 16. Details of this process will be described with reference to FIG. 19.

The process of Step S115 in the flow illustrated in FIG. 16 is a process of calculating a drone posture control value used for controlling the posture of the drone at a drone position of the relay point n calculated in Step S114 and controlling the drone posture in accordance with the calculated control value. A detailed sequence of this process will be described with reference to the flowchart illustrated in FIG. 19. This process is a process that is executed by the drone control unit 107 of the mobile body control device 100 illustrated in FIG. 13.

During flight of the drone 10 along the selection path (the movement path), the drone control unit 107 executes following processes of (Step S141) to (Step S144) at each relay point set in the selection path (the movement path).

### (Step S141)

First, the drone control unit 107 of the mobile body control device 100 reads a camera imaging direction on a plan (a flight plan) at the relay point n in Step S141. The camera imaging direction on the plan (the flight plan) at the relay point n is a camera imaging direction determined in Step S107 of the flow illustrated in FIG. 13, that is, in accordance with the flow described reference to FIG. 18 and is a direction for causing the camera imaging direction of the image sensor (the camera) 111 to be directed toward a localization possible area as possibly as can.

This camera imaging direction information is acquired from the map information 106.

As described above, the camera imaging direction information of each relay point determined in accordance with the flow illustrated in FIG. 18 is recorded in the map information 106 together with selection path information and relay point information, and the drone control unit 107 reads the camera imaging direction corresponding to a relay point from the map information 106.

### (Step S142)

Next, in Step S142, the drone control unit 107 of the mobile body control device 100 calculates a difference between the current camera imaging direction based on the drone position/posture analyzed from a self-position estimation result of the current position (the relay point n) calculated in Step S113 of the flow illustrated in FIG. 16 and the camera imaging direction on the plan at the relay point n recorded as the flight plan.

### (Step S143)

Next, the drone control unit 107 of the mobile body control device 100 executes the following process in Step S143.

A drone (camera) rotation direction control value=a rotation direction control value for rotating in a direction for decreasing the difference is calculated. A drone (camera) rotation speed control value=a rotation speed control value that is in proportion to the absolute value of the difference is calculated.

### (Step S144)

Next, the drone control unit 107 of the mobile body control device 100 executes the following process in Step S144.

Posture control of the drone is executed by applying the rotation direction control value and the rotation speed control value calculated in Step S143.

In accordance with such a process, the camera imaging direction of the drone 10 is set as the camera imaging direction of each relay point determined in Step S107. As a result, the probability of succeeding in image capture of a localization possible area becomes high, and the probability of succeeding in feature point extraction from a captured image, a SLAM process according to a feature point tracking, and the self-position/posture estimating process becomes high, and movement control (flight control) with high accuracy according to a planned movement path (flight path) is realized.

### 4. (Embodiment 2) Configuration and Processing Example of Mobile Body Control Device According to Embodiment 2 of Present Disclosure

Next, a configuration and a processing example of the mobile body control device according to Embodiment 2 of the present disclosure will be described.

Embodiment 1 described above is an embodiment of a case of a configuration in which a camera mounted in the drone 10 is fixed to the drone and has a configuration in which posture control of the drone itself is performed in a case in which the camera imaging direction is controlled.

Embodiment 2 described below is an embodiment in which a camera control unit controlling the posture of a camera is included inside of a mobile body control device 100 of a drone 10, and, in a case in which an imaging direction of the camera is controlled, not posture control of the drone itself but control using the camera control unit is performed.

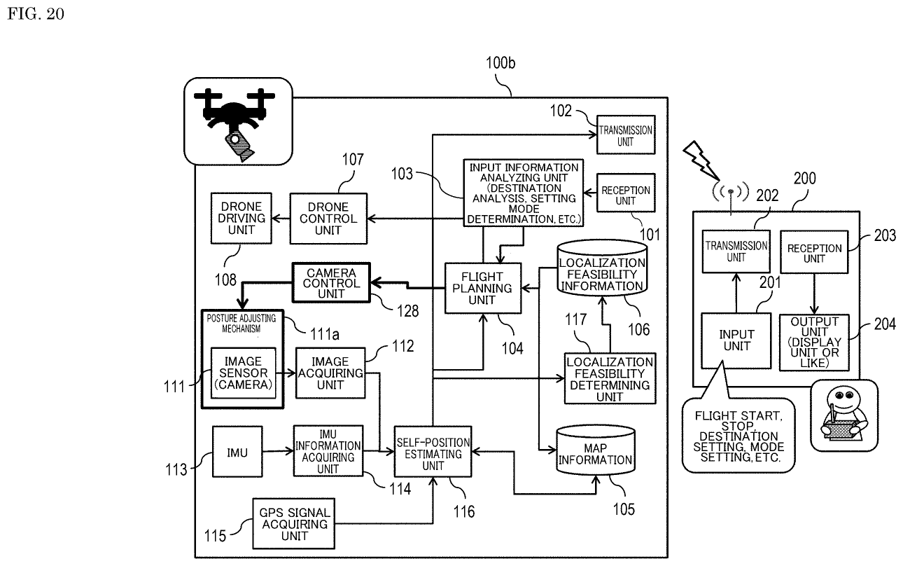

FIG. 20 illustrates a configuration example of a mobile body control device 100b according to Embodiment 2 of the present disclosure.

In FIG. 20, a configuration example of a controller 200 communicating with the mobile body control device 100b is also illustrated together with the configuration of the mobile body control device 100b according to Embodiment 2 of the present disclosure configured inside of the drone 10.

As illustrated in FIG. 20, the mobile body control device 100b includes a reception unit 101, a transmission unit 102, an input information analyzing unit 103, a flight planning unit 104, map information 105, localization feasibility information 106, a drone control unit 107, a drone driving unit 108, an image sensor (camera) 111, an image acquiring unit 112, an inertial measurement unit (IMU) 113, an IMU information acquiring unit 114, a GPS signal acquiring unit 115, a self-position estimating unit 116, and a localization feasibility determining unit 117, and further includes a camera control unit 128.

In addition, the image sensor (the camera) 111 has a configuration of being mounted in a posture adjusting mechanism 111a such as a gimbal that changes the posture of the image sensor (the camera) 111.

The controller 200 includes an input unit 201, a transmission unit 202, a reception unit 203, and an output unit (a display unit and the like) 204.

Differences from Embodiment 1 described above with reference to FIG. 13 are the mobile body control device 100b having the camera control unit 128 and the image sensor (the camera) 111 being configured to be mounted in the posture adjusting mechanism 111a such as a gimbal changing the posture of the image sensor (the camera) 111.

The other configuration is similar to the configuration of Embodiment 1, and thus description thereof will be omitted.

The camera control unit 128 controls the posture of the image sensor (the camera) 111 during flight of the drone 10 and adjusts the camera imaging direction. In other words, the camera imaging direction is adjusted by controlling the posture adjusting mechanism 111a such as a gimbal.

More specifically, a camera imaging direction adjusting process for causing the drone 10 to have the camera imaging direction of the image sensor (the camera) 111 at each relay point during flight to be directed toward a localization possible area as possibly as can is executed.

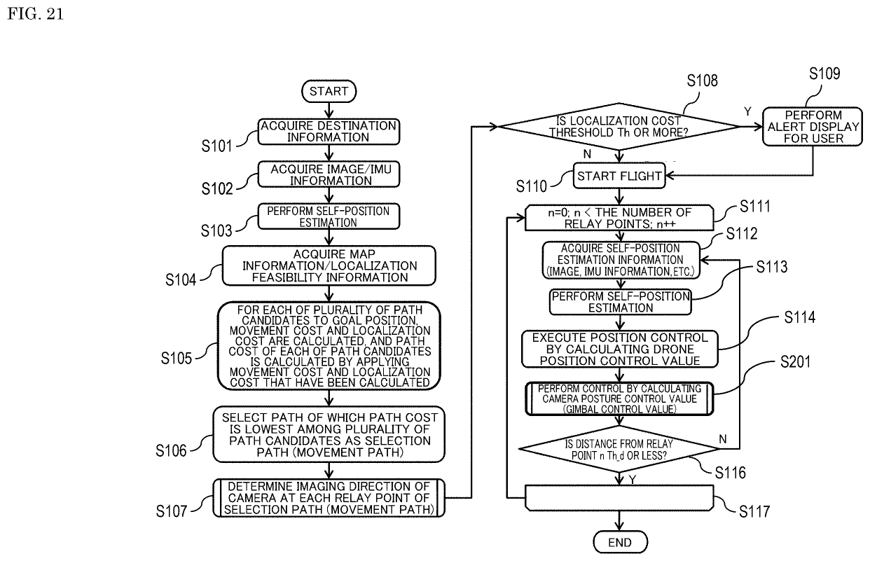

Details of the process executed by the mobile body control device 100b according to this Embodiment 2 will be described with reference to FIG. 21.

Hereinafter, processing of each step of the flow shown in FIG. 21 will be described in order.

### (Steps S101 to S104)

Processes of Steps S101 to S104 are processes similar to the processes of Steps S101 to S104 in Embodiment 1 described above with reference to FIG. 16.

First, the mobile body control device 100b acquires destination information in Step S101.

Next, an image and IMU information are acquired in Step S102.

Such acquisition information is input to the self-position estimating unit 116.

Next, the mobile body control device 100b executes a self-position estimating process in Step S103.

Next, in Step S104, map information 105 and localization feasibility information 106 are acquired.

As described above, the map information 105 is a three-dimensional map of a three-dimensional space that is an area in which the drone 10 flies and, for example, is map information configured using three-dimensional point group information representing objects that become obstacles for flight as a point group.

The localization feasibility information 106 is information representing which of area types (localization feasibility information) in units of predetermined divisional areas such as boxes (cubes) or rectangular area units divided into grids, that is, which one of areas (a) to (c) each divisional area is.
(a) Localization (self-position estimation) possible area
(b) Localization (self-position estimation) impossible area
(c) Localization (self-position estimation) possibility/impossibility unknown area

### (Step S105)

Next, in Step S105, the mobile body control device 100b calculates a movement cost and a localization cost of each of a plurality of paths that can be set as a path to a destination using the map information 105 and the localization feasibility information 106 acquired in Step S104 and calculates a path cost of each of path candidates by applying the movement cost and the localization cost of each of the plurality of paths that have been calculated.

This process is a process that is executed by the flight planning unit 104 illustrated in FIG. 20.

Although a specific example of the process of calculating a movement cost and a localization cost of each of a plurality of paths to a destination that is executed by the flight planning unit 104 is a process that is almost similar to the process described above with reference to FIG. 17 in Embodiment 1, when the localization cost is calculated, a “localization cost calculation algorithm AL2” different from the “localization cost calculation algorithm AL1” used in Embodiment 1 described above is used in this Embodiment 2.

The flight planning unit 104 of the mobile body control device 100b illustrated in FIG. 20, in Step S105 of the flow illustrated in FIG. 21, as described with reference to FIG. 17 in the previous Embodiment 1, for a plurality of paths from a start node position (S: src_node) to a goal node position (G: dest_node), calculates a cost corresponding to each path (path cost: cost(src_node, dest_node)) in accordance with the following cost calculation equation (Equation 1).

$$cost ( src\_node , dest\_node ) = w 1 \times ( movement cost ) + w 2 \times ( localization cost ) \qquad ( Equation 1 )$$

In (Equation 1) represented above, w1 and w2 are weight coefficient defined in advance.

In the cost calculation equation (Equation 1) described above, (movement cost) is a cost value that increases in proportion to the movement distance.

The localization cost is a cost value calculated using the following “localization cost calculation algorithm AL2” using functions including the cost corresponding to the localization possible number calculation function (compute_cost_localize_possible( )) and the cost corresponding to the localization impossible & unknown time calculation function (compute_cost_localize_impossible_or_unknown( )) represented in FIGS. 17(a) and 17(b).

“Localization cost calculation algorithm AL2”
if N direction localization feasibility information.all( ) == “impossible”:
cost = HIGHEST_COST_VALUE;# maximum cost fixed value
else if: N direction localization feasibility information.any( ) == “possible”:#
minimum one “possible” is present
cost = compute_cost_localize_possible(num_of_“possible”);
else:# “impossible” or “unknown”
cost = compute_cost_localize_impossible_or_unknown(num_of_“unknown”);

In addition, the “N direction localization feasibility information” in the algorithm described above is localization feasibility information of divisional areas of N directions adjacent to a divisional area to which one node belonging to a path that is a cost calculation target belongs.

In this Embodiment 2, localization feasibility information of N divisional areas that has been stored is configured to be used as the localization feasibility information 106 of the mobile body control device 100b illustrated in FIG. 20.

In addition, the “localization cost calculation algorithm AL2” described above is a cost calculation algorithm in which the more localization possible areas in peripheral divisional areas in N directions that are adjacent to a divisional area configuring a path from a start node position (S: src_node) to a goal node position (G: dest_node), the lower the cost value, and the more localization impossible areas or localization possibility/impossibility unknown areas in peripheral divisional areas of the divisional area configuring the path, the higher the cost value.

As described above, the flight planning unit 104 of the mobile body control device 100b illustrated in FIG. 20, in Step S105 of the flow illustrated in FIG. 21, for a plurality of paths from the start node position (S: src_node) to the goal node position (G: dest_node), calculates a cost corresponding to each path (a path cost: cost(src_node, dest_node)) in accordance with the following cost calculation equation (Equation 1).

$$cost ( src\_node , dest\_node ) = w 1 \times ( movement cost ) + w 2 \times ( localization cost ) \qquad ( Equation 1 )$$

In the cost calculation equation (Equation 1) represented above, the longer the distance of a path, the higher the cost becomes, and the higher the localization cost of a path, the higher the cost becomes.

In addition, as described above, the localization cost of a path becomes a lower cost as there are more localization possible areas in peripheral divisional areas of a divisional area configuring a path, and it becomes a higher cost as there are more localization impossible areas or localization possibility/impossibility unknown area in the peripheral divisional area of a divisional area configuring a path.

### (Step S106)

Next, the mobile body control device 100b, in Step S106, compares path costs of a plurality of path candidates to the destination calculated in Step S105 with each other and selects a path candidate for which the lowest cost value has been calculated as a selection path (a movement path).

### (Step S107)

Next, in Step S107, the mobile body control device 100b determines a camera imaging direction at each relay point of the selection path (the movement path) selected in Step S106.

This process is a process that is approximately similar to the process described with reference to the flowchart illustrated in FIG. 18 in the previous Embodiment 1.

However, in the process described with reference to the flowchart illustrated in FIG. 18 in Embodiment 1, for example, the process is executed by substituting parts described as “divisional areas of four forward/backward/leftward/rightward directions of a relay point n” in steps other than Step S122 with “divisional areas of N directions of the relay point n”.

In addition, the flight planning unit 104 records and maintains relay point information in the selection path (the movement path) determined in Step S107 and camera imaging direction information at each relay point in the map information 105.

### (Step S108)

Next, the mobile body control device 100b determines whether or not the localization cost of the selection path (the movement path) selected in Step S106 is a pre-defined threshold or more in Step S108.

In addition, the localization cost of the selection path (the movement path) that is a verification target here is a cost value of the selection path (the movement path) calculated in accordance with the “localization cost calculation algorithm AL2” described above.

In a case in which the localization cost of the selection path (the movement path) is determined to be a pre-defined threshold or more, the process is caused to proceed to Step S109, and in a case in which the localization cost is determined to be less than the threshold, the process is caused to proceed to Step S110.

### (Step S109)

Step S109 is a process that is executed in a case in which the localization cost of the selection path (the movement path) selected in Step S106 is determined to be the pre-defined threshold or more in Step S108.

In this case, the mobile body control device 100b executes an alert display (a warning display) for the user in Step S109.

For example, the mobile body control device transmits a warning message to the controller 200 used by a user and causes the output unit 204 of the controller 200 to execute an alert display (a warning display).

In accordance with this process, a user can understand in advance that flight accompanies a risk, and thus a countermeasure such as stop of the flight or the like can be performed.

### (Step S110)

Next, the mobile body control device 100b starts flight of the drone 10 along the selection path (the movement path) selected in Step S106 in Step S110.

### (Steps S111 to S117)

Processes of Steps S111 to S117 are processes that are repeatedly executed during flight of the drone 10 along the selection path (the movement path) selected in Step S106.

At each relay point of the selection path (the movement path), each of processes described below is executed.

### (Step S112)

Self-position estimation information, for example, a captured image acquired by the image sensor (the camera) 111, detection information (an acceleration, an angular velocity, and the like) of the IMU 113, and the like are acquired.

### (Step S113)

A self-position estimating process using the self-position estimation information acquired in Step S112 is executed. This process is executed in the self-position estimating unit 116.

### (Step S114)

On the basis of a self-position estimation result estimated in Step S113, as a drone control value for moving along the selection path (the movement path), a drone position control value for controlling the drone position is calculated, and the drone position is controlled in accordance with the calculated control value.

### (Step S201)

The process of this Step S201 is a process unique to Embodiment 2 different from Embodiment 1.

In this Embodiment 2, a camera posture control value for adjusting the imaging direction of the camera at the drone position calculated in Step S114 is calculated, and a control value is output to a posture adjusting mechanism such as a gimbal for performing posture control of the image sensor (the camera) 111 in accordance with the calculated control value, whereby the posture control of the image sensor (the camera) 111 is performed.

This posture control is executed for controlling the camera imaging direction of the image sensor (the camera) 111.

In other words, posture control for causing the camera imaging direction according to the image sensor (the camera) 111 to be directed toward a direction in which a “(a) localization (self-position estimation) possible area” can be imaged as possibly as can is executed.

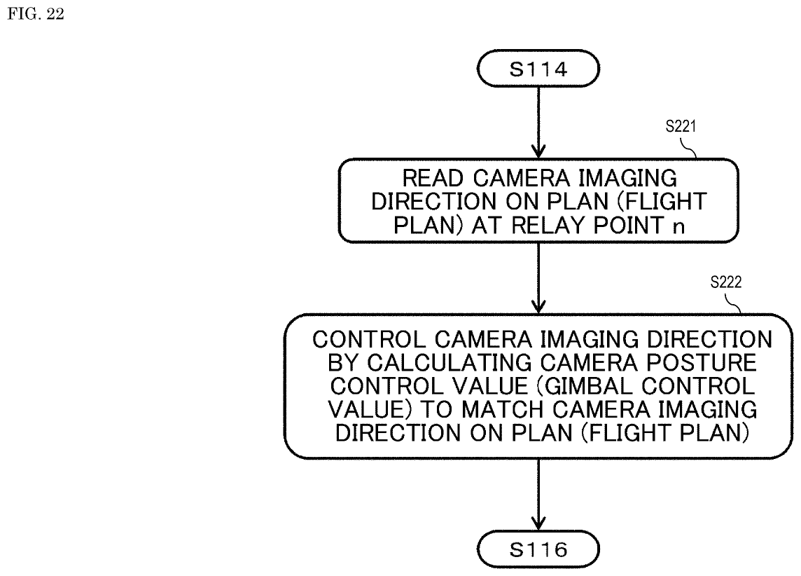

In addition, a detailed sequence of this Step S201 will be described in a later stage with reference to a flow illustrated in FIG. 22.

### (Step S116)

The processes of Steps S112 to S115 are repeated until a distance to a next relay point becomes a defined threshold or less, and when the distance to the next relay point becomes the defined threshold or less, processes of Steps S111 to S201 are repeated as processes corresponding to the next relay point.

When the drone passes through all the relay points set in the selection path (the movement path), the process ends.

At this time point, the drone comes into a state of being able to arrive at a goal (G), that is, a state in which a goal (G) place can be checked using a captured image acquired by the image sensor (the camera) 111.

Next, details of the process of Step S201 in the flow illustrated in FIG. 21, that is, a process of performing posture control of the image sensor (the camera) 111 by calculating a camera posture control value for adjusting an imaging direction of the camera at the drone position calculated in Step S114 and outputting a control value to a posture adjusting mechanism such as a gimbal used for performing posture control of the image sensor (the camera) 111 in accordance with the calculated control value will be described with reference to FIG. 22.

This process is a process that is executed by the camera control unit 128 of the mobile body control device 100b illustrated in FIG. 20.

The camera control unit 128 performs processes of the following (Step S221) to (Step S222) for each relay point set in the selection path (the movement path) during flight of the drone 10 along the selection path (the movement path).

### (Step S221)

First, the camera control unit 128 of the mobile body control device 100b reads a camera imaging direction on a plan (flight plan) at the relay point n in Step S221. The camera imaging direction on the plan (flight plan) at the relay point n is a camera imaging direction determined in Step S107 of the flow illustrated in FIG. 21, in other words, in accordance with the flow described with reference to FIG. 18 and is a direction for causing the camera imaging direction of the image sensor (the camera) 111 to be directed toward a localization possible area as possibly as can.

This camera imaging direction information is acquired from the map information 106.

The camera imaging direction information at each relay point determined in accordance with the flow illustrated in FIG. 21 is recorded in the map information 106 together with selection path information and relay point information, and the drone control unit 107 reads a camera imaging direction corresponding to the relay point from the map information 106.

### (Step S222)

Next, in Step S222, the camera control unit 128 of the mobile body control device 100b sets the camera imaging direction to the camera imaging direction at each relay point determined in Step S107 by controlling a posture adjusting mechanism such as a gimbal for performing posture control of the image sensor (the camera) 111.

As a result, the probability of succeeding in image capture of a localization possible area becomes high, the probability of succeeding in feature point extraction from a captured image, a SLAM process according to feature point tracking, and the self-position posture estimating process becomes high, and movement control (flight control) having high accuracy according to a planned movement path (flight path) is realized.

### 5. (Embodiment 3) Configuration and Processing Example of Mobile Body Control Device According to Embodiment 3 of Present Disclosure

Next, a configuration and a processing example of a mobile body control device according to Embodiment 3 of the present disclosure will be described.

Embodiment 3 is an embodiment of a case in which a plurality of (N) cameras having different imaging directions are mounted with being fixed to the drone 10. In this Embodiment 3, images in which a localization (self-position estimation) possible area is captured as possibly as can are selected and acquired from captured images of the plurality of (N) cameras, and flight control is executed.

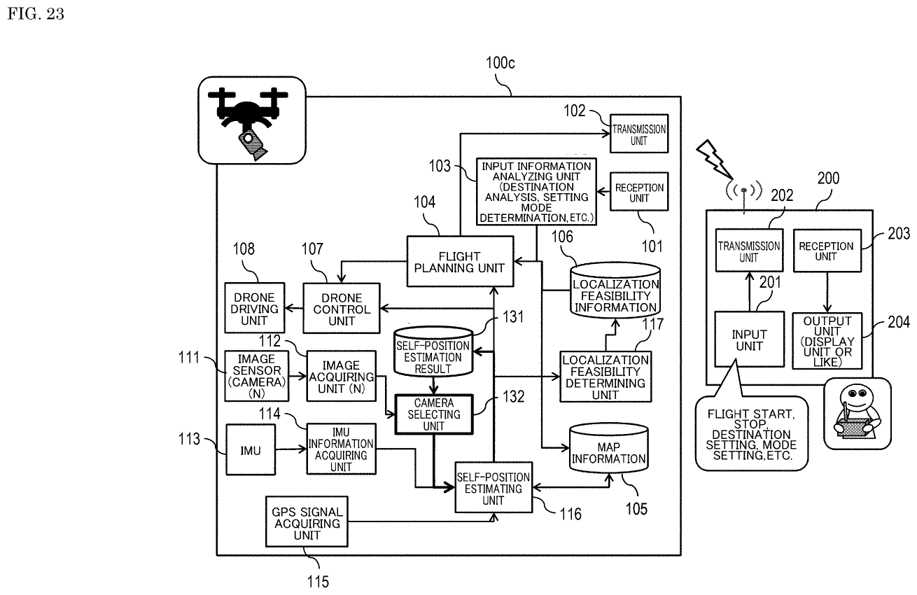

FIG. 23 illustrates a configuration example of a mobile body control device 100c according to Embodiment 3 of the present disclosure.

In FIG. 23, together with the configuration of the mobile body control device 100c according to Embodiment 3 of the present disclosure configured inside of a drone 10, a configuration example of a controller 200 communicating with the mobile body control device 100c is illustrated as well.

As illustrated in FIG. 23, the mobile body control device 100c includes a reception unit 101, a transmission unit 102, an input information analyzing unit 103, a flight planning unit 104, map information 105, localization feasibility information 106, a drone control unit 107, a drone driving unit 108, an image sensor (camera) 111, an image acquiring unit 112, an inertial measurement unit (IMU) 113, an IMU information acquiring unit 114, a GPS signal acquiring unit 115, a self-position estimating unit 116, and a localization feasibility determining unit 117 and further includes a storage unit storing a self-position estimation result 131 and a camera selecting unit 132.

The controller 200 includes an input unit 201, a transmission unit 202, a reception unit 203, and an output unit (a display unit and the like) 204.

Differences from Embodiment 1 described above with reference to FIG. 13 are that the image sensor (the camera) 111 of the mobile body control device 100c has a plurality of (N) cameras of mutually-different imaging directions, and the image acquiring unit 112 is configured using N image acquiring units corresponding to the N cameras, and the storage unit storing the self-position estimation result 131 and the camera selecting unit 132 are further included.

The other configuration is similar to the configuration of Embodiment 1, and thus description thereof will be omitted.

In the self-position estimation result 131, localization success rate information in units of divisional areas is recorded. This localization success rate information is acquired by recording success rates of localization processes executed at the time of flight of the drone 10 performed in the past and is sequentially updated.

In other words, in this Embodiment 3, area type identification information in units of divisional areas configured from a box-shaped (cubic) area having a three-dimensional shape or a rectangular area having a two-dimensional shape, in other words, area type identification information of each of
(a) localization (self-position estimation) possible area
(b) localization (self-position estimation) impossible area, and
(c) localization (self-position estimation) possibility/impossibility unknown area is recorded as localization feasibility information 106, and localization success rate information in units of divisional areas is recorded as the self-position estimation result 131.

The camera selecting unit 132 acquires localization success rate information in units of divisional areas from the self-position estimation result 141 and, by using the acquired localization success rate information, selects and acquires images in which a localization (self-position estimation) possible area is captured as possibly as can from captured images of a plurality of (N) cameras, and outputs the acquired images to the self-position estimating unit.

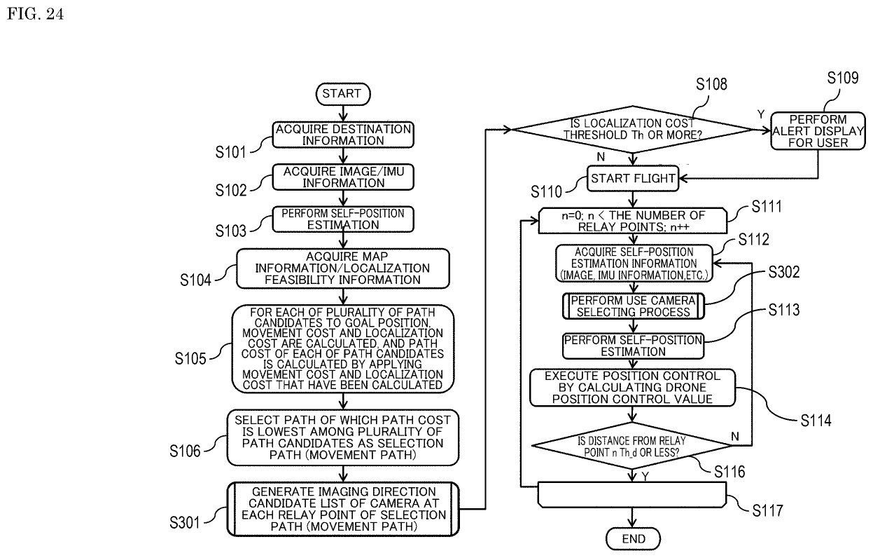

Details of the process executed by the mobile body control device 100c according to this Embodiment 3 will be described with reference to FIG. 24.

Hereinafter, processing of each step of the flow shown in FIG. 24 will be described in order.

### (Steps S101 to S104)

Processes of Steps S101 to S104 are processes similar to the processes of Steps S101 to S104 according to Embodiment 1 described above with reference to FIG. 16.

First, the mobile body control device 100c acquires destination information in Step S101.

Next, an image and IMU information are acquired in Step S102.

Such acquisition information is input to the self-position estimating unit 116.

Next, the mobile body control device 100c executes a self-position estimating process in Step S103.

Next, in Step S104, the map information 105 and the localization feasibility information 106 are acquired.

As described above, the map information 105 is a three-dimensional map of a three-dimensional space that is an area in which the drone 10 is flying and, for example, is map information configured using three-dimensional point group information in which objects that are obstacles for flight are represented as a point group.

The localization feasibility information 106 is information representing which area type in units of predetermined divisional areas such as units of boxes (cubes), rectangular areas, or the like divided by grids (localization feasibility information), that is, which area of (a) to (c) of each divisional area is.
(a) localization (self-position estimation) possible area,
(b) localization (self-position estimation) impossible area
(c) localization (self-position estimation) possibility/impossibility unknown area

### (Step S105)

Next, in Step S105, the mobile body control device 100c calculates a movement cost and a localization cost of each of a plurality of paths that can be set as a path to a destination using the map information 105 and the localization feasibility information 106 acquired in Step S104 and calculates a path cost of each of path candidates by applying the movement cost and the localization cost of each of the plurality of paths that have been calculated.

This process is also a process executed by the flight planning unit 104 illustrated in FIG. 23.

Although a specific example of the process of calculating a movement cost and a localization cost of each of a plurality of paths to a destination that is executed by the flight planning unit 104 is a process that is almost similar to the process described above with reference to FIG. 17 in Embodiment 1, the “localization cost calculation algorithm AL2” used in Embodiment 2 described above is used when the localization cost is calculated in this Embodiment 3.

The flight planning unit 104 of the mobile body control device 100c illustrated in FIG. 23, in Step S105 of the flow illustrated in FIG. 24, as described in the previous Embodiment 1 with reference to FIG. 17, for a plurality of paths from the start node position (S: src_node) to the goal node position (G: dest_node), calculates a cost corresponding to each path (a path cost: cost(src_node, dest_node)) in accordance with the following cost calculation equation (Equation 1).

$$cost ( src\_node , dest\_node ) = w 1 \times ( movement cost ) + w 2 \times ( localization cost ) \qquad ( Equation 1 )$$

In (Equation 1) represented above, w1 and w2 are weight coefficients defined in advance.

In the cost calculation equation (Equation 1) described above, (movement cost) is a cost value that increases in proportion to the movement distance.

In addition, the localization cost is a cost value calculated in accordance with the following “localization cost calculation algorithm AL2” using functions including the cost corresponding to a localization possible number calculation function (compute_cost_localize_possible( )) and the cost corresponding to a localization impossible & unknown time calculation function (compute_cost_localize_impossible_or_unknown( )) represented in FIGS. 17(a) and 17(b).

“Localization cost calculation algorithm AL2”
if N direction localization feasibility information.all( ) == “impossible”:
cost = HIGHEST_COST_VALUE;# maximum cost fixed value
else if: N direction localization feasibility information.any( ) == “possible”:#
minimum one “possible” is present
cost = compute_cost_localize_possible(num_of_“possible”);
else:# “impossible” or “unknown”
cost = compute_cost_localize_impossible_or_unknown(num_of_“unknown”);

In addition, the “N direction localization feasibility information” in the algorithm described above is localization feasibility information of divisional areas of N directions adjacent to a divisional area to which one node belonging to a path that is a cost calculation target belongs.

In this Embodiment 3, localization feasibility information of N divisional areas that has been stored is configured to be used as the localization feasibility information 106 of the mobile body control device 100c illustrated in FIG. 23.

In addition, the “localization cost calculation algorithm AL2” described above is a cost calculation algorithm in which the more localization possible areas in peripheral divisional areas in N directions that are adjacent to a divisional area configuring a path from a start node position (S: src_node) to a goal node position (G: dest_node), the lower the cost value, and the more localization impossible areas or localization possibility/impossibility unknown areas in peripheral divisional areas of the divisional area configuring the path, the higher the cost value.

As described above, the flight planning unit 104 of the mobile body control device 100c illustrated in FIG. 23, in Step S105 of the flow illustrated in FIG. 24, for a plurality of paths from the start node position (S: src_node) to the goal node position (G: dest_node), calculates a cost corresponding to each path (a path cost: cost(src_node, dest_node)) in accordance with the following cost calculation equation (Equation 1).

$$cost ( src\_node , dest\_node ) = w 1 \times ( movement cost ) + w 2 \times ( localization cost ) \qquad ( Equation 1 )$$

In the cost calculation equation (Equation 1) represented above, the longer the distance of a path, the higher the cost becomes, and the higher the localization cost of a path, the higher the cost becomes.

In addition, as described above, the localization cost of a path becomes a lower cost as there are more localization possible areas in peripheral divisional areas of a divisional area configuring a path, and it becomes a higher cost as there are more localization impossible areas or localization possibility/impossibility unknown area in the peripheral divisional area of a divisional area configuring a path.

### (Step S106)

Next, the mobile body control device 100c, in Step S106, compares path costs of a plurality of path candidates to the destination calculated in Step S105 with each other and selects a path candidate for which the lowest cost value has been calculated as a selection path (a movement path).

### (Step S301)

Next, in Step S301, the mobile body control device 100c generates a camera imaging direction candidate list of each relay point of the selection path (the movement path) selected in Step S106.

The process is a unique process of this Embodiment 3.

The camera imaging direction candidate list of each relay point is a list in which directions in which a “localization (self-position estimation) possible area” can be imaged are set with high ranks at each relay point.

More specifically, the camera imaging direction candidate list is a list in which localization possible area directions aligned in order of highest to lowest localization success rate are set in a list higher rank, and localization possibility/impossibility unknown area directions aligned in order of the highest to lowest localization success rate are set in a list lower rank.

In addition, this camera imaging direction candidate list of each relay point is recorded inside of the self-position estimation result 141. In the self-position estimation result 141, a list is recorded in association with each relay point recorded in the map information 105.

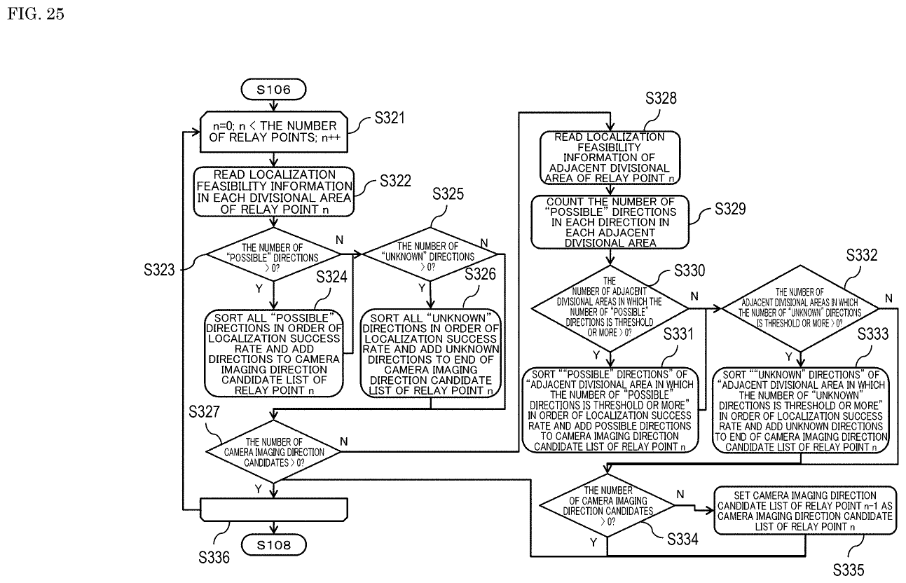

A detailed flow of this list generating process will be described in a later stage with reference to a flow illustrated in FIG. 25.

### (Step S108)

Next, the mobile body control device 100c determines whether or not the localization cost of the selection path (the movement path) selected in Step S106 is a pre-defined threshold or more in Step S108.

In addition, the localization cost of the selection path (the movement path) that is a verification target here is a cost value of the selection path (the movement path) calculated in accordance with the “localization cost calculation algorithm AL2” described above.

In a case in which the localization cost of the selection path (the movement path) is determined to be a pre-defined threshold or more, the process is caused to proceed to Step S109, and in a case in which the localization cost is determined to be less than the threshold, the process is caused to proceed to Step S110.

### (Step S109)

Step S109 is a process that is executed in a case in which the localization cost of the selection path (the movement path) selected in Step S106 is determined to be the pre-defined threshold or more in Step S108.

In this case, the mobile body control device 100c executes an alert display (a warning display) for the user in Step S109.

For example, the mobile body control device transmits a warning message to the controller 200 used by a user and causes the output unit 204 of the controller 200 to execute an alert display (a warning display).

In accordance with this process, a user can understand in advance that flight accompanies a risk, and thus a countermeasure such as stop of the flight or the like can be performed.

### (Step S110)

Next, the mobile body control device 100c starts flight of the drone 10 along the selection path (the movement path) selected in Step S106 in Step S110.

### (Steps S111 to S117)

Processes of Steps S111 to S117 are processes that are repeatedly executed during flight of the drone 10 along the selection path (the movement path) selected in Step S106.

At each relay point of the selection path (the movement path), each of processes described below is executed.

### (Step S112)

Self-position estimation information, for example, a captured image acquired by the image sensor (the camera) 111, detection information (an acceleration, an angular velocity, and the like) of the IMU 113, and the like are acquired.

### (Step S302)

The process of this Step S302 is also a unique process of this Embodiment 3. In Step S302, by referring to the camera imaging direction candidate list of each relay point generated in the previous Step S301, a process of selecting a camera used at the current relay point position is executed.

More specifically, at a relay point, a process in which a camera imaging a “localization (self-position estimation) possible area” as possibly as can is selected as a camera to be used is executed.

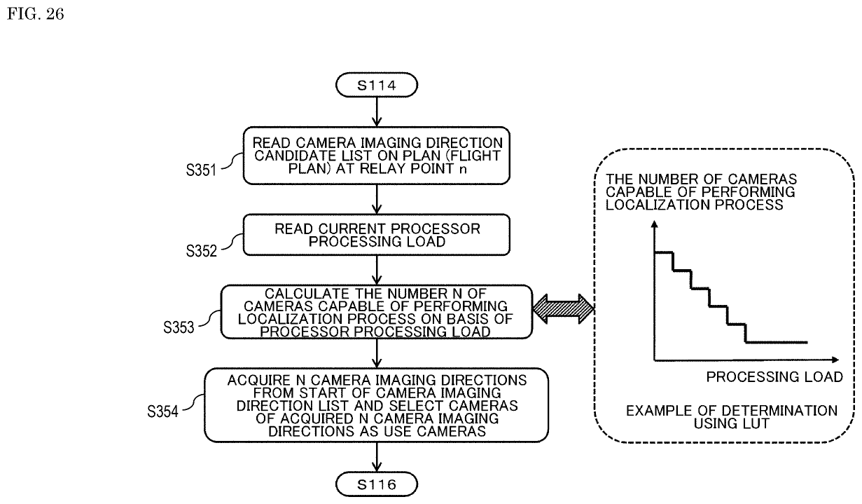

A detailed sequence of this process will be described in a later stage with reference to a flow illustrated in FIG. 26.

### (Step S113)

In Step S113, a self-position estimating process using the self-position estimation information acquired in Step S112 is executed. This process is executed in the self-position estimating unit 116.

### (Step S114)

On the basis of a self-position estimation result estimated in Step S113, as a drone control value for moving along the selection path (the movement path), a drone position control value for controlling the drone position is calculated, and the drone position is controlled in accordance with the calculated control value.

### (Step S116)

The processes of Steps S112 to S114 are repeated until a distance to a next relay point becomes a defined threshold or less, and when the distance to the next relay point becomes the defined threshold or less, processes of Steps S111 to S116 are repeated as processes corresponding to the next relay point.

When the drone passes through all the relay points set in the selection path (the movement path), the process ends.

At this time point, the drone comes into a state of being able to arrive at a goal (G), that is, a state in which a goal (G) place can be checked using a captured image acquired by the image sensor (the camera) 111.

Next, a detailed sequence of the process of Step S301 in the flow illustrated in FIG. 23, that is, the process of generating a camera imaging direction candidate list of each relay point of the selection path (the movement path) selected in Step S106 will be described with reference to a flow illustrated in FIG. 25.

This process is a unique process of this Embodiment 3.

As described above, the camera imaging direction candidate list of each relay point is a list in which directions in which a “localization (self-position estimation) possible area” can be imaged at each relay point are set with a higher rank.

More specifically, the camera imaging direction candidate list is a list in which localization possible area directions aligned in order of highest to lowest localization success rate are set in a list higher rank, and localization possibility/impossibility unknown area directions aligned in order of the highest to lowest localization success rate are set in a list lower rank.

This process is a process that is executed by the flight planning unit 104 of the mobile body control device 100c illustrated in FIG. 23.

The flight planning unit 104 executes processes of the following (Step S322) to (Step S336) of the flow illustrated in FIG. 25 for each of relay points set in the selection path (the movement path) of the drone 10.

Hereinafter, the processes of each step will be described in sequence.

### (Step S322)

First, in Step S322, localization feasibility information of each of divisional areas of four forward/backward/leftward/rightward directions of one relay point n selected as a verification target is acquired.

In other words, the flight planning unit 104 of the mobile body control device 100c illustrated in FIG. 23 acquires localization feasibility information of divisional areas on the periphery of a relay point n from the localization feasibility information 106.

In addition, as described above, in the localization feasibility information 106, together with area type identification information representing an area type in units of divisional areas, in other words, representing which area among areas (a) to (c) each divisional area is, localization success rate information in units of divisional areas is recorded as well.
(a) Localization (self-position estimation) possible area
(b) Localization (self-position estimation) impossible area
(c) Localization (self-position estimation) possibility/impossibility unknown area

### (Step S323)

Next, in Step S323, it is determined whether or not one or more “localization (self-position estimation) possible areas” are present in the divisional areas on the periphery of the relay point n by referring to the localization feasibility information acquired in Step S322.

In a case in which one or more localization possible areas are present, the process is caused to proceed to Step S324.

In a case in which there is no localization possible area at all, the process is caused to proceed to Step S325.

### (Step S324)

In Step S323, in a case in which it is determined that one or more “localization (self-position estimation) possible areas” are present in peripheral divisional areas of the relay point n, the following process is executed in Step S324.

The flight planning unit 104 of the mobile body control device 100c illustrated in FIG. 23, in Step S324, sorts ““possible” directions” that are directions of all the “localization (self-position estimation) possible areas” in order of the localization success rate and adds the “possible” directions to the camera imaging direction candidate list of the relay point n.

As described above, the camera imaging direction candidate list of each relay point is recorded inside of the self-position estimation result 141. In the self-position estimation result 141, the list is recorded in association with each relay point recorded inside of the map information 105.

### (Step S325)

After the end of the process of Step S324 and in Step S323, in a case in which it is determined that no “localization (self-position estimation) possible area” is present at all in the peripheral divisional areas of the relay point n, the following process is executed in Step S325.

In Step S325, it is determined whether or not one or more “localization (self-position estimation) possibility/impossibility unknown areas” are present in the peripheral divisional areas of the relay point n by referring to the localization feasibility information acquired in Step S322.

In a case in which one or more localization possibility/impossibility unknown areas are present, the process is caused to proceed to Step S326.

In a case in which no localization possibility/impossibility unknown area is present at all, the process is caused to proceed to Step S327.

### (Step S326)

Next, the flight planning unit 104 of the mobile body control device 100c illustrated in FIG. 23, in Step S326, sorts ““unknown” directions” that are directions of all the “localization (self-position estimation) possibility/impossibility unknown areas” in order of the localization success rate and adds the “unknown” directions to the end of the camera imaging direction candidate list of the relay point n.

### (Step S327)

After the end of the process of Step S326 and in Step S325, in a case in which it is determined that no “localization (self-position estimation) possibility/impossibility unknown area” is present at all in the peripheral divisional areas of the relay point n, the following process is executed in Step S327.

The flight planning unit 104 of the mobile body control device 100c illustrated in FIG. 23 determines whether or not there is one or more camera imaging directions registered in the camera imaging direction candidate list in Step S327. In a case in which one or more camera imaging directions registered in the camera imaging direction candidate list are present, the process ends, and a process corresponding to a next relay point is started.

On the other hand, in case in which no camera imaging direction registered in the camera imaging direction candidate list is present at all, the process is caused to proceed to Step S328.

### (Step S328)

In Step S327, in a case in which it is determined that no camera imaging direction registered in the camera imaging direction candidate list is present at all, the process is caused to proceed to Step S328, and the following process is executed.

The flight planning unit 104 of the mobile body control device 100c illustrated in FIG. 23 reads localization feasibility information of divisional areas adjacent to a relay point n in Step S328.

### (Step S329)

Next, in Step S329, by referring to the localization feasibility information of divisional areas adjacent to the relay point n read in Step S328, the number of “possible” directions in each direction is counted for each of the adjacent divisional areas.

### (Step S330)

Next, in Step S330, it is determined whether or not the number of adjacent divisional areas for which the number of “possible” directions is a threshold or more is one or more.

In a case in which it is determined that the number of adjacent divisional areas for which the number of “possible” directions is a threshold or more is one or more, the process is caused to proceed to Step S331.

On the other hand, in a case in which it is determined that no adjacent divisional area in which the number of “possible” directions is a threshold or more is present at all, the process is caused to proceed to Step S332.

### (Step S331)

In Step S330, in a case in which it is determined that the number of adjacent divisional areas for which the number of “possible” directions is the threshold or more is one or more, the following process is executed in Step S331.

The flight planning unit 104 of the mobile body control device 100c illustrated in FIG. 23, in Step S331, sorts ““possible” directions” of “adjacent divisional areas for which the number of “possible” directions is the threshold or more” in order of the localization success rate and adds the “possible directions” to the camera imaging direction candidate list of the relay point n.

### (Step S332)

In Step S330, in a case in which it is determined that no adjacent divisional area in which the number of “possible” directions is the threshold or more is present at all, the following process is executed in Step S332.

In Step S332, it is determined whether or not the number of adjacent divisional areas for which the number of “unknown” directions is a threshold or more is one or more.

In a case in which it is determined that the number of adjacent divisional areas for which the number of “unknown” directions is the threshold or more is one or more, the process is caused to proceed to Step S333.

On the other hand, in a case in which it is determined that no adjacent divisional area in which the number of “unknown” directions is the threshold or more is present at all, the process is caused to proceed to Step S334.

### (Step S334)

In Step S333, in a case in which it is determined that the number of adjacent divisional areas for which the number of “unknown” directions is the threshold or more is one or more, the following process is executed in Step S334.

The flight planning unit 104 of the mobile body control device 100c illustrated in FIG. 23, in Step S334, sorts ““unknown” directions” of “adjacent divisional areas for which the number of “unknown” directions is a threshold or more” in order of the localization success rate and adds the “unknown” directions to the end of the camera imaging direction candidate list of the relay point n.

### (Step S334)

After the end of the process of Step S333 and in Step S332, in a case in which it is determined that no “localization (self-position estimation) possibility/impossibility unknown area” is present at all in the peripheral divisional areas of the relay point n, the following process is executed in Step S334.

The flight planning unit 104 of the mobile body control device 100c illustrated in FIG. 23 determines whether or not there is one or more camera imaging directions registered in the camera imaging direction candidate list in Step S334.

In a case in which one or more camera imaging directions registered in the camera imaging direction candidate list are present, the process ends, and a process corresponding to a next relay point is started.

On the other hand, in case in which no camera imaging direction registered in the camera imaging direction candidate list is present at all, the process is caused to proceed to Step S335.

### (Step S335)

In Step S334, in a case in which it is determined that no camera imaging direction registered in the camera imaging direction candidate list is present at all, the following process is executed in Step S335.

The flight planning unit 104 of the mobile body control device 100c illustrated in FIG. 23 sets a camera imaging direction candidate list of a relay point n−1 as the camera imaging direction list of the relay point n in Step S335.

The relay point n−1 is a relay point through which the drone 10 passes immediately before the drone 10 arrives at the relay point n.

After starting flight, the drone 10, for each relay point, performs the process of selecting a camera to capture an image used for a self-position estimating process using the camera imaging direction candidate list corresponding to the relay point that has been generated in accordance with the flow illustrated in FIG. 25.

At each relay point, the process of selecting a camera to be used from a plurality of (N) cameras configuring the image sensor (the camera) 111 is performed. The process of selecting a camera imaging a localization possible area as possibly as can is performed.

A camera selecting process during flight of the drone 10 is executed in Step S302 of the flow illustrated in FIG. 24. Details of this process will be described with reference to FIG. 26.

This process is a process that is executed by the camera selecting unit 132 of the mobile body control device 100c illustrated in FIG. 23.

While the drone 10 is flying along the selection path (the movement path), the camera selecting unit 132 executes processes of the following (Step S351) to (Step S354) at each relay point set in the selection path (the movement path).

### (Step S351)

First, the camera selecting unit 132 of the mobile body control device 100 reads the camera imaging direction candidate list on a plan (flight plan) at the relay point n in Step S351.

The camera imaging direction candidate list on the plan (the flight plan) at the relay point n is a camera imaging direction candidate list determined in Step S301 of the flow illustrated in FIG. 24, in other words, determined in accordance with the flow described with reference to FIG. 25 and is a list defining a direction for causing the camera imaging direction of the image sensor (the camera) 111 to be directed toward a localization possible area as possibly as can.

This camera imaging direction candidate list is acquired from the self-position estimation result 141.

As described above, the camera imaging direction candidate list of each relay point is recorded inside of the self-position estimation result 141 in association with each relay point.

The camera selecting unit 132 reads the camera imaging direction corresponding to the relay point from the camera selecting unit 132.

### (Step S352)

Next, the camera selecting unit 132 of the mobile body control device 100 reads a processing load of a current processor of the mobile body control device 100c of the drone 10 in Step S352.

In addition, for example, a hardware monitoring unit monitoring use statuses of a processor, a memory, and the like is disposed in the mobile body control device 100c, and the drone control unit 107 reads a processing load of the processor from the hardware monitoring unit in Step S352.

### (Step S353)

Next, the camera selecting unit 132 of the mobile body control device 100 calculates the number of camera captured images for which the localization process is to be executed, that is, the number N of cameras on the basis of the processing load of the current processor of the mobile body control device 100c of the drone 10 in Step S353.

As illustrated on the right side of FIG. 26, in a case in which the processing load of the current processor is low, the number of camera captured images for which the localization process is executed, that is, the number N of cameras becomes large, and, in a case in which the processing load of the current processor is high, the number of camera captured images for which the localization process is executed, that is, the number N of cameras becomes small.

### (Step S354)

Next, the camera selecting unit 132 of the mobile body control device 100 executes the following process in Step S354.

In accordance with the number of camera captured images, for which the localization process is executed, that has been calculated in Step S353, that is, the number N of cameras, high-ranked N camera imaging directions are acquired from the camera imaging direction candidate list acquired in Step S351 and selects cameras imaging the acquired N camera imaging directions as cameras used for the localization process.

In accordance with such a process, N cameras are selected from a plurality of cameras mounted in the drone 10, and a localization process using captured images of the selected cameras is executed.

As a result, the probability of succeeding in image capture of a localization possible area becomes high, the probability of succeeding in feature point extraction from a captured image, a SLAM process according to feature point tracking, and the self-position posture estimating process becomes high, and movement control (flight control) having high accuracy according to a planned movement path (flight path) is realized.

### 6. (Embodiment 4) Configuration and Processing Example of Mobile Body Control Device According to Embodiment 4 of Present Disclosure

Next, a configuration and a processing example of a mobile body control device according to Embodiment 4 of the present disclosure will be described.

Embodiment 4 is an embodiment of a configuration in which one or more wide-angle cameras including a wide-angle lens such as a fisheye lenes are mounted in a drone 10.

In this Embodiment 4, image areas in which a localization (self-position estimation) possible area is imaged as possibly as can are selected from captured images of the wide-angle cameras, and a localization process using images of the selected image areas is executed to perform flight control.

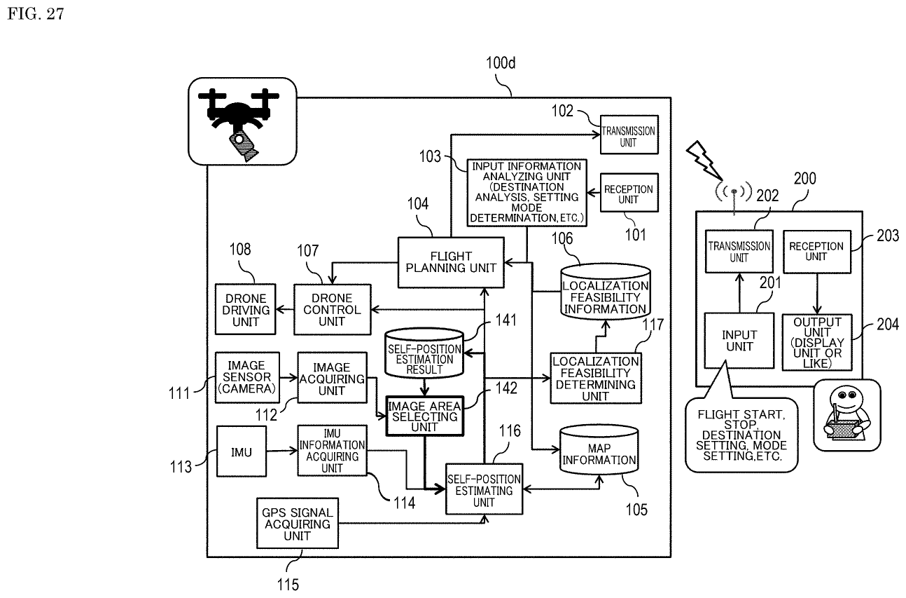

FIG. 27 illustrates a configuration example of a mobile body control device 100d according to Embodiment 4 of the present disclosure.

In FIG. 27, together with the configuration of the mobile body control device 100c according to Embodiment 4 of the present disclosure configured inside of a drone 10, a configuration example of a controller 200 communicating with the mobile body control device 100d is illustrated as well.

As illustrated in FIG. 27, the mobile body control device 100d includes a reception unit 101, a transmission unit 102, an input information analyzing unit 103, a flight planning unit 104, map information 105, localization feasibility information 106, a drone control unit 107, a drone driving unit 108, an image sensor (camera) 111, an image acquiring unit 112, an inertial measurement unit (IMU) 113, an IMU information acquiring unit 114, a GPS signal acquiring unit 115, a self-position estimating unit 116, and a localization feasibility determining unit 117 and further includes a storage unit storing a self-position estimation result 141 and an image area selecting unit 142.

The controller 200 includes an input unit 201, a transmission unit 202, a reception unit 203, and an output unit (a display unit and the like) 204.

Differences from Embodiment 1 described above with reference to FIG. 13 are that the image sensor (the camera) 111 of the mobile body control device 100d is configured using one or more wide-angle cameras including a wide-angle lens, for example, such as a fisheye lens, and the storage unit storing the self-position estimation result 141 and the image area selecting unit 142 are further included. The other configuration is similar to the configuration of Embodiment 1, and thus description thereof will be omitted.

In the self-position estimation result 141, localization success rate information in units of divisional areas is recorded. This localization success rate information is acquired by recording success rates of localization processes executed at the time of flight of the drone 10 performed in the past and is sequentially updated.

In other words, in this Embodiment 4, area type identification information in units of divisional areas configured from a box-shaped (cube) area having a three-dimensional shape or a rectangular area having a two-dimensional shape, in other words, area type identification information of each of
(a) localization (self-position estimation) possible area,
(b) localization (self-position estimation) impossible area,
(c) localization (self-position estimation) possibility/impossibility unknown area is recorded as localization feasibility information 106, and localization success rate information in units of divisional areas is recorded as the self-position estimation result 141.

The image area selecting unit 142 acquires localization success rate information in units of divisional areas from the self-position estimation result 141 and, by using the acquired localization success rate information, selects and acquires images in which a localization (self-position estimation) possible area is imaged as possibly as can from a plurality of (N) camera captured image areas, and outputs the acquired images to the self-position estimating unit.

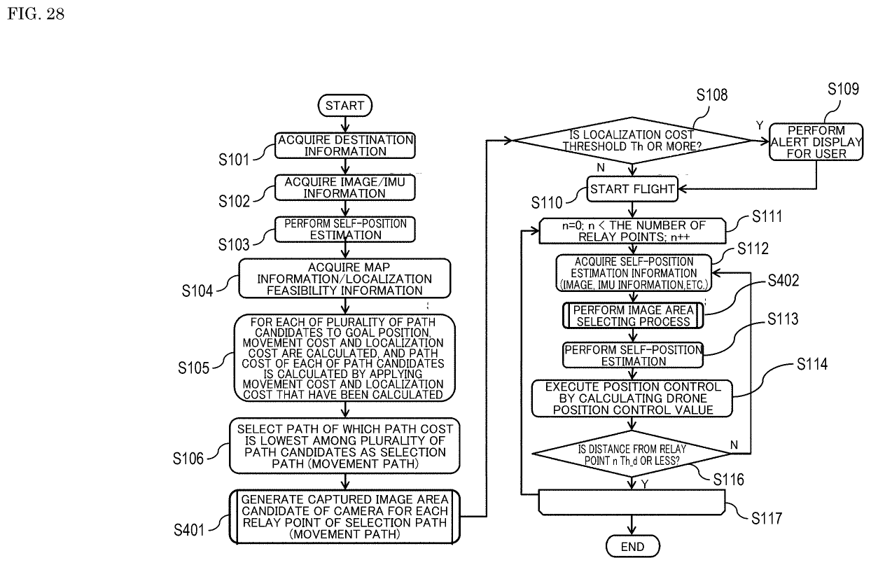

Details of the process executed by the mobile body control device 100d according to this Embodiment 4 will be described with reference to FIG. 28.

Hereinafter, processing of each step of the flow shown in FIG. 28 will be described in order.

### (Steps S101 to S104)

Processes of Steps S101 to S104 are processes similar to the processes of Steps S101 to S104 according to Embodiment 1 described above with reference to FIG. 16.

First, the mobile body control device 100d acquires destination information in Step S101.

Next, an image and IMU information are acquired in Step S102.

Such acquisition information is input to the self-position estimating unit 116.

Next, the mobile body control device 100d executes a self-position estimating process in Step S103.

Next, in Step S104, the map information 105 and the localization feasibility information 106 are acquired.

As described above, the map information 105 is a three-dimensional map of a three-dimensional space that is an area in which the drone 10 is flying and, for example, is map information configured using three-dimensional point group information in which objects that are obstacles for flight are represented as a point group.

The localization feasibility information 106 is information representing which area type in units of predetermined divisional areas such as units of boxes (cubes), rectangular areas, or the like divided by grids (localization feasibility information), that is, which area of (a) to (c) each divisional area is.
(a) localization (self-position estimation) possible area
(b) localization (self-position estimation) impossible area
(c) localization (self-position estimation) possibility/impossibility unknown area

### (Step S105)

Next, in Step S105, the mobile body control device 100d calculates a movement cost and a localization cost of each of a plurality of paths that can be set as a path to a destination using the map information 105 and the localization feasibility information 106 acquired in Step S104 and calculates a path cost of each of path candidates by applying the movement cost and the localization cost of each of the plurality of paths that have been calculated.

This process is also a process executed by the flight planning unit 104 illustrated in FIG. 27.

Although a specific example of the process of calculating a movement cost and a localization cost of each of a plurality of paths to a destination that is executed by the flight planning unit 104 is a process that is almost similar to the process described above with reference to FIG. 17 in Embodiment 1, following “localization cost calculation algorithm AL4” is used when the localization cost is calculated in this Embodiment 4.

The flight planning unit 104 of the mobile body control device 100d illustrated in FIG. 27, in Step S105 of the flow illustrated in FIG. 28, as described in the previous Embodiment 1 with reference to FIG. 17, for a plurality of paths from the start node position (S: src_node) to the goal node position (G: dest_node), calculates a cost corresponding to each path (a path cost: cost(src_node, dest_node)) in accordance with the following cost calculation equation (Equation 1).

$$cost ( src\_node , dest\_node ) = w 1 \times ( movement cost ) + w 2 \times ( localization cost ) \qquad ( Equation 1 )$$

In (Equation 1) represented above, w1 and w2 are weight coefficients defined in advance.

In the cost calculation equation (Equation 1) described above, (movement cost) is a cost value that increases in proportion to the movement distance.

The localization cost is a cost value calculated using the following “localization cost calculation algorithm AL4” using functions including the cost corresponding to the localization possible number calculation function (compute_cost_localize_possible( )) and the cost corresponding to the localization impossible & unknown time calculation function (compute_cost_localize_impossible_or_unknown( )) represented in FIGS. 17(a) and 17(b).

“Localization cost calculation algorithm AL4”
if 5 direction localization feasibility information.all( ) == “impossible”:
cost = HIGHEST_COST_VALUE;# maximum cost fixed value
else if: 5 direction localization feasibility information.any( ) == “possible”:# minimum
one “possible” is present
cost = compute_cost_localize_possible(num_of_“possible”);
else:# “impossible” or “unknown”
cost = compute_cost_localize_impossible_or_unknown(num_of_“unknown”);

In addition, the “5 direction localization feasibility information” in the algorithm described above is localization feasibility information of divisional areas of five directions adjacent to a divisional area to which one node belonging to a path that is a cost calculation target belongs.

In this Embodiment 4, localization feasibility information of five divisional areas that has been stored is configured to be used as the localization feasibility information 106 of the mobile body control device 100d illustrated in FIG. 27.

In addition, the “localization cost calculation algorithm AL4” described above is a cost calculation algorithm in which the more localization possible areas in peripheral divisional areas in five directions that are adjacent to a divisional area configuring a path from a start node position (S: src_node) to a goal node position (G: dest_node), the lower the cost value, and the more localization impossible areas or localization possibility/impossibility unknown areas in peripheral divisional areas of the divisional area configuring the path, the higher the cost value.

As described above, the flight planning unit 104 of the mobile body control device 100d illustrated in FIG. 27, in Step S105 of the flow illustrated in FIG. 28, for a plurality of paths from the start node position (S: src_node) to the goal node position (G: dest_node), calculates a cost corresponding to each path (a path cost: cost(src_node, dest_node)) in accordance with the following cost calculation equation (Equation 1).

$$cost ( src\_node , dest\_node ) = w 1 \times ( movement cost ) + w 2 \times ( localization cost ) \qquad ( Equation 1 )$$

In the cost calculation equation (Equation 1) represented above, the longer the distance of a path, the higher the cost becomes, and the higher the localization cost of a path, the higher the cost becomes.

In addition, as described above, the localization cost of a path becomes a lower cost as there are more localization possible areas in peripheral divisional areas of a divisional area configuring a path, and it becomes a higher cost as there are more localization impossible areas or localization possibility/impossibility unknown area in the peripheral divisional area of a divisional area configuring a path.

### (Step S106)

Next, the mobile body control device 100d, in Step S106, compares path costs of a plurality of path candidates to the destination calculated in Step S105 with each other and selects a path candidate for which the lowest cost value has been calculated as a selection path (a movement path).

### (Step 401)

Next, in Step S401, the mobile body control device 100d generates a camera captured image area candidate list of each relay point of the selection path (the movement path) selected in Step S106.

The process is a unique process of this Embodiment 4.

The camera captured image area candidate list of each relay point is a list in which image areas in which a “localization (self-position estimation) possible area” can be imaged are set with high ranks at each relay point.

More specifically, the camera imaging direction candidate list is a list in which localization possible area directions aligned in order of highest to lowest localization success rate are set in a list higher rank, and localization possibility/impossibility unknown area directions aligned in order of the highest to lowest localization success rate are set in a list lower rank.

In addition, this camera captured image area candidate list of each relay point is recorded inside of the self-position estimation result 141. In the self-position estimation result 141, a list is recorded in association with each relay point recorded in the map information 105.

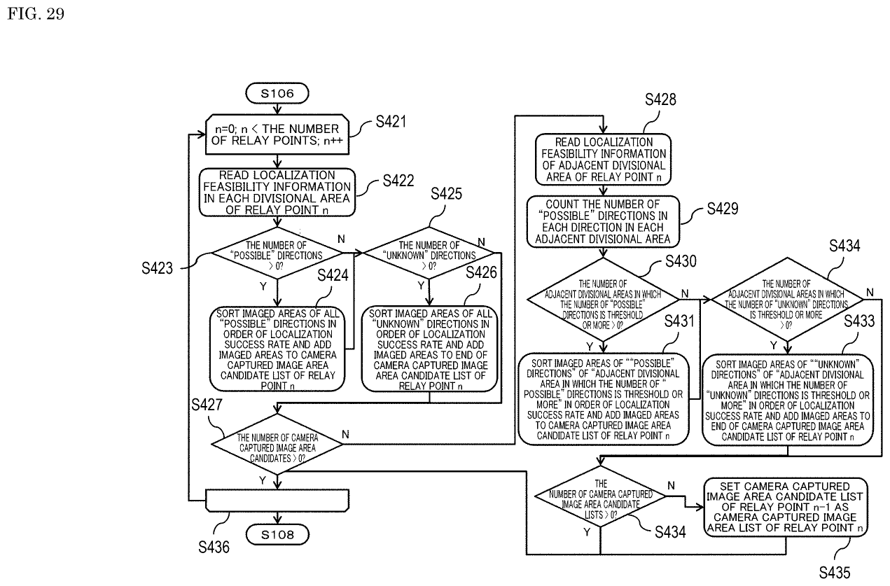

A detailed flow of this list generating process will be described in a later stage with reference to a flow illustrated in FIG. 29.

### (Step S108)

Next, the mobile body control device 100d determines whether or not the localization cost of the selection path (the movement path) selected in Step S106 is a pre-defined threshold or more in Step S108.

In addition, the localization cost of the selection path (the movement path) that is a verification target here is a cost value of the selection path (the movement path) calculated in accordance with the “localization cost calculation algorithm AL4” described above.

In a case in which the localization cost of the selection path (the movement path) is determined to be a pre-defined threshold or more, the process is caused to proceed to Step S109, and in a case in which the localization cost is determined to be less than the threshold, the process is caused to proceed to Step S110.

### (Step S109)

Step S109 is a process that is executed in a case in which the localization cost of the selection path (the movement path) selected in Step S106 is determined to be the pre-defined threshold or more in Step S108.

In this case, the mobile body control device 100d executes an alert display (a warning display) for the user in Step S109.

For example, the mobile body control device transmits a warning message to the controller 200 used by a user and causes the output unit 204 of the controller 200 to execute an alert display (a warning display).

In accordance with this process, a user can understand in advance that flight accompanies a risk, and thus a countermeasure such as stop of the flight or the like can be performed.

### (Step S110)

Next, the mobile body control device 100d starts flight of the drone 10 along the selection path (the movement path) selected in Step S106 in Step S110.

### (Steps S111 to S117)

Processes of Steps S111 to S117 are processes that are repeatedly executed during flight of the drone 10 along the selection path (the movement path) selected in Step S106.

At each relay point of the selection path (the movement path), each of processes described below is executed.

### (Step S112)

Self-position estimation information, for example, a captured image acquired by the image sensor (the camera) 111, detection information (an acceleration, an angular velocity, and the like) of the IMU 113, and the like are acquired.

### (Step S402)

The process of this Step S402 is also a unique process of this Embodiment 4.

In Step S402, by referring to the camera captured image area candidate list of each relay point generated in the previous Step S401, a process of selecting a captured image area used in the localization process at the current relay point position is executed.

More specifically, at a relay point, a process of selecting an image area imaging a “localization (self-position estimation) possible area” as possibly as can as an image area used in the localization process is executed.

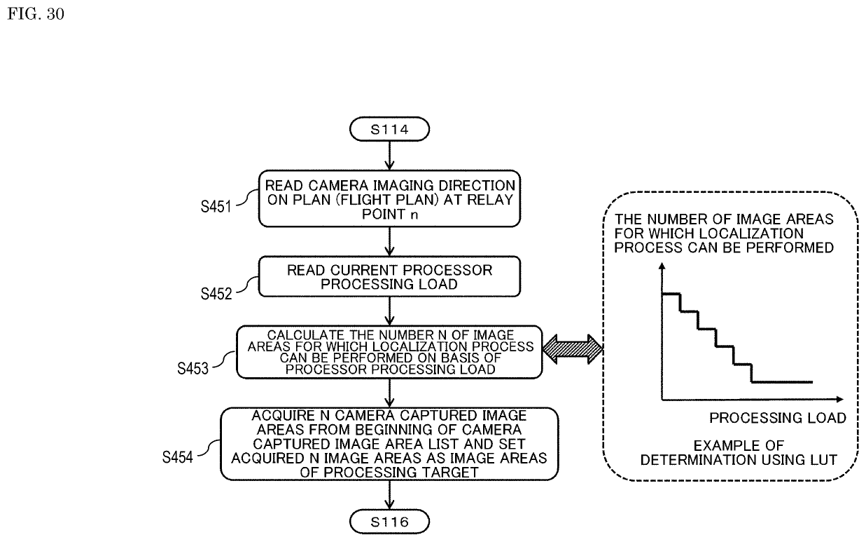

A detailed sequence of this process will be described in a later stage with reference to a flow illustrated in FIG. 30.

### (Step S113)

In Step S113, a self-position estimating process using the self-position estimation information acquired in Step S112 is executed. This process is executed in the self-position estimating unit 116.

### (Step S114)

On the basis of a self-position estimation result estimated in Step S113, as a drone control value for moving along the selection path (the movement path), a drone position control value for controlling the drone position is calculated, and the drone position is controlled in accordance with the calculated control value.

### (Step S116)

The processes of Steps S112 to S114 are repeated until a distance to a next relay point becomes a defined threshold or less, and when the distance to the next relay point becomes the defined threshold or less, processes of Steps S111 to S116 are repeated as processes corresponding to the next relay point.

When the drone passes through all the relay points set in the selection path (the movement path), the process ends.

At this time point, the drone comes into a state of being able to arrive at a goal (G), that is, a state in which a goal (G) place can be checked using a captured image acquired by the image sensor (the camera) 111.

Next, a detailed sequence of the process of Step S401 in the flow illustrated in FIG. 27, that is, the process of generating a camera captured image area candidate list of each relay point of the selection path (the movement path) selected in Step S106 will be described with reference to a flow illustrated in FIG. 29.

This process is a unique process of this Embodiment 4.

As described above, the camera captured image area candidate list of each relay point is a list in which image areas in which a “localization (self-position estimation) possible area” can be imaged at each relay point are set with a higher rank.

More specifically, the camera imaging direction candidate list is a list in which areas corresponding to localization possible areas aligned in order of highest to lowest localization success rate are set in a list higher rank, and areas corresponding to localization possibility/impossibility unknown areas aligned in order of highest to lowest localization success rate are set in a list lower rank.

This process is a process that is executed by the flight planning unit 104 of the mobile body control device 100d illustrated in FIG. 27.

The flight planning unit 104 executes processes of the following (Step S422) to (Step S436) of the flow illustrated in FIG. 29 for each of relay points set in the selection path (the movement path) of the drone 10.

Hereinafter, the processes of each step will be described in sequence.

### (Step S422)

First, in Step S422, localization feasibility information of each of divisional areas of four forward/backward/leftward/rightward directions of one relay point n selected as a verification target is acquired.

In other words, the flight planning unit 104 of the mobile body control device 100d illustrated in FIG. 27 acquires localization feasibility information of divisional areas on the periphery of a relay point n from the localization feasibility information 106.

In addition, as described above, in the localization feasibility information 106, together with area type identification information representing an area type in units of divisional areas, in other words, representing which area among areas (a) to (c) each divisional area is, localization success rate information in units of divisional areas is recorded as well.
(a) Localization (self-position estimation) possible area
(b) Localization (self-position estimation) impossible area
(c) Localization (self-position estimation) possibility/impossibility unknown area

### (Step S423)

Next, in Step S423, it is determined whether or not one or more “localization (self-position estimation) possible areas” are present in the divisional areas on the periphery of the relay point n by referring to the localization feasibility information acquired in Step S422.

In a case in which one or more localization possible areas are present, the process is caused to proceed to Step S424.

In a case in which there is no localization possible area at all, the process is caused to proceed to Step S425.

### (Step S424)

In Step S423, in a case in which it is determined that one or more “localization (self-position estimation) possible areas” are present in peripheral divisional areas of the relay point n, the following process is executed in Step S424.

The flight planning unit 104 of the mobile body control device 100d illustrated in FIG. 27, in Step S424, sorts ““possible” directions” that are directions of all the “localization (self-position estimation) possible areas” in order of the localization success rate and adds the “possible” directions to the camera captured image area candidate list of the relay point n.

As described above, the camera captured image area candidate list of each relay point is recorded inside of the self-position estimation result 141. In the self-position estimation result 141, the list is recorded in association with each relay point recorded inside of the map information 105.

### (Step S425)

After the end of the process of Step S424 and in Step S423, in a case in which it is determined that no “localization (self-position estimation) possible area” is present at all in the peripheral divisional areas of the relay point n, the following process is executed in Step S425.

In Step S425, it is determined whether or not one or more “localization (self-position estimation) possibility/impossibility unknown areas” are present in the peripheral divisional areas of the relay point n by referring to the localization feasibility information acquired in Step S422.

In a case in which one or more localization possibility/impossibility unknown areas are present, the process is caused to proceed to Step S426.

In a case in which no localization possibility/impossibility unknown area is present at all, the process is caused to proceed to Step S427.

### (Step S426)

Next, the flight planning unit 104 of the mobile body control device 100d illustrated in FIG. 27, in Step S426, sorts ““unknown” directions” that are directions of all the “localization (self-position estimation) possibility/impossibility unknown areas” in order of the localization success rate and adds the “unknown” directions to the end of the camera captured image area candidate list of the relay point n.

### (Step S427)

After the end of the process of Step S426 and in Step S425, in a case in which it is determined that no “localization (self-position estimation) possibility/impossibility unknown area” is present at all in the peripheral divisional areas of the relay point n, the following process is executed in Step S427.

The flight planning unit 104 of the mobile body control device 100d illustrated in FIG. 27 determines whether or not there is one or more camera captured image area candidates registered in the camera captured image area candidate list in Step S427.

In a case in which one or more camera captured image area candidates registered in the camera captured image area candidate list are present, the process ends, and a process corresponding to a next relay point is started.

On the other hand, in case in which no camera captured image area candidate registered in the camera captured image area candidate list is present at all, the process is caused to proceed to Step S428.

### (Step S428)

In Step S427, in a case in which it is determined that no camera captured image area candidate registered in the camera captured image area candidate list is present at all, the process is caused to proceed to Step S428, and the following process is executed.

The flight planning unit 104 of the mobile body control device 100d illustrated in FIG. 27 reads localization feasibility information of divisional areas adjacent to a relay point n in Step S428.

### (Step S429)

Next, in Step S429, by referring to the localization feasibility information of divisional areas adjacent to the relay point n read in Step S428, the number of “possible” directions in each direction is counted for each of the adjacent divisional areas.

### (Step S430)

Next, in Step S430, it is determined whether or not the number of adjacent divisional areas for which the number of “possible” directions is a threshold or more is one or more.

In a case in which it is determined that the number of adjacent divisional areas for which the number of “possible” directions is a threshold or more is one or more, the process is caused to proceed to Step S431.

On the other hand, in a case in which it is determined that no adjacent divisional area in which the number of “possible” directions is a threshold or more is present at all, the process is caused to proceed to Step S432.

### (Step S431)

In Step S430, in a case in which it is determined that the number of adjacent divisional areas for which the number of “possible” directions is the threshold or more is one or more, the following process is executed in Step S431.

The flight planning unit 104 of the mobile body control device 100d illustrated in FIG. 27, in Step S431, sorts ““possible” directions” of “adjacent divisional areas for which the number of “possible” directions is the threshold or more” in order of the localization success rate and adds the “possible” directions to the camera captured image area candidate list of the relay point n.

### (Step S432)

In Step S430, in a case in which it is determined that no adjacent divisional area in which the number of “possible” directions is the threshold or more is present at all, the following process is executed in Step S432.

In Step S432, it is determined whether or not the number of adjacent divisional areas for which the number of “unknown” directions is a threshold or more is one or more.

In a case in which it is determined that the number of adjacent divisional areas for which the number of “unknown” directions is the threshold or more is one or more, the process is caused to proceed to Step S433.

On the other hand, in a case in which it is determined that no adjacent divisional area in which the number of “unknown” directions is the threshold or more is present at all, the process is caused to proceed to Step S434.

### (Step S434)

In Step S433, in a case in which it is determined that the number of adjacent divisional areas for which the number of “unknown” directions is the threshold or more is one or more, the following process is executed in Step S434.

The flight planning unit 104 of the mobile body control device 100d illustrated in FIG. 27, in Step S434, sorts ““unknown” directions” of “adjacent divisional areas for which the number of “unknown” directions is a threshold or more” in order of the localization success rate and adds the “unknown” directions to the end of the camera captured image area candidate list of the relay point n.

### (Step S434)

After the end of the process of Step S433 and in Step S432, in a case in which it is determined that no “localization (self-position estimation) possibility/impossibility unknown area” is present at all in the peripheral divisional areas of the relay point n, the following process is executed in Step S434.

The flight planning unit 104 of the mobile body control device 100d illustrated in FIG. 27 determines whether or not there is one or more camera captured image area candidates registered in the camera captured image area candidate list in Step S434.

In a case in which one or more camera captured image area candidates registered in the camera captured image area candidate list are present, the process ends, and a process corresponding to a next relay point is started.

On the other hand, in case in which no camera captured image area candidate registered in the camera captured image area candidate list is present at all, the process is caused to proceed to Step S435.

### (Step S435)

In Step S434, in a case in which it is determined that no camera captured image area candidate registered in the camera captured image area candidate list is present at all, the following process is executed in Step S435.

The flight planning unit 104 of the mobile body control device 100d illustrated in FIG. 27 sets a camera captured image area candidate list of a relay point n−1 as the camera captured image area candidate list of the relay point n in Step S435. The relay point n−1 is a relay point through which the drone 10 passes immediately before the drone 10 arrives at the relay point n.

After starting flight, the drone 10, for each relay point, performs the process of selecting an image area used in a self-position estimating process using a camera captured image area candidate list corresponding to a relay point generated in accordance with the flow illustrated in FIG. 29.

At each relay point, the process of selecting an image area to be used from a captured image area of a wide-angle camera including a wide-angle lens such as fisheye lens configuring the image sensor (the camera) 111 is performed. The process of selecting an image area imaging a localization possible area as possibly as can is performed.

An image area selecting process during flight of the drone 10 is executed in Step S302 of the flow illustrated in FIG. 28. Details of this process will be described with reference to FIG. 30.

This process is a process that is executed by the image area selecting unit 142 of the mobile body control device 100d illustrated in FIG. 27.

While the drone 10 is flying along the selection path (the movement path), the image area selecting unit 142 executes processes of the following (Step S451) to (Step S454) at each relay point set in the selection path (the movement path).

### (Step S451)

First, the image area selecting unit 142 of the mobile body control device 100 reads the camera captured image area candidate list on a plan (flight plan) at the relay point n in Step S451.

The camera captured image area candidate list on the plan (the flight plan) at the relay point n is a camera captured image area candidate list determined in Step S401 of the flow illustrated in FIG. 28, in other words, determined in accordance with the flow described with reference to FIG. 29 and is a list defining image areas for selecting an image area used for selecting a localization possible area as possibly as can from captured images of wide-angle cameras including a wide-angle lens such as a fisheye lens configuring the image sensor (the camera) 111.

This camera captured image area candidate list is acquired from the self-position estimation result 141.

As described above, the camera captured image area candidate list of each relay point is recorded inside of the self-position estimation result 141 in association with each relay point.

The image area selecting unit 142 reads the camera imaging direction corresponding to the relay point from the image area selecting unit 142.

### (Step S452)

Next, the image area selecting unit 142 of the mobile body control device 100 reads a processing load of a current processor of the mobile body control device 100d of the drone 10 in Step S452.

In addition, for example, a hardware monitoring unit monitoring use statuses of a processor, a memory, and the like is disposed in the mobile body control device 100d, and the drone control unit 107 reads a processing load of the processor from the hardware monitoring unit in Step S452.

### (Step S453)

Next, the image area selecting unit 142 of the mobile body control device 100 calculates the number of camera captured images, that is, the number N of image areas for which the localization process is to be executed, on the basis of the processing load of the current processor of the mobile body control device 100d of the drone 10 in Step S453.

As illustrated on the right side of FIG. 30, in a case in which the processing load of the current processor is low, the number of camera captured image areas for which the localization process is executed, that is, the number N of image areas becomes large, and, in a case in which the processing load of the current processor is high, the number of camera captured image areas for which the localization process is executed, that is, the number N of image areas is set to be small.

### (Step S454)

Next, the image area selecting unit 142 of the mobile body control device 100 executes the following process in Step S454.

Image areas corresponding to the number of image areas of camera captured images, for which the localization process is executed, calculated in Step S453, that is, N high-ranked image areas are acquired from the camera captured image area candidate list acquired in Step S451, and the acquired N image areas are selected as image areas used in the localization process.

In accordance with such a process, N image areas are selected from captured image areas of a wide-angle camera including a wide-angle lens such as a fisheye lens mounted in the drone 10, and a localization process using the selected captured image areas is executed.

As a result, the probability of succeeding in image capture of a localization possible area becomes high, and the probability of succeeding in feature point extraction from a captured image, a SLAM process according to a feature point tracking, and the self-position/posture estimating process becomes high, and movement control (flight control) with high accuracy according to a planned movement path (flight path) is realized.

### 7. (Embodiment 5) Configuration and Processing Example of Mobile Body Control Device According to Embodiment 5 of Present Disclosure

Next, a configuration and a processing example of a mobile body control device according to Embodiment 5 of the present disclosure will be described.

Embodiment 5 is an embodiment relating to a mobile body control device capable of flying by performing switching between two types of flight modes including
(1) Success-focused flight mode
(2) Map enlargement-focused flight mode
described above with reference to FIGS. 4 to 6.

As described above with reference to FIGS. 4 to 6, in a case in which a drone 10 is flying in an area including a “(c) localization (self-position estimation) possibility/impossibility unknown area”, there are two types of flight modes as below.
(1) Success-focused flight
(2) Map enlargement-focused flight
“(1) Success-focused flight” is safe flight, that is, a flight mode in which flying is performed by performing reliable localization (self-position estimation).
“(2) Map enlargement-focused flight” is a flight mode in which, by deliberately flying in a “(c) localization (self-position estimation) possibility/impossibility unknown area”, the process of analyzing the “(c) localization (self-position estimation) possibility/impossibility unknown area” to be one of
(a) localization (self-position estimation) possible area and
(b) localization (self-position estimation) impossible area
is performed.

Embodiment 5 described below is an embodiment relating to a mobile body control device that enables flight by performing switching between two types of flight modes including
(1) success-focused flight mode
(2) map enlargement-focused flight mode.

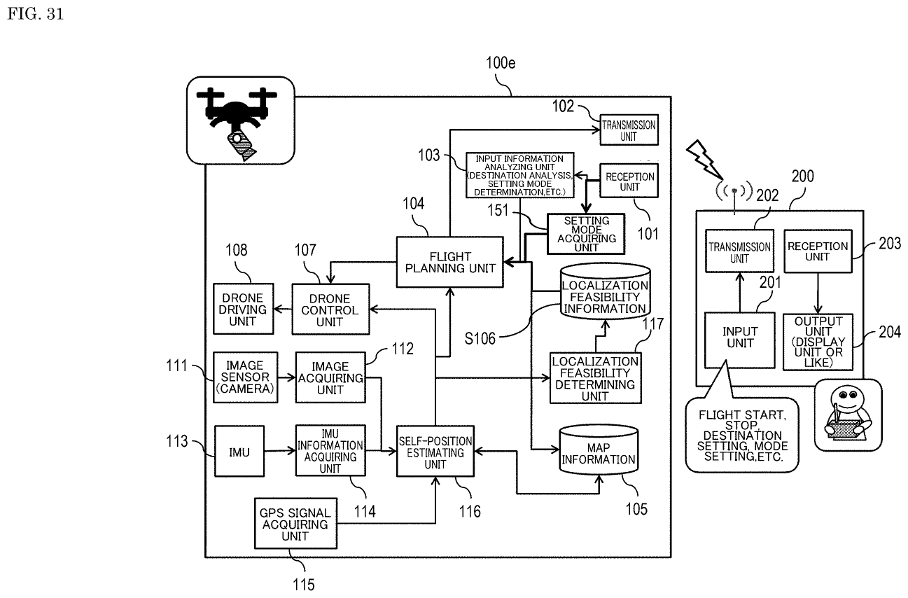

FIG. 31 illustrates a configuration example of a mobile body control device 100e according to Embodiment 5 of the present disclosure.

In FIG. 31, together with the configuration of the mobile body control device 100e according to Embodiment 5 of the present disclosure configured inside of a drone 10, a configuration example of a controller 200 communicating with the mobile body control device 100e is illustrated as well.

As illustrated in FIG. 31, the mobile body control device 100e includes a reception unit 101, a transmission unit 102, an input information analyzing unit 103, a flight planning unit 104, map information 105, localization feasibility information 106, a drone control unit 107, a drone driving unit 108, an image sensor (camera) 111, an image acquiring unit 112, an inertial measurement unit (IMU) 113, an IMU information acquiring unit 114, a GPS signal acquiring unit 115, a self-position estimating unit 116, and a localization feasibility determining unit 117 and further includes a setting mode acquiring unit 151.

The controller 200 includes an input unit 201, a transmission unit 202, a reception unit 203, and an output unit (a display unit and the like) 204.

A difference from Embodiment 1 described above with reference to FIG. 13 is that the mobile body control device 100e has the setting mode acquiring unit 151.

The other configuration is similar to the configuration of Embodiment 1, and thus description thereof will be omitted.

The setting mode acquiring unit 151 analyzes input information from the controller 200 that is received through the reception unit 101 and analyzes which one of two types of flight modes including
(1) success-focused flight mode
(2) map enlargement-focused flight mode the flight mode
is set to.

An analysis result is input to the flight planning unit 104.

The flight planning unit 104 generates a flight plan according to a setting mode.

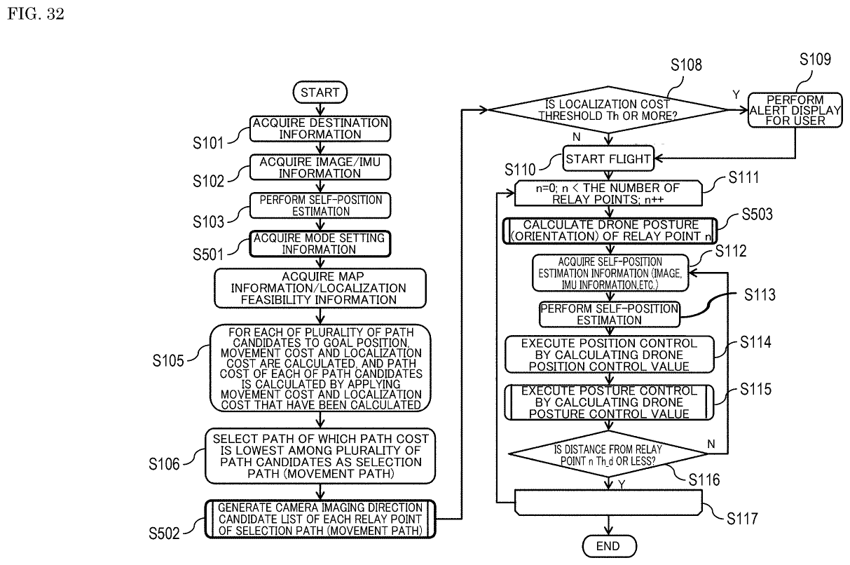

Details of the process executed by the mobile body control device 100e according to this Embodiment 5 will be described with reference to FIG. 32.

Hereinafter, processing of each step of the flow shown in FIG. 32 will be described in order.

### (Steps S101 to S103)

Processes of Steps S101 to S103 are processes similar to the processes of Steps S101 to S103 according to Embodiment 1 described above with reference to FIG. 16.

First, the mobile body control device 100e acquires destination information in Step S101.

Next, an image and IMU information are acquired in Step S102.

Such acquisition information is input to the self-position estimating unit 116.

Next, the mobile body control device 100e executes a self-position estimating process in Step S103.

### (Step S501)

Next, in Step S501, the mode setting information is acquired.

This process is a process that is executed by the setting mode acquiring unit 151 of the mobile body control device 100e illustrated in FIG. 31.

As described above, the setting mode acquiring unit 151 analyzes input information from the controller 200 that is received through the reception unit 101 and analyzes which one of two types of flight modes including
(1) success-focused flight mode
(2) map enlargement-focused flight mode the flight mode
is set to.

An analysis result is input to the flight planning unit 104.

### (Step S104)

Next, in Step S104, the map information 105 and the localization feasibility information 106 are acquired.

As described above, the map information 105 is a three-dimensional map of a three-dimensional space that is an area in which the drone 10 is flying and, for example, is map information configured using three-dimensional point group information in which objects that are obstacles for flight are represented as a point group.

The localization feasibility information 106 is information representing which area type in units of predetermined divisional areas such as units of boxes (cubes), rectangular areas, or the like divided by grids (localization feasibility information), that is, which area of (a) to (c) of each divisional area is.
(a) localization (self-position estimation) possible area
(b) localization (self-position estimation) impossible area
(c) localization (self-position estimation) possibility/impossibility unknown area

### (Step S105)

Next, in Step S105, the mobile body control device 100e calculates a movement cost and a localization cost of each of a plurality of paths that can be set as a path to a destination using the map information 105 and the localization feasibility information 106 acquired in Step S104 and calculates a path cost of each of path candidates by applying the movement cost and the localization cost of each of the plurality of paths that have been calculated.

This process is also a process executed by the flight planning unit 104 illustrated in FIG. 31.

Although a specific example of the process of calculating a movement cost and a localization cost of each of a plurality of paths to a destination that is executed by the flight planning unit 104 is a process that is almost similar to the process described above with reference to FIG. 17 in Embodiment 1, a “localization cost calculation algorithm AL5” different from Embodiments 1 to 5 described above is used when the localization cost is calculated in this Embodiment 5.

The flight planning unit 104 of the mobile body control device 100e illustrated in FIG. 31, in Step S105 of the flow illustrated in FIG. 32, as described in the previous Embodiment 1 with reference to FIG. 17, for a plurality of paths from the start node position (S: src_node) to the goal node position (G: dest_node), calculates a cost corresponding to each path (a path cost: cost(src_node, dest_node)) in accordance with the following cost calculation equation (Equation 1).

$$cost ( src\_node , dest\_node ) = w 1 \times ( movement cost ) + w 2 \times ( localization cost ) \qquad ( Equation 1 )$$

In (Equation 1) represented above, w1 and w2 are weight coefficients defined in advance.

In the cost calculation equation (Equation 1) described above, (movement cost) is a cost value that increases in proportion to the movement distance.

The localization cost is a cost value calculated using the following “localization cost calculation algorithm AL5” using functions including the cost corresponding to the localization possible number calculation function (compute_cost_localize_possible( )) and the cost corresponding to the localization impossible & unknown time calculation function (compute_cost_localize_impossible_or_unknown( )) represented in FIGS. 17(a) and 17(b).

The localization cost is a cost value calculated in accordance with the following “localization cost calculation algorithm AL5” using functions including a cost corresponding to a localization possible number calculation function (compute_cost_localize_possible( )) and a cost corresponding to a localization impossible & unknown time calculation function (compute_cost_localize_impossible_or_unknown( )).

In addition, the following “localization cost calculation algorithm AL5” is executed by inputting “localization success information” of peripheral 4 directions corresponding to a relay point on a path from the start node position (S: src_node) to a goal node position (G: dest_node) and “mode setting information (s)” thereto.

The “mode setting information (s)” is input as a variable in the range of s=0 to 1. The success-focused flight mode has (s=0), and the map enlargement-focused flight mode has (s=1).

Hereinafter, the “localization cost calculation algorithm AL5” will be represented.

“Localization cost calculation algorithm AL5”
if 4 direction localization feasibility information.all( ) == “impossible”:
cost = HIGHEST_COST_VALUE;# maximum cost fixed value
else
if “success rate ⇔ map enlargement setting” s == 0
if 4 direction localization feasibility information.any( ) == “possible”:# Minimum one
“possible” is present.
cost = compute_cost_localize_possible(num_of_“possible”);
else:# “possible” or “unknown”
cost = compute_cost_localize_impossible_or_unknown(num_of_“unknown”);
else
cost1 = compute_cost_localize_possible(num_of_“possible”);
cost2 = compute_cost_localize_unknown(“success rate ⇔ map enlargement
setting”s, num_of_“unknown”);
cost = (cost1 + cost2)*0.5;

The “localization cost calculation algorithm AL5” described above is an algorithm in which a cost calculation form is set to be different in accordance with which one of two types of flight modes including
(1) success-focused flight mode
(2) map enlargement-focused flight mode the flight mode
is set to.

In addition, in the algorithm described above, the “4 direction localization feasibility information” is localization feasibility information of divisional areas of four directions adjacent to a divisional area to which one node belonging to a path that is a cost calculation target belongs.

In this Embodiment 5, localization feasibility information of four divisional areas stored in the localization feasibility information 106 of the mobile body control device 100e illustrated in FIG. 31 is used.

In addition, the “localization cost calculation algorithm AL5” described above is a cost calculation algorithm in which, the more the localization possible areas in peripheral divisional areas of N directions adjacent to a divisional area configuring a path from the start node position (S: src_node) to the goal node position (G: dest_node), the lower the cost becomes, and the more localization impossible areas or possibility/impossibility unknown areas in divisional areas on the periphery of a divisional area configuring the path, the higher the cost value becomes.

As described above, the flight planning unit 104 of the mobile body control device 100e illustrated in FIG. 31, in Step S105 of the flow illustrated in FIG. 32, for a plurality of paths from the start node position (S: src_node) to the goal node position (G: dest_node), calculates a cost corresponding to each path (a path cost: cost(src_node, dest_node)) in accordance with the following cost calculation equation (Equation 1).

$$cost ( src\_node , dest\_node ) = w 1 \times ( movement cost ) + w 2 \times ( localization cost ) \qquad ( Equation 1 )$$

In the cost calculation equation (Equation 1) represented above, the longer the distance of a path, the higher the cost becomes, and the higher the localization cost of a path, the higher the cost becomes.

In addition, as described above, the localization cost of a path becomes a lower cost as there are more localization possible areas in peripheral divisional areas of a divisional area configuring a path, and it becomes a higher cost as there are more localization impossible areas or localization possibility/impossibility unknown area in the peripheral divisional area of a divisional area configuring a path.

### (Step S106)

Next, the mobile body control device 100e, in Step S106, compares path costs of a plurality of path candidates to the destination calculated in Step S105 with each other and selects a path candidate for which the lowest cost value has been calculated as a selection path (a movement path).

### (Step S502)

Next, in Step S502, the mobile body control device 100e generates a camera imaging direction candidate list of each relay point of the selection path (the movement path) selected in Step S106.

The process is a unique process of this Embodiment 5.

In addition, as camera imaging direction candidate lists of each relay point, at each relay point, there are two types of lists including a “possible direction candidate list” in which directions in which a “localization (self-position estimation) possible area” can be imaged are set and an “unknown direction candidate list” in which directions in which a “localization (self-position estimation) possibility/impossibility unknown area” can be imaged are set.

In this embodiment, this camera imaging direction candidate list of each relay point is recorded inside of the localization feasibility information 106. In the localization feasibility information 106, lists are recorded in association with each relay point recorded inside of the map information 105.

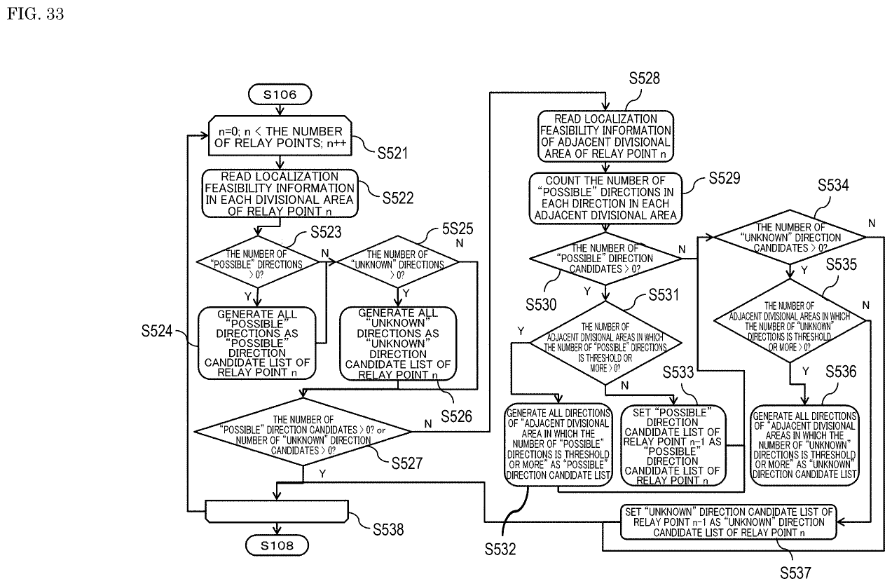

A detailed flow of this list generating process will be described in a later stage with reference to a flow illustrated in FIG. 33.

### (Step S108)

Next, the mobile body control device 100e determines whether or not the localization cost of the selection path (the movement path) selected in Step S106 is a pre-defined threshold or more in Step S108.

In addition, the localization cost of the selection path (the movement path) that is a verification target here is a cost value of the selection path (the movement path) calculated in accordance with the “localization cost calculation algorithm AL5” described above.

In a case in which the localization cost of the selection path (the movement path) is determined to be a pre-defined threshold or more, the process is caused to proceed to Step S109, and in a case in which the localization cost is determined to be less than the threshold, the process is caused to proceed to Step S110.

### (Step S109)

Step S109 is a process that is executed in a case in which the localization cost of the selection path (the movement path) selected in Step S106 is determined to be the pre-defined threshold or more in Step S108.

In this case, the mobile body control device 100e executes an alert display (a warning display) for the user in Step S109.

For example, the mobile body control device transmits a warning message to the controller 200 used by a user and causes the output unit 204 of the controller 200 to execute an alert display (a warning display).

In accordance with this process, a user can understand in advance that flight accompanies a risk, and thus a countermeasure such as stop of the flight or the like can be performed.

### (Step S110)

Next, the mobile body control device 100e starts flight of the drone 10 along the selection path (the movement path) selected in Step S106 in Step S110.

### (Steps S111 to S117)

Processes of Steps S111 to S117 are processes that are repeatedly executed during flight of the drone 10 along the selection path (the movement path) selected in Step S106.

At each relay point of the selection path (the movement path), each of processes described below is executed.

### (Step S503)

In Step S503, the direction of the drone (the camera imaging direction) at a relay point n is calculated.

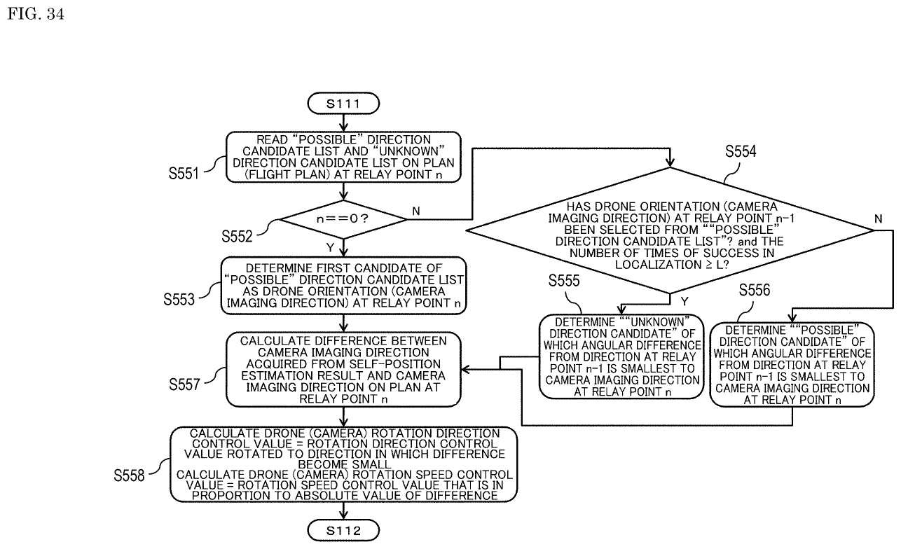

This process is a unique process of Embodiment 5. Details of this process will be described in a later stage with reference to FIG. 34.

### (Step S112)

Next, in Step S112, self-position estimation information, for example, a captured image acquired by the image sensor (the camera) 111, detection information (an acceleration, an angular velocity, and the like) of the IMU 113, and the like are acquired.

### (Step S113)

In Step S113, a self-position estimating process using the self-position estimation information acquired in Step S112 is executed. This process is executed in the self-position estimating unit 116.

### (Step S114)

On the basis of a self-position estimation result estimated in Step S113, as a drone control value for moving along the selection path (the movement path), a drone position control value for controlling the drone position is calculated, and the drone position is controlled in accordance with the calculated control value.

### (Step S115)

A drone posture control value used for controlling the posture of the drone at the drone position calculated in Step S114 is calculated, and the drone posture is controlled in accordance with the calculated control value.

This drone posture control is executed for controlling the camera imaging direction of the image sensor (the camera) 111.

In other words, posture control for directing the camera imaging direction according to the image sensor (the camera) 111 toward a direction, in which the (a) localization (self-position estimation) possible area” can be imaged as possibly as can, is executed.

### (Step S116)

The processes of Steps S112 to S115 are repeated until a distance to a next relay point becomes a defined threshold or less, and, when the distance to the next relay point becomes the defined threshold or less, the processes of Steps S111 to S116 are repeated as a process corresponding to the next relay point.

When the drone passes through all the relay points set in the selection path (the movement path), the process ends.

At this time point, the drone comes into a state in which it can arrive at the goal (G), in other words, a state in which a goal (G) place can be checked using a captured image acquired by the image sensor (the camera) 111.

Next, a detailed sequence of the process of Step S502 in the flow illustrated in FIG. 31, that is, the process of generating a camera imaging direction candidate list of each relay point of the selection path (the movement path) selected in Step S106 will be described with reference to a flow illustrated in FIG. 33.

This process is a unique process of this Embodiment 5.

As described above, as the “camera imaging direction candidate lists” corresponding to each relay point, there are two types of lists including a “possible direction candidate list” in which directions in which “localization (self-position estimation) possible areas” at each relay point can be imaged are set and an “unknown direction candidate list” in which directions in which “localization (self-position estimation) possibility/impossibility unknown areas” at each relay point can be imaged are set.

This process is a process executed by the flight planning unit 104 of the mobile body control device 100e illustrated in FIG. 31.

The flight planning unit 104 executes processes of the following (Step S522) to (Step S536) of the flow illustrated in FIG. 33 for each of relay points set in the selection path (the movement path).

Hereinafter, the processes of each step will be described in sequence.

### (Step S522)

First, in Step S522, localization feasibility information of each of divisional areas of four forward/backward/leftward/rightward directions of one relay point n selected as a verification target is acquired.

In other words, the flight planning unit 104 of the mobile body control device 100e illustrated in FIG. 31 acquires localization feasibility information of divisional areas on the periphery of a relay point n from the localization feasibility information 106.

In addition, as described above, in the localization feasibility information 106, together with area type identification information representing an area type in units of divisional areas, in other words, representing which area among areas (a) to (c) each divisional area is, localization success rate information in units of divisional areas is recorded as well.
(a) Localization (self-position estimation) possible area
(b) Localization (self-position estimation) impossible area
(c) Localization (self-position estimation) possibility/impossibility unknown area

### (Step S523)

Next, in Step S523, it is determined whether or not one or more “localization (self-position estimation) possible areas” are present in the divisional areas on the periphery of the relay point n by referring to the localization feasibility information acquired in Step S522.

In a case in which one or more localization possible areas are present, the process is caused to proceed to Step S524.

In a case in which there is no localization possible area at all, the process is caused to proceed to Step S525.

### (Step S524)

In Step S523, in a case in which it is determined that one or more “localization (self-position estimation) possible areas” are present in peripheral divisional areas of the relay point n, the following process is executed in Step S524.

The flight planning unit 104 of the mobile body control device 100e illustrated in FIG. 31, in Step S524, generates a “possible direction candidate list” in which ““possible” directions” that are directions of all “localization (self-position estimation) possible areas” are formed as a list.

In addition, as described above, in the “camera imaging direction candidate list” at each relay point, there are two types of lists including “a possible direction candidate list” in which directions in which a “localization (self-position estimation) possible area” at each relay point can be imaged are set and an “unknown direction candidate list” in which directions in which directions in which a “localization (self-position estimation) possibility/impossibility unknown area” at each relay point can be imaged are set.

Such lists are recorded inside of the localization feasibility information 106. In the localization feasibility information 106, a list is recorded in association with each relay point recorded inside of the map information 105.

### (Step S525)

After the end of the process of Step S524 and in Step S523, in a case in which it is determined that no “localization (self-position estimation) possibility/impossibility unknown area” is present at all in the peripheral divisional areas of the relay point n, the following process is executed in Step S525.

In Step S525, it is determined whether or not one or more “localization (self-position estimation) possibility/impossibility unknown areas” are present in the peripheral divisional areas of the relay point n by referring to the localization feasibility information acquired in Step S522.

In a case in which one or more localization possibility/impossibility unknown areas are present, the process is caused to proceed to Step S526.

In a case in which no localization possibility/impossibility unknown area is present at all, the process is caused to proceed to Step S527.

### (Step S526)

Next, the flight planning unit 104 of the mobile body control device 100e illustrated in FIG. 31, in Step S526, generates an “unknown direction candidate list” in which ““unknown” directions” that are directions of all “localization (self-position estimation) possibility/impossibility unknown areas” are formed as a list.

### (Step S527)

After the end of the process of Step S526 and in Step S525, in a case in which it is determined that no “localization (self-position estimation) possibility/impossibility unknown area” is present at all in the peripheral divisional areas of the relay point n, the following process is executed in Step S527.

The flight planning unit 104 of the mobile body control device 100e illustrated in FIG. 31 performs the following in Step S527.

It is determined whether one or more possible direction candidates are recorded in the “possible direction candidate list” in which ““possible” directions” that are directions of all “localization (self-position estimation) possible areas” are formed as a list or whether one or more unknown direction candidates are recorded in the “unknown direction candidate list” in which ““unknown” directions” that are directions of all “localization (self-position estimation) possibility/impossibility unknown areas” are formed as a list.

In a case in which a candidate is recorded in any one of the “possible direction candidate list” or the “unknown direction candidate list”, the process ends. In other words, the process is caused to proceed to a process for a next relay point.

On the other hand, in a case in which no candidate is recorded in the “possible direction candidate list” and the “unknown direction candidate list”, the process proceeds to Step S528.

### (Step S528)

In a case in which it is determined that no candidate is recorded in the “possible direction candidate list” and the “unknown direction candidate list” in Step S527, the process proceeds to Step S528, and the following process is executed.

The flight planning unit 104 of the mobile body control device 100e illustrated in FIG. 31 reads localization feasibility information of divisional areas adjacent to a relay point n in Step S528.

### (Step S529)

Next, in Step S529, by referring to the localization feasibility information of divisional areas adjacent to the relay point n read in Step S528, the number of “possible” directions in each direction is counted for each of the adjacent divisional areas.

### (Step S530)

Next, in Step S530, in a case in which there is one or more “possible” directions of each adjacent divisional area, the process proceeds to Step S531, and in a case in which there is no “possible” direction, the process proceeds to Step S534.

### (Step S531)

In Step S530, in a case in which the number of “possible”” directions of each adjacent divisional area is one or more, it is determined whether or not there are adjacent divisional areas in which the number of “possible”” directions is larger than a pre-defined threshold in Step S531.

In a case in which there is an adjacent divisional area in which the number of “possible”” directions is larger than the pre-defined threshold, the process proceeds to Step S532.

In a case in which there is no adjacent divisional area in which the number described above is larger than the predefined threshold, the process proceeds to Step S533.

### (Step S532)

In a case in which it is determined that there is an adjacent divisional area in which the number of “possible”” directions is larger than the pre-defined threshold In Step S531, the following process is executed in Step S532.

The flight planning unit 104 of the mobile body control device 100e illustrated in FIG. 31 sets ““possible” directions” of “adjacent divisional areas in which the number of “possible” directions is the threshold or more” as a “possible direction candidate list” of the relay point n in Step S532.

### (Step S533)

On the other hand, in a case in which it is determined that there is no adjacent divisional area in which the number of “possible”” directions is larger than the pre-defined threshold in Step S531, the following process is executed in Step S533.

The flight planning unit 104 of the mobile body control device 100e illustrated in FIG. 31 sets a “possible direction candidate list” of a relay point n−1 as the “possible direction candidate list” of the relay point n in Step S533.

The relay point n−1 is a relay point through which the drone 10 passes immediately before the drone 10 arrives at the relay point n.

### (Step S534)

In a case in which it is determined that there is no “possible” directions of each adjacent divisional area at all in Step S530, or in a case in which the process of generating a “possible direction candidate list” of the relay point n has been completed in Steps S532 and S533, the following process is executed in Step S534.

The number of “unknown” directions of each adjacent divisional area is calculated in Step S534, the process proceeds to Step S535 in a case in which the number of “unknown” directions of each adjacent divisional area is one or more, and in a case in which there is no “unknown” direction, the process proceeds to Step S537.

### (Step S535)

In a case in which the number of “unknown”” directions of each adjacent divisional area is one or more in Step S534, it is determined whether or not there is an adjacent divisional area in which the number of “unknown”” directions is larger than a pre-defined threshold in Step S535.

In a case in which there is an adjacent divisional area in which the number of “unknown”” directions is larger than the pre-defined threshold, the process proceeds to Step S536.

In a case in which there is no such an adjacent divisional area, the process proceeds to Step S537.

### (Step S536)

In a case in which it is determined that there is an adjacent divisional area in which the number of “unknown”” directions is larger than the pre-defined threshold in Step S535, the following process is executed in Step S536.

The flight planning unit 104 of the mobile body control device 100e illustrated in FIG. 31 sets the ““unknown” directions of the “adjacent divisional area in which the number of “unknown” directions is the threshold or more” as the “unknown direction candidate list” of the relay point n in Step S536.

### (Step S537)

On the other hand, in a case in which it is determined that the number of “unknown”” directions is zero in Step S534, or in a case in which it is determined that there is no adjacent divisional area in which the number of “unknown”” directions is larger than the pre-defined threshold in Step S535, the following process is executed in Step S537.

The flight planning unit 104 of the mobile body control device 100e illustrated in FIG. 31 sets the “unknown direction candidate list” of a relay point n−1 as the “unknown direction candidate list” of the relay point n in Step S537.

The relay point n−1 is a relay point through which the drone 10 passes immediately before the drone 10 arrives at the relay point n.

After starting to flight, the drone 10, at each relay point, by using camera imaging direction candidate lists corresponding to the relay point generated in accordance with the flow illustrated in this FIG. 33, that is, the “possible direction candidate list” and the “unknown direction candidate list”, performs a process of calculating a camera direction (a drone posture) for capturing an image used in the self-position estimating process.

In this Embodiment 5, at each relay point, the direction of the image sensor (the camera) 111 is adjusted using posture control of the drone. This process is executed as a process during flight of the drone 10 and is executed in Step S503 of the flow illustrated in FIG. 32. Details of this process will be described with reference to FIG. 34.

This process is a process that is executed by the drone control unit 107 of the mobile body control device 100e illustrated in FIG. 31.

While the drone 10 is flying along the selection path (the movement path), the drone control unit 107 executes the following processes of (Step S551) to (Step S558) at each relay point set in the selection path (the movement path).

### (Step S551)

First, the camera selecting unit 132 of the mobile body control device 100 reads the camera imaging direction candidate list on a plan (flight plan) at the relay point n in Step S551.

In other words, the “possible direction candidate list” and the “unknown direction candidate list” are read.

These “possible direction candidate list” and “unknown direction candidate list” are acquired from the localization feasibility information 106.

As described above, the camera imaging direction candidate list of each relay point is recorded inside of the localization feasibility information 106 in association with each relay point.

### (Step S552)

Next, the camera selecting unit 132 of the mobile body control device 100 determines whether or not the relay point identifier n=0 in Step S552.

In addition, the relay point identifier n is sequentially set to n=0, 1, and 2 from a start position.

In a case in which the relay point identifier n=0, the process proceeds to Step S553.

In a case in which the relay point identifier n≠0, the process proceeds to Step S554.

### (Step S553)

In a case in which the relay point identifier n=0, the following process is executed in Step S553.

The drone control unit 107 determines a first candidate of the ““possible” direction candidate list” as the drone direction (the camera imaging direction) at the relay point n in Step S553.

### (Step S554)

On the other hand, in a case in which the relay point identifier n≠0, the following process is executed in Step S554.

The drone control unit 107 executes the following determination process in Step S553.

At the relay point n−1, the drone direction (the camera imaging direction) is selected from the “possible” direction candidate list, and it is determined whether or not the number of times of success of localization is a threshold (L) or more.

In a case in which the drone direction (the camera imaging direction) at the relay point n−1 is selected from the “possible” direction candidate list, and it is determined that the number of times of success of localization is the threshold (L) or more (Yes), the process proceeds to Step S555.

In a case in which No is determined, the process proceeds to Step S556.

### (Step S555)

In Step S554, in a case in which the drone direction (the camera imaging direction) at the relay point n−1 is selected from the “possible” direction candidate list, and it is determined that the number of times of success of localization is the threshold (L) or more (Yes), the process proceeds to Step S555, and the following process is executed.

The drone control unit 107 determines an ““unknown” direction candidate” of which an angular difference from the camera imaging direction at the relay point n−1 is the smallest as the camera imaging direction at the relay point n in Step S555.

### (Step S556)

On the other hand, in Step S554, in a case in which the drone direction (the camera imaging direction) at the relay point n−1 has not been selected from the “possible” direction candidate list, or it is determined that the number of times of success of localization is not the threshold (L) or more (No), the process proceeds to Step S556, and the following process is executed.

The drone control unit 107 determines a ““possible” direction candidate” of which an angular difference from the camera imaging direction at the relay point n−1 is the smallest as the camera imaging direction at the relay point n in Step S556.

### (Step S557)

Next, the drone control unit 107 of the mobile body control device 100 calculates a difference between a current camera imaging direction based on the drone position posture analyzed from the self-position estimation result of the current position (the relay point n) and the camera imaging direction on a plan at the relay point n recorded as a flight plan in Step S557.

### (Step S558)

Next, the drone control unit 107 of the mobile body control device 100 executes the following process in Step S558.

A drone (camera) rotation direction control value=a rotation direction control value for rotating in a direction for decreasing the difference is calculated.

A drone (camera) rotation speed control value=a rotation speed control value that is in proportion to the absolute value of the difference is calculated.

In Step S115 of the flow illustrated in FIG. 32, the posture control of the drone 10 is executed in accordance with this calculation result.

The process according to this Embodiment 5 has been described above with reference to FIGS. 4 to 6.
(1) Success-focused flight mode
(2) Map enlargement-focused flight mode

Embodiment 5 is an embodiment relating to a mobile body control device that enables flight by performing switching between these two types of flight modes, and in a case in which “(1) Success-focused flight mode” is set, flight control similar to Embodiment 1 is executed. In other words, the setting of the camera imaging direction is formed such that the probability of succeeding in image capture of a localization possible area is raised.

On the other hand, in a case in which “(2) Map enlargement-focused flight mode” is set, such flight control that flight is performed by selecting a “(c) localization (self-position estimation) possibility/impossibility unknown area” is performed.

In accordance with this process, a “localization feasibility information” update process of changing the “(c) localization (self-position estimation) possibility/impossibility unknown area” to one of areas including
(a) localization (self-position estimation) possible area and
(b) localization (self-position estimation) impossible area and registering the changed area
can be performed.

### 8. Hardware Configuration Example of Mobile Body Control Device According to Present Disclosure

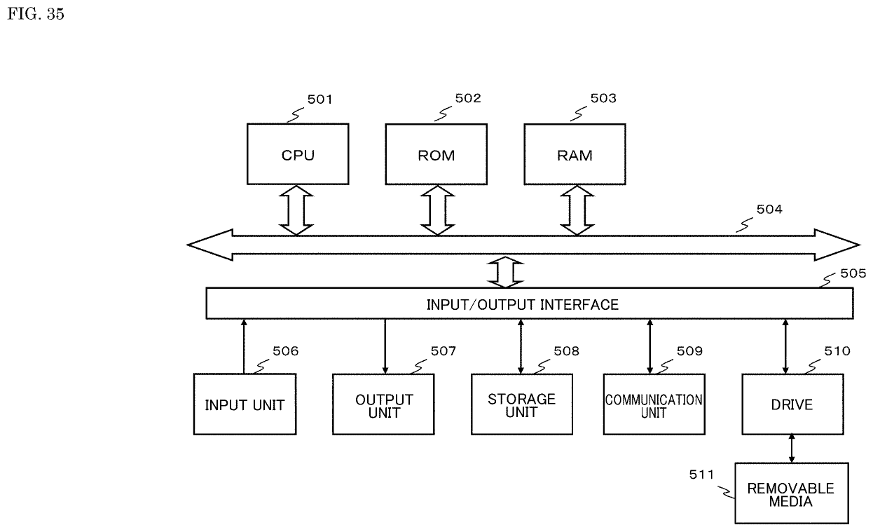

Next, a hardware configuration example of the mobile body control device according to the present disclosure will be described with reference to FIG. 35.

Each element of the hardware configuration illustrated in FIG. 35 will be described. A central processing unit (CPU) 501 functions as a data processing unit that execute various kinds of processing according to programs stored in a read only memory (ROM) 502 or a storage unit 508. For example, the processing according to the sequence described in the above embodiment is executed. A random access memory (RAM) 503 stores programs and data executed by the CPU 501. The CPU 501, the ROM 502, and the RAM 503 are connected to each other by a bus 504.

The CPU 501 is connected to an input/output interface 505 via the bus 504, and an input unit 506 formed from various sensors, a camera, a switch, a keyboard, a mouse, a microphone, and the like and an output unit 507 formed from a display, a speaker, and the like are connected to the input/output interface 505.

The storage unit 508 connected to the input/output interface 505, for example, is formed from a USB memory, an SD card, a hard disk or the like and stores a program executed by the CPU 501 and various kinds of data. A communication unit 509 functions as a transmission and reception unit of data communication via a network such as the Internet, a local area network, or the like and communicates with external devices.

A drive 510 connected to the input/output interface 505 drives a removable medium 511 such as a magnetic disk, an optical disc, a magneto-optical disc, or a semiconductor memory such as a memory card, and records or reads data.

### 9. Summary of Configuration of Present Disclosure

Embodiments of the present disclosure have been described above in detail with reference to a specific embodiment. However, it will be apparent to those skilled in the art that modification and substation of the embodiments can be made without departing from the gist of the technology disclosed in the present disclosure. That is, the present invention has been disclosed according to an illustrative form, but the present disclosure should not be restrictively construed. The gist of the present disclosure should be determined in consideration of the claims.

The technology disclosed in the present specification can have the following configuration.
(1) A mobile body control method executed in a mobile body control device, the mobile body control method including: an imaging direction control step of controlling an imaging direction of a camera using a control unit; and a localization processing step of executing a localization process estimating a self-position using a captured image of the camera using a self-position estimating unit, in which, in the imaging direction control step, a camera imaging direction control process of directing the imaging direction of the camera to a divisional area that can be localized by referring to localization feasibility information enabling to identify whether or not localization can be performed in units of divisional areas is executed.
(2) The mobile body control method described in (1), in which the localization feasibility information is information set to one of (a) to (c) in units of the divisional areas.
(a) a localization possible area representing an area that can be localized
(b) a localization impossible area representing an area that cannot be localized
(c) a localization possibility/impossibility unknown area representing an area that is unknown whether localization can be performed or not.
(3) The mobile body control method described in (2), in which, in the imaging direction control step, a camera imaging direction control process of directing the imaging direction of the camera to a divisional area set as the localization possible area by referring to the localization feasibility information is executed.
(4) The mobile body control method described in (2) or (3), in which, in the imaging direction control step, a camera imaging direction control process of directing the imaging direction of the camera to the localization possibility/impossibility unknown area by referring to the localization feasibility information is executed in a case in which there is no divisional area set as the localization possible area.
(5) The mobile body control method described in any one of (1) to (3), further including a movement plan generating step of generating a movement path of a mobile body using a movement planning unit, in which, in the movement plan generating step, camera imaging direction setting information for imaging the divisional area that can be localized is generated for each of relay points on the movement path.
(6) The mobile body control method described in (5), in which the movement planning unit executes a camera imaging direction determining process enabling a localization possible area to be imaged at each of the relay points, and in which, in the imaging direction control step, the control unit executes a camera imaging direction control process of directing the imaging direction of the camera to a camera imaging direction corresponding to each of the relay points that is determined by the movement planning unit.
(7) The mobile body control method described in (5) or (6), in which, in a case in which the localization possible area cannot be imaged at a relay point, the movement planning unit executes a camera imaging direction determining process enabling a localization possibility/impossibility unknown area to be imaged, and, in the imaging direction control step, the control unit executes a camera imaging direction control process of directing the imaging direction of the camera to a camera imaging direction corresponding to each of the relay points that is determined by the movement planning unit.
(8) The mobile body control method described in any one of (1) to (7), in which the camera is a camera fixed to a mobile body, and, in the imaging direction control step, a direction of the mobile body is controlled to direct the imaging direction of the camera to the divisional area that can be localized by referring to the localization feasibility information.
(9) The mobile body control method described in (8), in which the mobile body is a drone, and, in the imaging direction control step, a drone control unit controls a direction of the drone to direct the imaging direction of the camera to the divisional area that can be localized by referring to the localization feasibility information.
(10) The mobile body control method described in any one of (1) to (9), in which the camera is a camera that is able to perform imaging direction control independently from a mobile body using control of a camera control unit, and the imaging direction control step is a step that the camera control unit controls the imaging direction of the camera to direct the imaging direction of the camera to the divisional area that can be localized by referring to the localization feasibility information.
(11) The mobile body control method described in any one of (1) to (10), in which the camera is configured using a plurality of cameras mounted in a mobile body, and the imaging direction control step is a step that a camera selecting unit selects a camera to image the divisional area that can be localized as a camera imaging a localization processing image by referring to the localization feasibility information.
(12) The mobile body control method described in (11), in which the imaging direction control step is a step that the camera selecting unit selects a camera to image a direction in which a localization success rate is high as a camera imaging a localization processing image in accordance with a localization success rate corresponding to the camera imaging direction.
(13) The mobile body control method described in (11) or (12), in which, in the imaging direction control step, the camera selecting unit: selects a camera imaging in a localization possible direction of which a localization success rate is high as a camera capturing a localization processing image in a case that there is a localization possible direction; and selects a camera imaging in a localization possibility/impossibility unknown direction of which a localization success rate is high as a camera capturing a localization processing image in a case that there is no localization possible direction.
(14) The mobile body control method described in any one of (1) to (13), in which the camera is a camera including a wide-angle lens mounted in a mobile body, and the imaging direction control step is a step that an image area selecting unit selects a camera imaging an image area that can be localized as a camera capturing a localization processing image by referring to the localization feasibility information.
(15) The mobile body control method described in (14), in which the imaging direction control step is a step in which the image area selecting unit selects an image area of which a localization success rate is high as an image area of a localization processing image in accordance with the localization success rate corresponding to a captured image area.
(16) The mobile body control method described in (14) or (15), in which, in the imaging direction control step, the image area selecting unit: selects an image area in a localization possible direction of which a localization success rate is high as an image area of a localization processing image in a case that there is a localization possible direction; and selects an image area in a localization possibility/impossibility unknown direction of which a localization success rate is high as an image area of a localization processing image in a case that there is no localization possible direction.
(17) The mobile body control method described in any one of (1) to (17), in which, in the imaging direction control step, a camera imaging direction control process of directing the imaging direction of the camera to a localization possible area is executed in a case that a setting mode of a mobile body is a success rate-focused mode, and a camera imaging direction control process of directing the imaging direction of the camera to a localization possibility/impossibility unknown area is executed in a case that the setting mode of the mobile body is a map enlargement-focused mode.
(18) The mobile body control method described in any one of (1) to (18), further including a movement plan generating step of generating a movement path of a mobile body using a movement planning unit, in which, in the movement plan generating step, camera imaging direction setting information for imaging a localization possible area at each of relay points on the movement path is generated in a case that a setting mode of the mobile body is a success rate-focused mode, and camera imaging direction setting information for imaging a localization possibility/impossibility unknown area at each of the relay points on the movement path is generated in a case that the setting mode of the mobile body is a map enlargement-focused mode.
(19) A mobile body control device including: a control unit configured to control an imaging direction of a camera; and a self-position estimating unit configured to execute a localization processing step of executing a localization process estimating a self-position using a captured image of the camera, in which the self-control unit executes a camera imaging direction control process of directing the imaging direction of the camera to a divisional area that can be localized by referring to localization feasibility information enabling to identify whether or not localization can be performed in units of divisional areas.
(20) A program causing a mobile body control device to execute a mobile body control process including: an imaging direction control step of causing a control unit to control an imaging direction of a camera; and a localization processing step of causing a self-position estimating unit to execute a localization processing step of executing a localization process estimating a self-position using a captured image of the camera, in which, in the imaging direction control step, a camera imaging direction control process of directing the imaging direction of the camera to a divisional area that can be localized by referring to localization feasibility information enabling to identify whether or not localization can be performed in units of divisional areas is caused to be executed.

The series of processing described in this specification can be executed by hardware, software, or a composite configuration of both. If the series of processing is to be executed by software, the series of processing can be executed by installing a program recording the processing sequence into a memory in a computer embedded in dedicated hardware, or by installing the program into a general-purpose computer capable of executing various kinds of processing. For example, the program can be pre-recorded on a recording medium. Rather than being installed into a computer from a recording medium, the program can be received via a network such as a local area network (LAN) or the Internet, and installed into a built-in recording medium such as a hard disk.

The various processes described in this specification can be performed consecutively in the described order or may be performed in parallel or individually depending on the processing capability of the device performing the processes or as needed. In the present specification, the system is a logical set of configurations of a plurality of devices, and the devices having each configuration are not limited to those in the same housing.

### INDUSTRIAL APPLICABILITY

As described above, according to a configuration of one embodiment of the present disclosure, a device and a method realizing movement according to a pre-defined path even in a case in which a mobile body cannot receive absolute position information from the outside such as a GPS signal or the like as an input are realized.

More specifically, the configuration is a configuration executing control of a mobile body, for example, such a drone and executes an imaging direction control step of controlling an imaging direction of a camera using a control unit and a localization processing step of executing a localization process of estimating a self-position using a captured image of the camera using a self-position estimating unit. In the imaging direction control step, by referring to localization feasibility information enabling whether or not localization can be performed in units of divisional areas, a camera imaging direction control process of directing an imaging direction of the camera to a divisional area that can be localized is executed.

According to this configuration, a device and a method realizing movement according to a pre-defined path even in a case in which a mobile body cannot receive absolute position information from the outside such as a GPS signal or the like as an input are realized.

### REFERENCE SIGNS LIST

10 Drone
11 Camera
100 Mobile body control device
101 Reception unit
102 Transmission unit
103 Input information analyzing unit
104 Flight planning unit
105 Map information
106 Localization feasibility information
107 Drone control unit
108 Drone driving unit
111 Image sensor (camera)
112 Image acquiring unit
113 IMU (inertial measurement unit)
114 IMU information acquiring unit
115 GPS signal acquiring unit
116 Self-position estimating unit
117 Localization feasibility determining unit
121 Map base position analyzing unit
122 Visual odometry processing executing unit
123 Inertial navigation system (INS)
124 GPS signal analyzing unit
125 Mobile body position integration analyzing unit
126 Current position mapping processing unit
128 Camera control unit
131 Self-position estimating unit
132 Camera selecting unit
141 Self-position estimating unit
142 Image area selecting unit
151 Setting mode acquiring unit
501 CPU
502 ROM
503 RAM
504 Bus
505 Input/output interface
506 Input unit
507 Output unit
508 Storage unit
509 Communication unit
510 Drive
511 Removable medium

What is claimed is:

1. A mobile body control method executed in a mobile body control device, the mobile body control method comprising:
an imaging direction control step of controlling an imaging direction of a camera using a control unit; and
a localization processing step of executing a localization process estimating a self-position using a captured image of the camera using a self-position estimating unit, wherein, in the imaging direction control step, a camera imaging direction control process of directing the imaging direction of the camera to a divisional area that can be localized by referring to localization feasibility information enabling to identify whether or not localization can be performed in units of divisional areas is executed.

2. The mobile body control method according to claim 1, wherein the localization feasibility information is information set to one of (a) to (c) in units of the divisional areas.
(a) a localization possible area representing an area that can be localized
(b) a localization impossible area representing an area that cannot be localized
(c) a localization possibility/impossibility unknown area representing an area that is unknown whether localization can be performed or not.

3. The mobile body control method according to claim 2, wherein, in the imaging direction control step, a camera imaging direction control process of directing the imaging direction of the camera to a divisional area set as the localization possible area by referring to the localization feasibility information is executed.

4. The mobile body control method according to claim 2, wherein, in the imaging direction control step, a camera imaging direction control process of directing the imaging direction of the camera to the localization possibility/impossibility unknown area by referring to the localization feasibility information is executed in a case in which there is no divisional area set as the localization possible area.

5. The mobile body control method according to claim 1, further comprising a movement plan generating step of generating a movement path of a mobile body using a movement planning unit,
wherein, in the movement plan generating step, camera imaging direction setting information for imaging the divisional area that can be localized is generated for each of relay points on the movement path.

6. The mobile body control method according to claim 5,
wherein the movement planning unit executes a camera imaging direction determining process enabling a localization possible area to be imaged at each of the relay points, and
wherein, in the imaging direction control step, the control unit executes a camera imaging direction control process of directing the imaging direction of the camera to a camera imaging direction corresponding to each of the relay points that is determined by the movement planning unit.

7. The mobile body control method according to claim 5,
wherein, in a case in which the localization possible area cannot be imaged at a relay point, the movement planning unit executes a camera imaging direction determining process enabling a localization possibility/impossibility unknown area to be imaged, and
wherein, in the imaging direction control step, the control unit executes a camera imaging direction control process of directing the imaging direction of the camera to a camera imaging direction corresponding to each of the relay points that is determined by the movement planning unit.

8. The mobile body control method according to claim 1,
wherein the camera is a camera fixed to a mobile body, and
wherein, in the imaging direction control step, a direction of the mobile body is controlled to direct the imaging direction of the camera to the divisional area that can be localized by referring to the localization feasibility information.

9. The mobile body control method according to claim 8,
wherein the mobile body is a drone, and
wherein, in the imaging direction control step, a drone control unit controls a direction of the drone to direct the imaging direction of the camera to the divisional area that can be localized by referring to the localization feasibility information.

10. The mobile body control method according to claim 1,
wherein the camera is a camera that is able to perform imaging direction control independently from a mobile body using control of a camera control unit, and
wherein the imaging direction control step is a step that the camera control unit controls the imaging direction of the camera to direct the imaging direction of the camera to the divisional area that can be localized by referring to the localization feasibility information.

11. The mobile body control method according to claim 1,
wherein the camera is configured using a plurality of cameras mounted in a mobile body, and
wherein the imaging direction control step is a step that a camera selecting unit selects a camera to image the divisional area that can be localized as a camera imaging a localization processing image by referring to the localization feasibility information.

12. The mobile body control method according to claim 11, wherein the imaging direction control step is a step that the camera selecting unit selects a camera to image in a direction in which a localization success rate is high as a camera imaging a localization processing image in accordance with a localization success rate corresponding to the camera imaging direction.

13. The mobile body control method according to claim 11, wherein, in the imaging direction control step, the camera selecting unit:
selects a camera imaging in a localization possible direction of which a localization success rate is high as a camera capturing a localization processing image in a case that there is a localization possible direction; and
selects a camera imaging in a localization possibility/impossibility unknown direction of which a localization success rate is high as a camera capturing a localization processing image in a case that there is no localization possible direction.

14. The mobile body control method according to claim 1,
wherein the camera is a camera including a wide-angle lens mounted in a mobile body, and
wherein the imaging direction control step is a step that an image area selecting unit selects a camera imaging an image area that can be localized as a camera capturing a localization processing image by referring to the localization feasibility information.

15. The mobile body control method according to claim 14, wherein the imaging direction control step is a step that the image area selecting unit selects an image area of which a localization success rate is high as an image area of a localization processing image in accordance with the localization success rate corresponding to a captured image area.

16. The mobile body control method according to claim 14, wherein, in the imaging direction control step, the image area selecting unit:
selects an image area in a localization possible direction of which a localization success rate is high as an image area of a localization processing image in a case that there is a localization possible direction; and
selects an image area in a localization possibility/impossibility unknown direction of which a localization success rate is high as an image area of a localization processing image in a case that there is no localization possible direction.

17. The mobile body control method according to claim 1, wherein, in the imaging direction control step, a camera imaging direction control process of directing the imaging direction of the camera to a localization possible area is executed in a case that a setting mode of a mobile body is a success rate-focused mode, and a camera imaging direction control process of directing the imaging direction of the camera to a localization possibility/impossibility unknown area is executed in a case that the setting mode of the mobile body is a map enlargement-focused mode.

18. The mobile body control method according to claim 1, further comprising a movement plan generating step of generating a movement path of a mobile body using a movement planning unit,
wherein, in the movement plan generating step, camera imaging direction setting information for imaging a localization possible area at each of relay points on the movement path is generated in a case that a setting mode of the mobile body is a success rate-focused mode, and camera imaging direction setting information for imaging a localization possibility/impossibility unknown area at each of the relay points on the movement path is generated in a case that the setting mode of the mobile body is a map enlargement-focused mode.

19. A mobile body control device comprising:
a control unit configured to control an imaging direction of a camera; and
a self-position estimating unit configured to execute a localization processing step of executing a localization process estimating a self-position using a captured image of the camera,
wherein the self-control unit executes a camera imaging direction control process of directing the imaging direction of the camera to a divisional area that can be localized by referring to localization feasibility information enabling to identify whether or not localization can be performed in units of divisional areas.

20. A program causing a mobile body control device to execute a mobile body control process comprising:
an imaging direction control step of causing a control unit to control an imaging direction of a camera; and
a localization processing step of causing a self-position estimating unit to execute a localization processing step of executing a localization process estimating a self-position using a captured image of the camera,
wherein, in the imaging direction control step, a camera imaging direction control process of directing the imaging direction of the camera to a divisional area that can be localized by referring to localization feasibility information enabling to identify whether or not localization can be performed in units of divisional areas is caused to be executed.
